(19) United States
(12) Patent Application Publication
(10) Pub. No.: US 2011/0093587 A1
(43) Pub. Date: Apr. 21, 2011

(54) DEVICE DATA MANAGEMENT SYSTEM

(76) Inventors: Yasufumi Toshima, Cupertino, CA (US); Kazuhiro Kawai, Tokyo (JP)

(21) Appl. No.: 12/673,227

(22) PCT Filed: Aug. 11, 2008
(86) PCT No.: PCT/JP2008/064432

§ 371 Date: Jan. 5, 2011

(30) Foreign Application Priority Data
Aug. 14, 2007 (JP) 2007-211266

(51) Int. Cl. G06F 15/173

(52) U.S. Cl. 709/224

(57) ABSTRACT

[Problems] To provide a device data management system which can know and monitor use of user computers constituting a network and respective operation states.

[Means for Solving Problems] A device data management system (10) includes a plurality of networks (16) formed by computers (11-14) and a device monitoring server (15) which monitors them in time series; a data relay server (17) which temporarily stores various information transmitted from the server (15); and a data management computer (18) which acquires various information from the server (17). The server (15) has: use history information collection means which collects application use history information from the computers (11-14) in time series; and use history information transmission means which transmits the collected use history information to the server (17). The management computer (18) has: use history information storage means which classifies the use history information transmitted from the server (15) for each network and stores them; and use history information output means which outputs the information.

### TECHNICAL FIELD

The present invention relates to a device data management system for acquiring from at least a device monitor unit a plurality of various information on each network component unit forming a network, and managing the information collectively for each network.

### BACKGROUND ART

A data management server is available which is connected to a plurality of terminal units to manage the information used in the terminal units (see Patent Document 1). This data management server executes the operation of a data storage means with individual storage areas allotted to each user, an access state judgment means for judging whether a terminal unit is capable of accessing the data management server, and a data access management means which, in response to a request from a terminal unit to the individual storage area, permits the access-requesting terminal unit to access the information stored in an individual storage area in the case where the access state judgment means judges that the terminal unit used by the user associated with the particular individual storage area is in the state accessible to the data management server, and otherwise rejects the access of the access-requesting terminal unit to the information stored in the individual storage area. In this data management server, a file stored in the storage area such as a folder of the user is prevented from being used by a third party in the case where the user is not on the job thereby to improve the information security.
Patent Document 1: Japanese Patent Application Laid-Open No. 2005-71327

### DISCLOSURE OF THE INVENTION

In the data management server disclosed in Patent Document 1, the individual storage area of each user is allotted to the server, and a plurality of various information on the users are stored in individual storage areas. Therefore, the plurality of the various information cannot be retrieved by the terminal unit of each user, and the plurality of the various information on the terminal units cannot be centrally and collectively managed. This data management server can neither manage the various information on the use and operation of the terminal units nor grasp and monitor the manner in which the terminal units are used and operated. Specifically, due to the impossibility of grasping the manner in which an application is used by each terminal unit, various applications, if freely brought in and used by the user of a terminal unit, cannot be grasped, and the use of the application in a terminal unit cannot be controlled. Further, in view of the fact that the manner in which an application is installed or uninstalled cannot be grasped, the act of the user of a terminal unit to install an unrequired application cannot be controlled, and the unauthorized uninstallation of an application by the user of the terminal unit cannot be controlled.

The object of this invention is to provide a device data management system which can centrally and collectively manage a plurality of various information on each component unit forming a network on the one hand and can grasp and monitor the various manner in which the component units of the network are used and operated on the other hand.

In order to solve the problem described above, according to this invention, there is provided a device data management system comprising a plurality of networks each formed of a plurality of network component devices and a device monitor for temporally monitoring the network component devices, and a data management unit for acquiring a plurality of various information on the network component devices from a plurality of the device monitors forming the networks, wherein the device monitor includes a use history information collection means for temporally collecting from the network component devices the use history information of each application used in the network component devices, and a use history information transmission means for transmitting the collected use history information to a data management unit, and wherein the data management unit includes a use history information first storage means for storing by classifying according to each network the use history information transmitted from each device monitor and a use history information first output means for outputting by classifying the use history information according to each network.

As an example of this invention, the data management unit includes a use history information second storage means for storing, by classifying according to each network component device, the use history information transmitted from each device monitor, and a use history information second output means for outputting by classifying the use history information according to each network component device.

As another example of the invention, the device monitor includes an access history information collection means for temporally collecting from the network component devices the access history information on the access to an unusable application in the network component devices, and an access history information history transmission means for transmitting the collected access history information to the data management unit, and wherein the data management unit includes an access history information first storage means for storing by classifying according to each network the access history information transmitted from each device monitor and an access history information first output means for outputting by classifying the access history information according to each network.

As still another example of the invention, the data management unit includes an access history information second storage means for storing, by classifying according to each network component device, the access history information transmitted from each device monitor, and an access history information second output means for outputting by classifying the access history information according to each network component device.

As yet another example of the invention, the data management unit includes an application alteration means for adding, changing or deleting an application used in the network component devices and an unusable application alteration means for adding, changing or deleting the unusable application in the network component devices.

As a further example of the invention, the device monitor includes an installation information collection means for temporally collecting, from the network component devices, the information on installation, if any, of an application in the network component devices, and an installation information transmission means for transmitting the collected installation information to the data management unit on the one hand, and the data management unit includes an installation information first storage means for storing, for each network, the installation information transmitted from each device monitor and an installation information first output means for outputting by classifying the installation information according to each network on the other hand.

As a still further example of the invention, the data management unit includes an installation information second storage means for storing, by classifying according to each network component device, the installation information transmitted from each device monitor and an installation information second output means for outputting by classifying the installation information according to each network component device.

As a yet further example of the invention, the device monitor includes an uninstallation information collection means for temporally collecting the uninstallation information from the network component devices in the case where an application is uninstalled from the network component devices and an installation information transmission means for transmitting the collected uninstallation information to the data management unit on the one hand, and the data management unit includes an uninstallation information first storage means for storing, by classifying according to each network, the uninstallation information transmitted from each device monitor and an uninstallation information first output means for outputting by classifying the uninstallation information according to each network on the other hand.

As another example of the invention, the data management unit includes an uninstallation information second storage means for storing, by classifying according to each network component device, the uninstallation information transmitted from each device monitor and an uninstallation information second output means for outputting by classifying the uninstallation information according to each network.

As still another example of the invention, the device monitor includes an external use history information collection means for temporally collecting, from a network component device, the external use history information in the case where the network component device is used in an external environment other than the network formed by the network component device and an external use history information transmission means for transmitting the collected external use history information to the data management unit on the one hand, and the data management unit includes an external use history information first storage means for storing, by classifying according to each network, the external use history information transmitted from each device monitor and an external use history information first output means for outputting by classifying the external use history information according to each network on the other hand.

As yet another example of the invention, the data management unit includes an external use history information second storage means for storing, by classifying according to each network component device, the external use history information transmitted from each device monitor and an external use history information second output means for outputting by classifying the external use history information according to each network.

As a further example of the invention, the device monitor includes an undesignated time use history information collection means for temporally collecting, from a network component device, the undesignated time use history information in the case where the network component device is used at other than a designated time and an undesignated time use history information transmission means for transmitting the collected undesignated time use history information to the data management unit on the one hand, and the data management unit includes an undesignated time use history information first storage means for storing, by classifying according to each network, the undesignated time use history information transmitted from each device monitor and an undesignated time use history information first output means for outputting by classifying the undesignated time use history information according to each network on the other hand.

As a still further example of the invention, the data management unit includes an undesignated time use history information second storage means for storing, by classifying according to each network component device, the undesignated time use history information transmitted from each device monitor and an undesignated time use history information second output means for outputting by classifying the undesignated time use history information according to each network component device.

As a yet further example of the invention, the device monitor includes a bring-out action information collection means for temporally collecting from a network component device the bring-out action information in the case where an attempt is made to bring out a bring-out prohibited data from the network component device and a bring-out action information transmission means for transmitting the collected bring-out action information to the data management unit on the one hand, and the data management unit includes a bring-out action information first storage means for storing, by classifying according to each network, the bring-out action information transmitted from each device monitor and a bring-out action information first output means for outputting by classifying the bring-out action information according to each network on the other hand.

As another example of the invention, the data management unit includes a bring-out action information second storage means for storing, by classifying according to each network component device, the bring-out action information transmitted from each device monitor and a bring-out action information second output means for outputting by classifying the bring-out action information according to each network component device.

As still another example of the invention, the device monitor includes a print action information collection means for temporally collecting from a network component device the print action information in the case where an attempt is made to print a print prohibited data from a network component device and a print action information transmission means for transmitting the collected print action information to the data management unit on the one hand, and the data management unit includes a print action information first storage means for storing, by classifying according to each network, the print action information transmitted from each device monitor and a print action information first output means for outputting by classifying the print action information according to each network on the other hand.

As yet another example of the invention, the data management unit includes a print action information second storage means for storing, by classifying according to each network component device, the print action information transmitted from each device monitor and a print action information second output means for outputting by classifying the print action information according to each network component device.

As a further example of the invention, the device monitor includes an E-mail transmission information collection means for temporally collecting from a network component device the E-mail transmission information in the case where an E-mail is transmitted from the network component device and an E-mail transmission information transmission means for transmitting the collected E-mail transmission information to the data management unit on the one hand, and the data management unit includes an E-mail transmission information first storage means for storing, by classifying according to each network, the E-mail transmission information transmitted from each device monitor and an E-mail transmission information first output means for outputting by classifying the E-mail transmission information according to each network on the other hand.

As a still further example of the invention, the data management unit includes an E-mail transmission information second storage means for storing, by classifying according to each network, the E-mail transmission information transmitted from each device monitor and an E-mail transmission information second output means for outputting by classifying the E-mail transmission information according to each network.

As a yet further example of the invention, the device monitor includes a Web site access information collection means for temporally collecting from a network component device the Web site access transmission information in the case where a predetermined Web site is accessed by the network component device and a Web site access information transmission means for transmitting the collected access site access information to the data management unit on the one hand, and the data management unit includes a Web site access information first storage means for storing, by classifying according to each network, the Web site access information transmitted from each device monitor and a Web site access information first output means for outputting by classifying the Web site access information according to each network on the other hand.

As another example of the invention, the data management unit includes a Web site access information second storage means for storing, by classifying according to each network, the Web site access information transmitted from each device monitor and a Web site access information second output means for outputting by classifying the Web site access information according to each network.

As still another example of the invention, the device monitor includes an external network access information collection means for temporally collecting from a network component device the external network access transmission information in the case where the network component device accesses an external network other than the network formed by the network component device and an external network access information transmission means for transmitting the collected external network access information to the data management unit on the one hand, and the data management unit includes an external network access information first storage means for storing, by classifying according to each network, the external network access information transmitted from each device monitor and an external network access information first output means for outputting by classifying the external network access information according to each network.

As yet another example of the invention, the data management unit includes an external network access information second storage means for storing, by classifying according to each network component device, the external network access information transmitted from each device monitor and an external network access information second output means for outputting by classifying the external network access information according to each network component device.

In a device data management system according to this invention, the use history information on the application of the network component devices forming each network are centrally and collectively managed for each network. Therefore, the manner in which an application is used can be grasped and monitored for each network by a system manager, and the use of the application can be controlled for each network. In the case where a network is formed of a plurality of network component devices for each branch office, for example, the use information on the application of the network component devices is transmitted to a data management unit installed in the management department of the head office from a device monitor installed in each branch office. In this way, the manner in which the application of the network component devices is used can be grasped and monitored by the management department of the head office for each branch office, thereby making it possible for the management department in the head office to positively control the use of an application in each branch office.

In a device data management system for managing, for each network component device forming each network, the use history information of an application of the network component device, a data management unit centrally and collectively manages the use history information of an application for each network component device. In this way, the manner in which an application is used can be grasped and monitored by the system manager for each network component device through a data management unit, thereby making it possible to control the use of the application for each network component device. In the case where a plurality of network component devices form a network for each branch office, for example, the use information of an application for each network component device is transmitted from the device monitor installed in each branch office to the data management unit installed in the management department of the head office. Thus, the manner in which the application of the network component device is used can be grasped and monitored by the management department of the head office for each network component device, and the management department of the head office can positively control the use of an application in each network component device installed in each branch office.

In a device data management system for managing the history information of access to an unusable application of each network component device, a data management unit centrally and collectively manages the history information of access to the unusable application for each network component device forming each network. In this way, the manner in which the unusable application is accessed can be grasped and monitored by the system manager for each network through the data management unit, thereby making it possible to control the access to an unusable application for each network. For example, the manner in which an unusable application of a network component device forming a network in each branch office is accessed can be grasped and monitored by the management department of the head office for each branch office, and the management department of the head office can positively control the access to the unusable application in each branch office.

In a device data management system for managing the history information of access to an unusable application of each network component device forming each network, a data management unit centrally and collectively manages the history information of access to the unusable application for each network component device forming each network. In this way, the manner in which the unusable application is accessed can be grasped and monitored by the system manager for each network component through the data management unit, thereby making it possible to control the access to the unusable application for each network component device. For example, the manner in which the network component devices forming a network in each branch office can be grasped and monitored by the management department of the head office for each network component device, and the management department of the head office can positively control the access to the unusable application in each network component device installed in each branch office.

In a device data management system for adding, changing or deleting an application used in a network component device and adding, changing or deleting an unusable application in a network component device, the application used in each network component device can be altered freely as required. Therefore, a new application can be added and a network component device permitted to use the particular application additionally. In this way, an unusable application can be changed from the usable state to the unusable state and the use of the particular application in the network component device can be prohibited. Further, the applications used in a network component device can be arranged in order by deleting the unrequired ones of the applications. In this device data management system, an unusable application can be altered freely as required. An application not used for the time being can be added as an unusable application, and the particular application, whenever it is required to be used, can be changed from the unusable state to the usable state, and the network component device can be permitted to use the application. Further, the unusable applications can be arranged in order by deleting the unrequired ones of the unusable applications.

In a device data management system for managing the information on installation of an application in each network component device, a data management unit centrally and collectively manages, for each network, the information on installation of the application for each network component device forming each network. In this way, the manner in which an application is installed in each network can be grasped and monitored for each network by the system manager through the data management unit, thereby making it possible to control the installation of the application for each network. For example, the manner in which an application of an network component device forming a network in each branch office can be grasped and monitored by the management department of the head office for each branch office, and the management department of the head office can positively control the installation of the application in each branch office.

In a device data management system for managing the information on application installation for each network component device forming each network, a data management unit centrally and collectively manages the application installation information for each network component device. In this way, the manner in which an application is installed can be grasped and monitored by the system manager for each network component device through the data management unit, thereby making it possible to control the installation of the application for each network component device. For example, the manner in which an application of an network component device forming a network is installed in each branch office can be grasped and monitored by the management department of the head office for each network component device, and the management department of the head office can positively control the installation of an application in each network component device.

In a device data management system for managing the information on application uninstallation in each network component device, a data management unit centrally and collectively manages, for each network, the application uninstallation information in each network component device forming each network. In this way, the manner in which an application is uninstalled can be grasped and monitored by the system manager for each network through the data management unit, thereby making it possible to control the uninstallation of an application for each network. For example, the manner in which an application of a network component device forming a network in each branch office is uninstalled can be grasped and monitored by the management department of the head office for each branch office, and the management department of the head office can positively control the uninstallation of an application in each branch office.

In a device data management system for managing the application uninstallation information for each network component device forming each network, a data management unit centrally and collectively manages the application uninstallation information for each network component device. In this way, the manner in which an application is uninstalled can be grasped and monitored by the system manager for each network component device through the data management unit, thereby making it possible to control the uninstallation of an application for each network component device. For example, the manner in which an application of a network component device forming a network in each branch office is uninstalled can be grasped and monitored by the management department of the head office for each network component device, and the management department of the head office can positively control the uninstallation of an application for each network component device installed in each branch office.

In a device data management system for managing the external use history information of each network component device, a data management unit centrally and collectively manages, for each network, the external use history information in a network component device forming each network. In this way, the manner in which the network component device is used externally can be grasped and monitored by the system manager for each network through the data management unit, thereby making it possible to control the external use of each network component device for each network. For example, the manner in which a network component device forming a network is externally used in each branch office can be grasped and monitored by the management department of the head office for each branch office, and the management department of the head office can positively control the external use of each network component device in each branch office.

In a device data management system for managing, for each network component device forming each network, the external use history information of the network component devices, a data management unit centrally and collectively manages, for each network component device, the external use history information of the network component devices. In this way, the manner in which the network component devices are used externally can be grasped and monitored by the system manager for each network component device through the data management unit, thereby making it possible to control the external use for each network component device. For example, the manner in which a network component device forming a network is externally used in each branch office can be grasped and monitored by the management department of the head office for each network component device, and the management department of the head office can positively control the external use of each network component device installed in each branch office.

In a device data management system for managing the undesignated time use history information of each network component device, a data management unit centrally and collectively manages, for each network, the undesignated time use history information of the network component devices forming each network. In this way, the manner in which each network component device is used at other than a designated time can be grasped and monitored by the system manager for each network through the data management unit, thereby making it possible to control the use of each network component device at other than the designated time for each network. For example, the manner in which a network component device forming a network is used in each branch office at other than the designated time can be grasped and monitored by the management department of the head office for each branch office, and the management department of the head office can positively control the use, at other than the undesignated time, of each network component device installed in each branch office.

In a device data management system for managing, for each network component device, the undesignated time use history information of the network component devices forming each network, a data management unit centrally and collectively manages, for each network component device, the undesignated time use history information of the network component devices. In this way, the manner in which each network component device is used at other than a designated time can be grasped and monitored by the system manager for each network component device through the data management unit, thereby making it possible to control the use of each network component device at other than the undesignated time. For example, the manner in which a network component device forming a network is used in each branch office at other than the designated time can be grasped and monitored by the management department of the head office for each network component device, and the management department of the head office can positively control the use, at other than the undesignated time, of each network component device installed in each branch office.

In a device data management system for managing the bring-out action information of each network component device, a data management unit centrally and collectively manages, for each network, the bring-out action information of the network component device forming each network. In this way, the manner in which each network component device is brought out can be grasped and monitored by the system manager for each network through the data management unit, thereby making it possible to control the bring-out action of each network component device for each network. For example, the manner in which a network component device forming a network is brought out from each branch office can be grasped and monitored by the management department of the head office for branch office, and the management department of the head office can positively control the action to bring out each network component device from each branch office.

In a device data management system for managing, for each network component device forming each network, the bring-out action information of the network component devices, a data management unit centrally and collectively manages, for each network component device, the bring-out action information of the network component devices. In this way, the manner in which each network component device is brought out can be grasped and monitored by the system manager for each network component device through the data management unit, thereby making it possible to control the bring-out action for each network component device. For example, the manner in which a network component device forming a network is brought out from each branch office can be grasped and monitored by the management department of the head office for each network component device, and the management department of the head office can positively control the action to bring out each network component device installed in each branch office.

In a device data management system for managing the print action information of the no-printing data in each network component device, a data management unit centrally and collectively manages, for each network, the print action information of the network component devices forming each network. In this way, the manner in which the no-printing data of each network component device is printed can be grasped and monitored by the system manager for each network through the data management unit, thereby making it possible to control the printing of the no-printing data for each network. For example, the manner in which the no-printing data of a network component device forming a network is printed in each branch office can be grasped and monitored for each branch office by the management department of the head office, and the management department of the head office can positively control the action to print the no-printing data of each network component device in each branch office.

In a device data management system for managing the print action information of the no-printing data in each network component device for each network component device forming each network, a data management unit centrally and collectively manages, for each network component device, the print action information of the network component devices. In this way, the manner in which the no-printing data is printed can be grasped and monitored for each network component device by the system manager through the data management unit, thereby making it possible to control the printing of the no-printing data for each network component device. For example, the manner in which the no-printing data in the network component devices forming a network is printed in each branch office can be grasped and monitored for each network component device by the management department of the head office, and the management department of the head office can positively control the action to print the no-printing data of each network component device installed in each branch office.

In a device data management system for managing the E-mail transmission information of each network component device, a data management unit centrally and collectively manages, for each network, the E-mail transmission information of the network component devices forming each network. In this way, the manner in which the E-mail is transmitted in the network component devices can be grasped and monitored by the system manager for each network through the data management unit, thereby making it possible to control the E-mail transmission of the network component devices for each network. For example, the manner in which the E-mail is transmitted in a network component device forming a network in branch offices can be grasped and monitored for each branch office by the management department of the head office, and the management department of the head office can positively control the action to transmit the E-mail of each network component device in each branch office.

In a device data management system for managing, for each network component device, the E-mail transmission information of the network component devices forming each network, a data management unit centrally and collectively manages, for each network component device, the E-mail transmission information of the network component devices. In this way, the manner in which the E-mail is transmitted can be grasped and monitored by the system manager for each network component device through the data management unit, thereby making it possible to control the E-mail transmission for each network component device. For example, the manner in which the E-mail is transmitted in the network component devices forming a network in each branch office can be grasped and monitored for each network component device by the management department of the head office, and the management department of the head office can positively control the E-mail transmission action of each network component device installed in each branch office.

In a device data management system for managing the Web site access information of each network component device, a data management unit centrally and collectively manages, for each network, the Web site access information of the network component devices forming each network. In this way, the manner in which the Web site is accessed in the network component devices can be grasped and monitored by the system manager for each network through the data management unit, thereby making it possible to control the Web site access of the network component devices for each network. For example, the manner in which the Web site is accessed in the network component devices forming a network in each branch office can be grasped and monitored for each branch office by the management department of the head office, and the management department of the head office can positively control the access to the Web site of each network component device in each branch office.

In a device data management system for managing, for each network component device, the Web site access information of the network component devices forming each network, a data management unit centrally and collectively manages the Web site access information of the network component devices for each network component device. In this way, the manner in which the Web site is accessed can be grasped and monitored by the system manager for each network component device through the data management unit, thereby making it possible to control the access to the Web site for each network component device. For example, the manner in which the Web site is accessed in the network component devices forming a network in each branch office can be grasped and monitored for each network component device by the management department of the head office, and the management department of the head office can positively control the access to the Web site of each network component device installed in each branch office.

In a device data management system for managing the external network access information of each network component device, a data management unit centrally and collectively manages, for each network, the external network access information of the network component devices forming each network. In this way, the manner in which the external network of the network component devices is accessed can be grasped and monitored by the system manager for each network through the data management unit, thereby making it possible to control, for each network, the access of the network component devices to the external network. For example, the manner in which the external network is accessed in the network component devices forming a network in each branch office can be grasped and monitored for each branch office by the management department of the head office, and the management department of the head office can positively control, for each branch office, the access of each network component device to the external network.

In a device data management system for managing, for each network component device, the external network access information of the network component devices forming a network, a data management unit centrally and collectively manages, for each network component device, the external network access information of the network component devices. In this way, the manner in which the external network is accessed can be grasped and monitored by the system manager for each network component device through the data management unit, thereby making it possible to control the access to the external network for each network component device. For example, the manner in which the external network is accessed by the network component devices forming a network in each branch office can be grasped and monitored for each network component device by the management department of the head office, and the management department of the head office can positively control the access to the external network by each network component device installed in each branch office.

### BRIEF DESCRIPTION OF THE DRAWINGS

FIG. 1 is a diagram showing the configuration of a device data management system shown as an example.

FIG. 2 is a diagram showing an example of a display screen of the authentication procedure displayed on the display unit of a device monitor server or a data management computer.

FIG. 3 is a diagram showing an example of the user computer equipment information.

FIG. 4 is a diagram showing an example of an application list.

FIG. 5 is a diagram showing an example of the application use history information.

FIG. 6 is a diagram showing an example of the application use history information.

FIG. 7 is a diagram showing an example of the access history information.

FIG. 8 is a diagram showing an example of the access history information.

FIG. 9 is a diagram showing an example of a setting screen for adding, changing or deleting an application.

FIG. 10 is a diagram showing an example of a setting screen for adding, changing or deleting an unusable application.

FIG. 11 is a diagram showing an example of a setting screen of the transmission interval (output interval) of various information.

FIG. 12 is a diagram showing an example of the manner in which an application is installed.

FIG. 13 is a diagram showing the contents of an application installed.

FIG. 14 is a diagram showing an example of the manner in which an application is installed.

FIG. 15 is a diagram showing the contents of an application uninstalled.

FIG. 16 is a diagram showing an example of the print action information.

FIG. 17 is a diagram showing an example of the print action information.

FIG. 18 is a diagram showing an example of the file access history information.

FIG. 19 is a diagram showing an example of the file access history information.

FIG. 20 is a diagram showing an example of the external use history information.

FIG. 21 is a diagram showing an example of the external use history information.

FIG. 22 is a diagram showing an example of the undesignated time use history information.

FIG. 23 is a diagram showing an example of the undesignated time use history information.

FIG. 24 is a diagram showing an example of the bring-out action information.

FIG. 25 is a diagram showing an example of the bring-out action information.

FIG. 26 is a diagram showing an example of the print action information.

FIG. 27 is a diagram showing an example of the print action information.

FIG. 28 is a diagram showing an example of the E-mail transmission information.

FIG. 29 is a diagram showing an example of the E-mail transmission information.

FIG. 30 is a diagram showing an example of the Web site access information.

FIG. 31 is a diagram showing an example of the Web site access information.

FIG. 32 is a diagram showing an example of the external network access information.

FIG. 33 is a diagram showing an example of the external network access information.

### DESCRIPTION OF REFERENCE NUMERALS

10 Data management system
11A to C User computer (network component device)
12A to C User computer (network component device)
13A to C User computer (network component device)
14A to C User computer (network component device)
15A to C Device monitor server (device monitor)
16A to D Network
17A, B Data relay server
18 Data management computer (data management unit)
20 Internet
22 Display

### BEST MODE FOR CARRYING OUT THE INVENTION

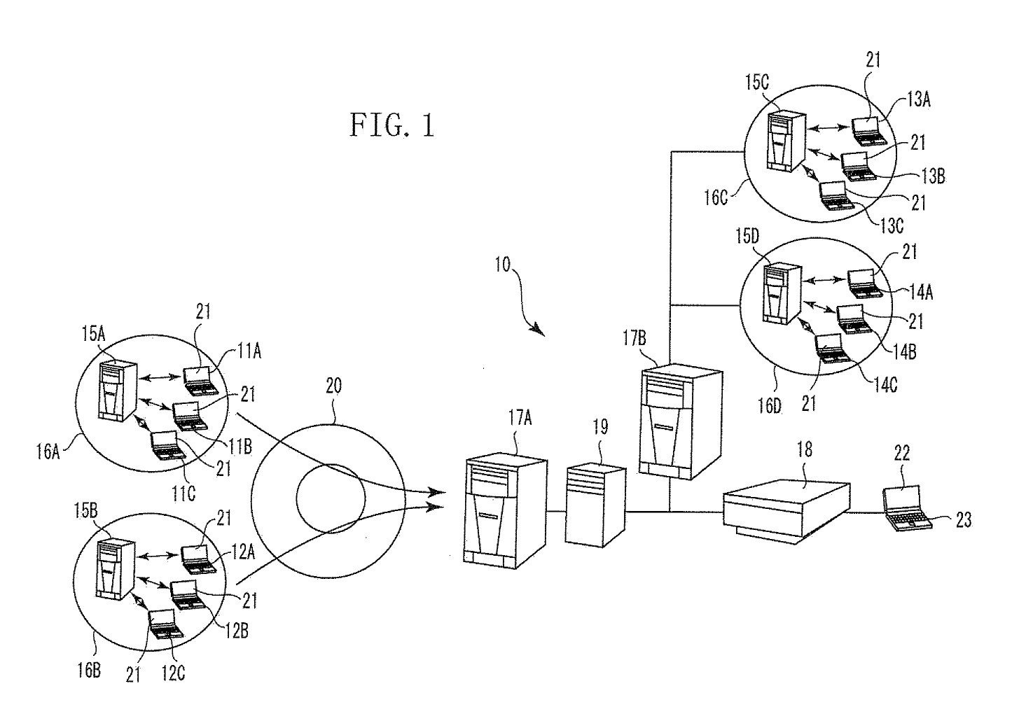

A device data management system according to this invention is explained in detail below with reference to the accompanying drawings. FIG. 1 is a diagram showing a configuration of the device data management system 10 shown as an example. The management system 10 is configured of a plurality of networks 16A to 16D formed of a plurality of user computers 11A to 11C, 12A to 12C, 13A to 13C, 14A to 14C (network component devices) managed and held by each user and device monitor servers 15A to 15D (device monitors) for temporally monitoring the user computers 11A to 11C, 12A to 12C, 13A to 13C, 14A to 14C, data relay servers 17A, 17B for temporarily storing a plurality of various information transmitted from the device monitor servers 15A to 15D forming the networks 16A to 16D, and a data management computer 18 (data management unit) for acquiring a plurality of various information stored in the data relays servers 17A, 17B. A firewall 19 is installed between the data relay server 17A and the data management computer 15. The servers 15A, 15B included in the device monitor servers 15A to 15D are connected to the data relay server 17A through an internet 20. Of these device monitor servers 15A to 15D, the servers 15C, 15D are connected to the data relay server 17B through an interface (wired or wireless). Incidentally, although the four networks 16A to 16D are shown in FIG. 1, the number of networks is not specifically limited. Also, although the three user computers 11A to 11C, 12A to 12C, 13A to 13C, 14A to 14C are shown as included in the networks 16A to 16D, the number of user computers is not specifically limited.

The networks 16A to 16D are connected to a group of servers, though not shown, including a DNS server for setting the correspondence between a host name and an IP address allotted to the particular host name, a Web server required to open a home page in public domain, a data base server providing a function of reading and writing various data by accepting requests from other client computers or other servers, a mail server for transmitting and receiving an E-mail and a document server for holding all the data such as texts and images generated and making these data retrievable.

The user computers 11A to 11C, 12A to 12C, 13A to 13C, 14A to 14C each have a central processing unit and a memory and have mounted thereon a large-capacity hard disk. These computers 11A to 11C, 12A to 12C, 13A to 13C, 14A to 14C are connected with, though not shown, a printer, a scanner and an external hard disk through an interface. The computers 11A to 11C, 12A to 12C, 13A to 13C, 14A to 14C can also be replaceably connected with the existing removable disks such as a memory stick, an IC recorder, a PDA and a portable phone, and various data can be exchanged between the computers 11A to 11C, 12A to 12C, 13A to 13C, 14A to 14C and these removable disks. The computers 11A to 11C, 12A to 12C, 13A to 13C, 14A to 14C each have the function of transmitting and receiving the E-mail. The computers 11A to 11C, 12A to 12C, 13A to 13C, 14A to 14C can each access and log in to a predetermined Web site on the one hand, and access and log in to a predetermined external network on the other hand.

The device monitor servers 15A to 15D are computers each having a central processing unit and a memory and having a large-capacity hard disk mounted thereon. The device monitor servers 15A to 15D are connected to, though not shown, a display, a keyboard, a printer, a scanner and an external hard disk through an interface. The device monitor servers 15A to 15D have the function of transmitting and receiving the E-mail.

The device monitor servers 15A to 15D temporally and endlessly monitor the manner in which the user computers 11A to 11C, 12A to 12C, 13A to 13C, 14A to 14C logged in to the networks 16A to 16D are used and operated. Further, the device monitor servers 15A to 15D manage the applications installed in the user computers 11A to 11C, 12A to 12C, 13A to 13C, 14A to 14C, the applications uninstalled from the user computers 11A to 11C, 12A to 12C, 13A to 13C, 14A to 14C, the operation time of the user computers 11A to 11C, 12A to 12C, 13A to 13C, 14A to 14C, the data printing in the user computers 11A to 11C, 12A to 12C, 13A to 13C, 14A to 14C and the file access in the user computers 11A to 11C, 12A to 12C, 13A to 13C, 14A to 14C. The device monitor servers 15A to 15D, under the control of an operating system, boot the device management application stored in the instruction file of a memory and execute the operation of each means described below in accordance with the application thus booted.

(Network Configuration Monitor)

The device monitor servers 15A to 15D temporally and endlessly monitor the network configuration information of the networks 16A to 16D. The network configuration information include the hardware information forming the networks 16A to 16D, the network topology information of the hardware, the hardware information of the user computers 11A to 11C, 12A to 12C, 13A to 13C, 14A to 14C and the information on the applications installed in the user computers 11A to 11C, 12A to 12C, 13A to 13C, 14A to 14C. The device monitor servers 15A to 15D store these network configuration information together with the information establishment day/hour in a hard disk (network configuration information collection means). Incidentally, once the hardware, the network topology or the application is changed, the device monitor servers 15A to 15D rewrite the network configuration information stored in the hard disk, and store the latest information after change and the rewrite day/hour in the hard disk. The network configuration information before rewriting, however, are not erased, but stored in the hard disks of the device monitor severs 15A to 15D.

The device monitor servers 15A to 15D attach a first identification data (network name, network identification number, etc.) to the network information to classify and identify the particular information for each of the networks 16A to 16D on the one hand and attach a second identification data (computer name, work group/domain, MAC address, IP address, user computer identification number, etc.) to the network configuration information to identify the user computers 11A to 11C, 12A to 12C, 13A to 13C, 14A to 14C on the other hand. The device monitor servers 15A to 15D encrypt the network information, the first identification data, the second identification data and the information establishment day/hour (network configuration information encryption means), and transmit the encrypted network configuration information, the first identification data, the second identification data and the information establishment day/hour periodically to the data relay servers 17A, 17B (network configuration information transmission means)

(Use History Monitor)

The device monitor servers 15A to 15D temporally and endlessly monitor the manner in which the applications of the user computers 11A to 11C, 12A to 12C, 13A to 13C, 14A to 14C logged in to the networks 16A to 16D are used. Once an application is used by any of the user computers 11A to 11C, 12A to 12C, 13A to 13C, 14A to 14C, the device monitor servers 15A to 15D collect the use history information on the particular application from the user computers 11A to 11C, 12A to 12C, 13A to 13C, 14A to 14C and store the collected use history information (use history information collection means). Once the application installed in the user computers 11A to 11C, 12A to 12C, 13A to 13C, 14A to 14C is started and used thereby, the use history information of the particular application is output from the user computers 11A to 11C, 12A to 12C, 13A to 13C, 14A to 14C to the device monitor servers 15A to 15D and temporally stored in the hard disks of the device monitor servers 15A to 15D.

In the device monitor servers 15A to 15D, the first identification data for identifying by classifying the use history information received from the user computers 11A to 11C, 12A to 12C, 13A to 13C, 14A to 14C for each of the networks 16A to 16D is attached to the particular information on the one hand, and the second identification data for identifying by classifying the use history information for each of the user computers 11A to 11C, 12A to 12C, 13A to 13C, 14A to 14C is attached to the particular information on the other hand. The device monitor servers 15A to 15D encrypt the use history information, the first identification information and the second identification information (use history information encryption means), and transmit the encrypted use history information, first identification data and second identification data periodically to the data relay servers 17A, 17B (use history information transmission means).

(Access History Monitor)

The device monitor servers 15A to 15D temporally and endlessly monitor the manner in which an unusable application is accessed by the user computers 11A to 11C, 12A to 12C, 13A to 13C, 14A to 14C logged in to the networks 16A to 16D. The device monitor servers 15A to 15D, once an unusable application is installed in the user computers 11A to 11C, 12A to 12C, 13A to 13C, 14A to 14C, collect the history information on the access to the unusable application from the user computers 11A to 11C, 12A to 12C, 13A to 13C, 14A to 14C and store the collected access history information (access history information collection means). With the start of the user computers 11A to 11C, 12A to 12C, 13A to 13C, 14A to 14C to install a predetermined application, the application identification information for specifying the particular application is output from the user computers 11A to 11C, 12A to 12C, 13A to 13C, 14A to 14C to the device monitor servers 15A to 15D. In the device monitor servers 15A to 15D, the application identification information output from the user computers 11A to 11C, 12A to 12C, 13A to 13C, 14A to 14C is compared with the usable application identification information and the unusable application identification information stored in the memory. In the case where the application identification information is the unusable application identification information (uninstallable), the device monitor servers 15A to 15D outputs an install prohibition to the user computers 11A to 11C, 12A to 12C, 13A to 13C, 14A to 14C. Once the user computers 11A to 11C, 12A to 12C, 13A to 13C, 14A to 14C receive the install prohibition, the particular access history information is output from the user computers 11A to 11C, 12A to 12C, 13A to 13C, 14A to 14C to the device monitor servers 15A to 15C, and stored temporally in the hard disks of the device monitor servers 15A to 15D.

In the device monitor servers 15A to 15D, the first identification data for identifying by classify, for each of the networks 16A to 16D, the access history information received from the user computers 11A to 11C, 12A to 12C, 13A to 13C, 14A to 14C is attached to the particular access history information on the one hand, and the second identification data for identifying by classifying the particular information for each of the user computers 11C, 12A to 12C, 13A to 13C, 14A to 14C is attached to the access history information on the other hand. The device monitor servers 15A to 15D encrypt the access history information, the first identification data and the second identification data (access history information encryption means) and periodically transmit the encrypted access history information, first identification data and second identification data periodically to the data relay servers 17A, 17B (access history information transmission means).

(Installation Monitor)

The device monitor servers 15A to 15D temporally and endlessly monitor the manner in which an application of the user computers 11A to 11C, 12A to 12C, 13A to 13C, 14A to 14C logged in to the networks 16A to 16D is installed. Once a usable application is installed in any of the user computers 11A to 11C, 12A to 12C, 13A to 13C, 14A to 14C, the device monitor servers 15A to 15D collect the application installation information from the particular one of the user computers 11A to 11C, 12A to 12C, 13A to 13C, 14A to 14C and store the collected installation information (installation information collection means). In the device monitor servers 15A to 15D, the application identification information output from the user computers 11A to 11C, 12A to 12C, 13A to 13C, 14A to 14C is compared with the usable application identification information and the unusable application information stored in the hard disk. In the case where the application identification information is the usable application identification information (installable), the device monitor servers 15A to 15D install the particular application in the user computers 11A to 11C, 12A to 12C, 13A to 13C, 14A to 14C. Upon complete installation of the application, the installation information is output to the device monitor servers 15A to 15D from the computers 11A to 11C, 12A to 12C, 13A to 13C, 14A to 14C, and stored temporally in the hard disks of the device monitor servers 15A to 15D.

In the device monitor servers 15A to 15D, the first identification data for identifying, by classifying for each of the networks 16A to 16D, the installation information received from the user computers 11A to 11C, 12A to 12C, 13A to 13C, 14A to 14C is attached to the particular information on the one hand, and the second identification data for identifying by classifying the installation information for each of the user computers 11A to 11C, 12A to 12C, 13A to 13C, 14A to 14C is attached to the particular information on the other hand. The device monitor servers 15A to 15D encrypt the installation information, the first identification data and the second identification data (installation information encryption means), and periodically transmit the encrypted installation information, first identification data and second identification data to the data relay servers 17A, 17B (installation information transmission means).

(Uninstallation Monitor)

The device monitor servers 15A to 15D temporally and endlessly monitor the uninstallation of an application from the user computers 11A to 11C, 12A to 12C, 13A to 13C, 14A to 14C. Once an application is uninstalled from any of the user computers 11A to 11C, 12A to 12C, 13A to 13C, 14A to 14C, the device monitor servers 15A to 15D collect the application uninstallation information from the particular one of the user computers 11A to 11C, 12A to 12C, 13A to 13C, 14A to 14C, and store the collected uninstallation information (uninstallation information collection means). Once any of the user computers 11A to 11C, 12A to 12C, 13A to 13C, 14A to 14C starts to uninstall a predetermined application, the application identification information for specifying the particular application is output from the computers 11A to 11C, 12A to 12C, 13A to 13C, 14A to 14C to the device monitor servers 15A to 15D. In the device monitor servers 15A to 15D, the application identification information output from the user computers 11A to 11C, 12A to 12C, 13A to 13C, 14A to 14C is compared with the uninstallable application identification information and the non-uninstallable application identification information stored in the hard disk. In the case where the application identification information is the uninstallable application identification information (uninstallable), the device monitor servers 15A to 15D uninstall the particular application from the user computers 11A to 11C, 12A to 12C, 13A to 13C, 14A to 14C. Upon complete uninstallation of the application, the uninstallation information is output to the device monitor servers 15A to 15D from the computers 11A to 11C, 12A to 12C, 13A to 13C, 14A to 14C, and stored temporally in the hard disks of the device monitor servers 15A to 15D.

Also, in the case where the application identification information is the non-uninstallable application identification information (uninstallation prohibited), the device monitor servers 15A to 15D output the uninstallation prohibit notice to the user computers 11A to 11C, 12A to 12C, 13A to 13C, 14A to 14C. Once the user computers 11A to 11C, 12A to 12C, 13A to 13C, 14A to 14C receive the uninstallation prohibit notice, the particular uninstallation information is output to the device monitor servers 15A to 15D from the computers 11A to 11C, 12A to 12C, 13A to 13C, 14A to 14C, and temporally stored in the hard disks of the device monitor servers 15A to 15D.

In the device monitor servers 15A to 15D, the first identification data for identifying by classifying the uninstallation information received from the user computers 11A to 11C, 12A to 12C, 13A to 13C, 14A to 14C is attached to the particular information on the one hand, and the second identification data for identifying by classifying the uninstallation information for each of the user computers 11A to 11C, 12A to 12C, 13A to 13C, 14A to 14C is attached to the particular uninstallation information on the other hand. The device monitor servers 15A to 15D encrypt the uninstallation information, the first identification information and the second identification information (uninstallation information encryption means), and periodically transmit the encrypted uninstallation information, first identification information and second identification information to the data relay servers 17A, 17B (uninstallation information transmission means).

(Print History Monitor)

The device monitor servers 15A to 15D temporally and endlessly monitor the manner in which the print operation of the user computers 11A to 11C, 12A to 12C, 13A to 13C, 14A to 14C logged in to the networks 16A to 16D is performed. Once the data is printed from the user computers 11A to 11C, 12A to 12C, 13A to 13C, 14A to 14C, the device monitor servers 15A to 15D collect the print history information from the computers 11A to 11C, 12A to 12C, 13A to 13C, 14A to 14C, and store the collected print history information (print history information collection means). In the case where any of the user computers 11A to 11C, 12A to 12C, 13A to 13C, 14A to 14C prints a predetermined data on a printer connected to the particular user computer, the particular print history information is output from the particular one of the computers 11A to 11C, 12A to 12C, 13A to 13C, 14A to 14C to the device monitor servers 15A to 15D and temporally stored in the hard disks of the device monitor servers 15A to 15D.

In the device monitor servers 15A to 15D, the first identification data for identifying by classifying the print history information received from the user computers 11A to 11C, 12A to 12C, 13A to 13C, 14A to 14C is attached to the particular information on the one hand, and the second identification data for identifying by classifying the print history information is attached for each of the user computers 11A to 11C, 12A to 12C, 13A to 13C, 14A to 14C to the particular information on the other hand. The device monitor servers 15A to 15D encrypt the print history information, the first identification data and the second identification data (print history information encryption means) and transmit the encrypted print history information, first identification data and second identification data periodically to the data relay servers 17A, 17B (print history information transmission means).

(File Access Monitor)

The device monitor servers 15A to 15D temporally and endlessly monitor the manner in which a file is accessed by any of the user computers 11A to 11C, 12A to 12C, 13A to 13C, 14A to 14C logged in to the networks 16A to 16D. Once the user computers 11A to 11C, 12A to 12C, 13A to 13C, 14A to 14C access a predetermined file, the device monitor servers 15A to 15D temporally collect the file access information from the particular one of the user computers 11A to 11C, 12A to 12C, 13A to 13C, 14A to 14C and store the collected file access information (file access information collection means). In the case where the user computers 11A to 11C, 12A to 12C, 13A to 13C, 14A to 14C access the file stored in a memory or an external hard disk, the particular file access information is output from the computers 11A to 11C, 12A to 12C, 13A to 13C, 14A to 14C to the device monitor servers 15A to 15D, and temporally stored in the hard disks of the device monitor servers 15A to 15D.

In the device monitor servers 15A to 15D, the first identification data for identifying by classifying, for each of the networks 16A to 16D, the file access information received from the user computers 11A to 11C, 12A to 12C, 13A to 13C, 14A to 14C is attached to the particular information on the one hand, and the second identification data for identifying by classifying the file access information for each of the user computers 11A to 11C, 12A to 12C, 13A to 13C, 14A to 14C is attached to the particular information on the other hand. The device monitor servers 15A to 15D encrypt the file access information, the first identification data and the second identification data (file access information encryption means) and transmit the encrypted file access information, first identification data and second identification data periodically to the data relay servers 17A, 17B (file access information transmission means).

(External Use History Monitor)

The device monitor servers 15A to 15D temporally and endlessly monitor the use of the user computers 11A to 11C, 12A to 12C, 13A to 13C, 14A to 14C in other than the networks. In the case where the user computers 11A to 11C, 12A to 12C, 13A to 13C, 14A to 14C are used in an external environment other than the networks 16A to 16D formed by the user computers 11A to 11C, 12A to 12C, 13A to 13C, 14A to 14C, the device monitor servers 15A to 15D collect the external use history information and store the collected external use history information (external use history information collection means). The identification number (computer name, IP address, MAC address, etc.) for specifying any of the user computers 11A to 11C, 12A to 12C, 13A to 13C, 14A to 14C is output by the user computers 11A to 11C, 12A to 12C, 13A to 13C, 14A to 14C to the device monitor servers 15A to 15D at predetermined intervals (3 or 5 minutes, etc.). In the case where the output of the identification number output at equal intervals from any of the user computers 11A to 11C, 12A to 12C, 13A to 13C, 14A to 14C is suspended after at least one output, the device monitor servers 15A to 15D judge that the particular one of the user computers 11A to 11C, 12A to 12C, 13A to 13C, 14A to 14C have left the networks 16A to 16D, and in the case where the identification number is output again at predetermined time intervals from any of the user computers 11A to 11C, 12A to 12C, 13A to 13C, 14A to 14C, judge that the particular one of the user computers 11A to 11C, 12A to 12C, 13A to 13C, 14A to 14C is connected again to the networks 16A to 16D and that the particular one of the user computers 11A to 11C, 12A to 12C, 13A to 13C, 14A to 14C has been used in the external environment. The device monitor servers 15A to 15D, upon judgment that any of the user computers 11A to 11C, 12A to 12C, 13A to 13C, 14A to 14C has been used in the external environment, cause the particular one of the user computers 11A to 11C, 12A to 12C, 13A to 13C, 14A to 14C to output the external use history information. The external use history information is stored temporally in the hard disks of the device monitor servers 15A to 15D.

In the device monitor servers 15A to 15D, the first identification data for identifying, by classifying for each of the networks 16A to 16D, the external use history information received from the user computers 11A to 11C, 12A to 12C, 13A to 13C, 14A to 14C is attached to the particular information on the one hand, and the second identification data for identifying by classifying the external use history information for each of the user computers 11A to 11C, 12A to 12C, 13A to 13C, 14A to 14C are attached to the particular information on the other hand. The device monitor servers 15A to 15D encrypt the external use history information, the first identification data and the second identification data (external use history information encryption means), and periodically transmit the encrypted external use history information, first identification data and second identification data to the data relay servers 17A, 17B (external use history information transmission means).

(Undesignated Time Use History Monitor)

The device monitor servers 15A to 15D temporally and endlessly monitor the use of the user computers 11A to 11C, 12A to 12C, 13A to 13C, 14A to 14C at other than a designated time. In the case where any of the user computers 11A to 11C, 12A to 12C, 13A to 13C, 14A to 14C is used at other than the designated time, the device monitor servers 15A to 15D collect the undesignated time use information from the particular one of the user computers 11A to 11C, 12A to 12C, 13A to 13C, 14A to 14C and store the collected undesignated time use history information (undesignated time use history information collection means). The designated time (permitted operation time) of each of the user computers 11A to 11C, 12A to 12C, 13A to 13C, 14A to 14C is stored in the memories of the device monitor servers 15A to 15D. The device monitor servers 15A to 15D, by the timer function thereof, specify the time associated with the identification number (computer name, IP address, MAC address, etc.) output at predetermined time intervals from the user computers 11A to 11C, 12A to 12C, 13A to 13C, 14A to 14C, and judge whether the user computers 11A to 11C, 12A to 12C, 13A to 13C, 14A to 14C are used at other than the designated time or not. The device monitor servers 15A to 15D, upon judgment that any of the user computers 11A to 11C, 12A to 12C, 13A to 13C, 14A to 14C is used at other than the designated time, causes the particular one of the user computers 11A to 11C, 12A to 12C, 13A to 13C, 14A to 14C to output the undesignated time use history information indicating the user at other than the designated time. The undesignated time use history information is temporally stored in the hard disks of the device monitor servers 15A to 15D.

In the device monitor servers 15A to 15D, the first identification data for identifying, by classifying for each of the networks 16A to 16D, the undesignated time use history information received from the user computers 11A to 11C, 12A to 12C, 13A to 13C, 14A to 14C is attached to the particular information on the one hand, and the second identification data for identifying by classifying the undesignated time use history information for each of the user computers 11A to 11C, 12A to 12C, 13A to 13C, 14A to 14C is attached to the particular information on the other hand. The device monitor servers 15A to 15D encrypt the undesignated time use history information, the first identification data and the second identification data (undesignated time use history information encryption means), and periodically transmit the encrypted undesignated time use history information, first identification data and second identification data to the data relay servers 17A, 17B (undesignated time use history information transmission means).

(Bring-Out Action Monitor)

The device monitor servers 15A to 15D temporally and endlessly monitor the action to bring out the prohibited data from the user computers 11A to 11C, 12A to 12C, 13A to 13C, 14A to 14C. In the case where an attempt is made to bring out the prohibited data from the user computers 11A to 11C, 12A to 12C, 13A to 13C, 14A to 14C, the device monitor servers 15A to 15D collect the bring-out action information from the user computers 11A to 11C, 12A to 12C, 13A to 13C, 14A to 14C and store the collected bring-out action information (bring-out action information collection means). Methods of prohibiting the data from being brought out include a method in which any of the user computers 11A to 11C, 12A to 12C, 13A to 13C, 14A to 14C is designated and the data is prohibited from being brought out from the particular computer, a method in which the data stored in the drive mounted on any of the user computers 11A to 11C, 12A to 12C, 13A to 13C, 14A to 14C is prohibited from being copied (prohibition of the copy action for the drive), a method in which the drive mounted on any of the user computers 11A to 11C, 12A to 12C, 13A to 13C, 14A to 14C is prohibited from being written in (prohibition of the action to write in the drive), and a method in which a specified data is designated and prohibited from being copied)

In the case where the action is conducted to bring out the data stored in any of the user computers 11A to 11C, 12A to 12C, 13A to 13C, 14A to 14C from which the data is prohibited from being brought out (the access to or copying of the data in any of the computers 11A to 11C, 12A to 12C, 13A to 13C, 14A to 14C), in the case where the action is conducted to copy a prohibited drive, in the case where the action is conducted to write in a drive prohibited from being written in or in the case where the action is conducted to copy a prohibited data, then the device monitor servers 15A to 15D judge that the action is conducted to bring out the data. The device monitor servers 15A to 15D, upon judgment that a bring-out action is conducted, displays a bring-out prohibit message on a display 21 of the particular one of the user computers 11A to 11C, 12A to 12C, 13A to 13C, 14A to 14C, while at the same time causing the particular one of the user computers 11A to 11C, 12A to 12C, 13A to 13C, 14A to 14C which has conducted the bring-out action to output the bring-out action information. The bring-out action information is temporally stored in the hard disks of the device monitor servers 15A to 15D.

In the device monitor servers 15A to 15D, the first identification data for identifying, by classifying for each of the networks 16A to 16D, the bring-out action information received from the user computers 11A to 11C, 12A to 12C, 13A to 13C, 14A to 14C is attached to the particular information on the one hand, and the second identification data for identifying by classifying the bring-out action information for each of the user computers 11A to 11C, 12A to 12C, 13A to 13C, 14A to 14C is attached to the particular information on the other hand. The device monitor servers 15A to 15D encrypt the bring-out action information, the first identification data and the second identification data (bring-out information encryption means), and periodically transmit the encrypted bring-out action information, first identification data and second identification data to the data relay servers 17A, 17B (bring-out action information transmission means).

(Print Action Monitor)

The device monitor servers 15A to 15D temporally and endlessly monitor the action to print the prohibited data in the user computers 11A to 11C, 12A to 12C, 13A to 13C, 14A to 14C. In the case where an attempt is made to print the prohibited data from any of the user computers 11A to 11C, 12A to 12C, 13A to 13C, 14A to 14C, the device monitor servers 15A to 15D collect the print action information from the particular one of the computers 11A to 11C, 12A to 12C, 13A to 13C, 14A to 14C and store the collected print action information (print action information collection means). Methods of prohibiting the data printing include a method in which any of the user computers 11A to 11C, 12A to 12C, 13A to 13C, 14A to 14C is designated and the printing the data in the particular computer is prohibited, a method in which a drive mounted on any of the user computers 11A to 11C, 12A to 12C, 13A to 13C, 14A to 14C is designated and the data stored in the drive is prohibited from being printed and a method in which a specified data is designated and the data is prohibited from being printed.

In the case where the print action is conducted in any of the user computers 11A to 11C, 12A to 12C, 13A to 13C, 14A to 14C prohibited from printing, in the case where the action to print for a prohibited drive is conducted or in the case where the action is conducted to print a prohibited data, then the device monitor servers 15A to 15D judges that a print action is conducted on the prohibited data. The device monitor servers 15A to 15D, upon judgment of a print action, displays a print prohibit message on the display 21 of the particular one of the user computers 11A to 11C, 12A to 12C, 13A to 13C, 14A to 14C, while at the same time causing the particular one of the user computers 11A to 11C, 12A to 12C, 13A to 13C, 14A to 14C which has conducted the print action to output the print action information. The print action information is temporally stored in the hard disks of the device monitor servers 15A to 15D.

In the device monitor servers 15A to 15D, the first identification data for identifying, by classifying for each of the networks 16A to 16D, the print action information received from the user computers 11A to 11C, 12A to 12C, 13A to 13C, 14A to 14C is attached to the particular information on the one hand, and the second identification data for identifying by classifying the print action information for each of the user computers 11A to 11C, 12A to 12C, 13A to 13C, 14A to 14C is attached to the particular information on the other hand. The device monitor servers 15A to 15D encrypt the print action information, the first identification data and the second identification data (print action information encryption means), and periodically transmit the encrypted print action information, first identification data and second identification data to the data relay servers 17A, 17B (print action information transmission means).

(E-Mail Transmission Monitor)

The device monitor servers 15A to 15D temporally and endlessly monitor the E-mail transmission in the user computers 11A to 11C, 12A to 12C, 13A to 13C, 14A to 14C. In the case where an E-mail is transmitted from any of the user computers 11A to 11C, 12A to 12C, 13A to 13C, 14A to 14C, the device monitor servers 15A to 15D collect the E-mail transmission information from the particular one of the computers 11A to 11C, 12A to 12C, 13A to 13C, 14A to 14C and store the collected E-mail transmission information (E-mail transmission information collection means). In the case where any of the user computers 11A to 11C, 12A to 12C, 13A to 13C, 14A to 14C transmits an E-mail to any other computer of the networks 16A to 16d formed thereby or in the case where any of the user computers 11A to 11C, 12A to 12C, 13A to 13C, 14A to 14C transmits an E-mail using the internet 20 outside the networks 16A to 16D formed by the user computers 11A to 11C, 12A to 12C, 13A to 13C, 14A to 14C, then a mail transmission signal is output from the user computers 11A to 11C, 12A to 12C, 13A to 13C, 14A to 14C to the device monitor servers 15A to 15D. The device monitor servers 15A to 15D detects the E-mail transmission in the user computers 11A to 11C, 12A to 12C, 13A to 13C, 14A to 14C by the E-mail transmission signal output from the user computers 11A to 11C, 12A to 12C, 13A to 13C, 14A to 14C. The device monitor servers 15A to 15D, upon detection of E-mail transmission, cause the particular one of the user computers 11A to 11C, 12A to 12C, 13A to 13C, 14A to 14C which has transmitted the E-mail to output the E-mail transmission information. The E-mail transmission information is stored temporally in the hard disks of the device monitor servers 15A to 15D.

In the device monitor servers 15A to 15D, the first identification data for identifying, by classifying for each of the networks 16A to 16D, the E-mail transmission information received from the user computers 11A to 11C, 12A to 12C, 13A to 13C, 14A to 14C is attached to the particular information on the one hand, and the second identification data for identifying by classifying the E-mail transmission information for each of the user computers 11A to 11C, 12A to 12C, 13A to 13C, 14A to 14C is attached to the particular information on the other hand. The device monitor servers 15A to 15D encrypt the E-mail transmission information, the first identification data and the second identification data (E-mail transmission information encryption means), and periodically transmit the encrypted E-mail transmission information, first identification data and second identification data to the data relay servers 17A, 17B (E-mail transmission information transmission means).

(Web Site Access Monitor)

The device monitor servers 15A to 15D temporally and endlessly monitor the access to the Web site in the user computers 11A to 11C, 12A to 12C, 13A to 13C, 14A to 14C. In the case where the Web site is accessed by any of the user computers 11A to 11C, 12A to 12C, 13A to 13C, 14A to 14C, the device monitor servers 15A to 15D collect the Web site access information from the particular one of the computers 11A to 11C, 12A to 12C, 13A to 13C, 14A to 14C and store the collected Web site access information (Web site access information collection means). In the case where any of the user computers 11A to 11C, 12A to 12C, 13A to 13C, 14A to 14C accesses the Web site using the internet 20, then a Web site access signal is output from the user computers 11A to 11C, 12A to 12C, 13A to 13C, 14A to 14C to the device monitor servers 15A to 15D. The device monitor servers 15A to 15D detect the Web site access by the user computers 11A to 11C, 12A to 12C, 13A to 13C, 14A to 14C based on the Web site access signal output from the user computers 11A to 11C, 12A to 12C, 13A to 13C, 14A to 14C. The device monitor servers 15A to 15D, upon detection of Web site access, cause the particular one of the user computers 11A to 11C, 12A to 12C, 13A to 13C, 14A to 14C which has accessed the Web site to output the Web site access information. The Web site access information is stored temporally in the hard disks of the device monitor servers 15A to 15D.

In the device monitor servers 15A to 15D, the first identification data for identifying, by classifying for each of the networks 16A to 16D, the Web site access information received from the user computers 11A to 11C, 12A to 12C, 13A to 13C, 14A to 14C is attached to the particular information on the one hand, and the second identification data for identifying by classifying the Web site access information for each of the user computers 11A to 11C, 12A to 12C, 13A to 13C, 14A to 14C is attached to the particular information on the other hand. The device monitor servers 15A to 15D encrypt the Web site access information, the first identification data and the second identification data (Web site access information encryption means), and periodically transmit the encrypted Web site access information, first identification data and second identification data to the data relay servers 17A, 17B (Web site access information transmission means).

(External Network Access Monitor)

The device monitor servers 15A to 15D temporally and endlessly monitor the access to an external network in the user computers 11A to 11C, 12A to 12C, 13A to 13C, 14A to 14C. In the case where any of the user computers 11A to 11C, 12A to 12C, 13A to 13C, 14A to 14C accesses an external network other than the networks 16A to 16D formed by the user computers 11A to 11C, 12A to 12C, 13A to 13C, 14A to 14C, the device monitor servers 15A to 15D collect the external network access information from the particular one of the user computers 11A to 11C, 12A to 12C, 13A to 13C, 14A to 14C, and store the collected external network access information (external network access information collection means). Once any of the user computers 11A to 11C, 12A to 12C, 13A to 13C, 14A to 14C accesses an external network using the internet 20, an external network access signal is output from the computers 11A to 11C, 12A to 12C, 13A to 13C, 14A to 14C to the device monitor servers 15A to 15D. The device monitor servers 15A to 15D detects the access by the user computers 11A to 11C, 12A to 12C, 13A to 13C, 14A to 14C to an external network based on an external network access signal output from the user computers 11A to 11C, 12A to 12C, 13A to 13C, 14A to 14C. The device monitor servers 15A to 15D, upon detection of the access to an external network, cause the particular one of the user computers 11A to 11C, 12A to 12C, 13A to 13C, 14A to 14C that has accessed the external network to output the external network access information. The external network access information is stored temporally in the hard disks of the device monitor servers 15A to 15D.

In the device monitor servers 15A to 15D, the first identification data for identifying, by classifying for each of the networks 16A to 16D, the external network access information received from the user computers 11A to 11C, 12A to 12C, 13A to 13C, 14A to 14C is attached to the particular information on the one hand, and the second identification data for identifying by classifying the external network access information for each of the user computers 11A to 11C, 12A to 12C, 13A to 13C, 14A to 14C is attached to the particular information on the other hand. The device monitor servers 15A to 15D encrypt the external network access information, the first identification data and the second identification data (external network access information encryption means), and periodically transmit the encrypted external network access information, first identification data and second identification data to the data relay servers 17A, 17B (external network access information transmission means).

The device monitor servers 15A to 15D transmit the various information to the data relay servers 17A, 17B at intervals of, say, six or twelve hours, one or two days or one or three weeks. According to this embodiment, the device monitor servers 15A to 15D totalize each information at intervals of one day (24 hours), and transmit the totalized one-day information to the data relay servers 17A, 17B. Incidentally, the device monitor servers 15A to 15D transmit the various information to the data relay servers 17A, 17B at intervals set by the data management computer 18, which intervals can be freely changed by the data management computer 18. In the data relay servers 17A, 17B, each information transmitted from the device monitor servers 15A to 15D is stored in a storage unit such as a data base or an external hard disk.

The data management computer 18 has a central processing unit and a memory and has mounted thereon a large-capacity hard disk. The data management computer 18 is connected with a display 22 and a keyboard 23 through an interface, and though not shown, also connected with a printer, a scanner and a data base through an interface. The data management computer 18 has the function of transmitting and receiving the E-mail. The data management computer 18 manages by acquiring the various information transmitted from the device monitor servers 15A to 15D to the data relay servers 17A, 17B. The data management computer 18, under the control of the operating system, starts the data management application stored in the instruction file of a memory, and in accordance with the application thus started, executes the operation of each means described below.

(Network Configuration Information Management)

The data management computer 18 accesses the data relay servers 17B, 17B at predetermined intervals to acquire the network configuration information, the first identification data (network name, network identification number, etc.), the second identification data (computer name, work group/domain, MAC address, IP address, user computer identification number, etc.) and the information establishment day/hour transmitted from the device monitor servers 15A to 15D, and decrypt the network configuration information, the first identification data, the second identification data and the information establishment day/hour acquired from the data relay servers 17A, 17B (network configuration information decryption means). The data management computer 18, based on the first identification data, classifies the decrypted network configuration information and information establishment day/hour for each of the networks 16A to 16D, and stores, in the data base, the network configuration information and the information establishment day/hour in the state classified for each of the networks 16A to 16D, while at the same time storing the decrypted second identification information in the data base (network configuration information storage means). The data management computer 18 outputs the network configuration information by classifying them for each of the networks 16A to 16D (network configuration information output means). Incidentally, once the network configuration is altered, the network configuration information after alteration is transmitted from the device monitor servers 15A to 15D to the data relay servers 17A, 17B, and the data management computer 18 acquire the altered network configuration information from the data relay servers 17A, 17B.

(Use History Information Management)

The data management computer 18 accesses the data relay servers 17B, 17B at predetermined intervals to acquire the use history information, the first identification data and the second identification data transmitted from the device monitor servers 15A to 15D, and decrypt the use history information, the first identification data and the second identification data acquired from the data relay servers 17A, 17B (use history information decryption means). The data management computer 18, based on the first identification data, classifies the decrypted use history information for each of the networks 16A to 16D while at the same time classifying the use history information for each of the user computers 11A to 11C, 12A to 12C, 13A to 13C, 14A to 14C based on the second identification data. The data management computer 18 stores the use history information classified for each of the networks 16A to 16D in the data base (use history information first storage means). At the same time, the use history information classified for each of the user computers 11A to 11C, 12A to 12C, 13A to 13C, 14A to 14C is stored in the data base (use history information second storage means). Also, the data management computer 18 outputs the use history information by classifying them for each of the networks 16A to 16D (use history information first output means) on the one hand and outputs the use history information by classifying them for each of the user computers 11A to 11C, 12A to 12C, 13A to 13C, 14A to 14C (use history information second output means) on the other hand.

(Access History Information Management)

The data management computer 18 accesses the data relay servers 17B, 17B at predetermined intervals to acquire the access history information, the first identification data and the second identification data transmitted from the device monitor servers 15A to 15D, and decrypts the access history information, the first identification data and the second identification data acquired from the data relay servers 17A, 17B (access history information decrypting means). The data management computer 18, based on the first identification data, classifies the decrypted access history information for each of the networks 16A to 16D while at the same time classifying the access history information for each of the user computers 11A to 11C, 12A to 12C, 13A to 13C, 14A to 14C based on the second identification data. The data management computer 18 stores in the data base the access history information classified for each of the networks 16A to 16D (access history information first storage means). At the same time, the access history information classified for each of the user computers 11A to 11C, 12A to 12C, 13A to 13C, 14A to 14C is stored in the data base (access history information second storage means). Also, the data management computer 18 outputs the access history information by classifying them for each of the networks 16A to 16D (access history information first output means) on the one hand and outputs the access history information by classifying them for each of the user computers 11A to 11C, 12A to 12C, 13A to 13C, 14A to 14C (access history information second output means) on the other hand.

(Application Alteration Management)

The data management computer 18 can add, change or delete, for each of the networks 16A to 16D, the usable application used by the user computers 11A to 11C, 12A to 12C, 13A to 13C, 14A to 14C (usable application alteration means). The data management computer 18 encrypts the first application use rule after alteration of an application (first application use rule encryption means), and transmits the encrypted first application use rule to the data relay servers 17A, 17B. The device monitor servers 15A to 15D access the data relay servers 17A, 17B to acquire the first application use rule, and decrypts the first application use rule acquired from the data relay servers 17A, 17B (first application use rule decryption means). The device monitor servers 15A to 15D output the decrypted first application use rule to each of the user computers 11A to 11C, 12A to 12C, 13A to 13C, 14A to 14C. The user computers 11A to 11C, 12A to 12C, 13A to 13C, 14A to 14C comply with the first application use rule output from the device monitor servers 15A to 15D. The data management computer 18 can set a different first application use rule for each of the networks 16A to 16D.

(Unusable Application Alteration Management)

The data management computer 18 can add, change or delete, for each of the networks 16A to 16D, of the unusable application prohibited to use in the user computers 11A to 11C, 12A to 12C, 13A to 13C, 14A to 14C (unusable application alteration means). The data management computer 18 encrypts the second application use rule after alteration of an unusable application (second application use rule encryption means), and transmits the encrypted second application use rule to the data relay servers 17A, 17B. The device monitor servers 15A to 15D access the data relay servers 17A, 17B to acquire the second application use condition, and decrypts the second application use rule acquired from the data relay servers 17A, 17B (second application use rule decryption means). The device monitor servers 15A to 15D output the decrypted second application use rule to each of the user computers 11A to 11C, 12A to 12C, 13A to 13C, 14A to 14C. The user computers 11A to 11C, 12A to 12C, 13A to 13C, 14A to 14C comply with the second application use condition output from the device monitor servers 15A to 15D. The data management computer 18 can set a different second application use rule for each of the networks 16A to 16D.

(Information Transmission Interval Management)

The data management computer 18 can set or change, for each of the networks 16A to 16D and various information, the transmission interval at which the various information are transmitted by the device monitor servers 15A to 15D to the data relay servers 17A, 17B (transmission interval setting and changing means). The data management computer 18, after setting or changing the transmission interval, encrypts the particular interval (transmission interval setting and alteration means), and transmits the encrypted transmission interval to the data relay servers 17A, 17B. The device monitor servers 15A to 15D access the data relay servers 17A, 17B to acquire the transmission interval, and decrypts the transmission interval acquired from the data relay servers 17A, 17B (transmission interval decryption means). The device monitor servers 15A to 15D output the decrypted transmission interval to each of the user computers 11A to 11C, 12A to 12C, 13A to 13C, 14A to 14C. The user computers 11A to 11C, 12A to 12C, 13A to 13C, 14A to 14C, in accordance with the transmission interval output from the device monitor servers 15A to 15D, output each information to the device monitor servers 15A to 15D at the particular transmission interval.

(Installation Information Management)

The data management computer 18 accesses the data relay servers 17B, 17B at predetermined intervals to acquire the installation information, the first identification data and the second identification data transmitted from the device monitor servers 15A to 15D, and decrypts the installation information, the first identification data and the second identification data acquired from the data relay servers 17A, 17B (installation information decryption means). The data management computer 18, based on the first identification data, classifies the decrypted installation information for each of the networks 16A to 16D while at the same time classifying the installation information for each of the user computers 11A to 11C, 12A to 12C, 13A to 13C, 14A to 14C based on the second identification data. The data management computer 18 stores, in the data base, the installation information classified for each of the networks 16A to 16D (installation information first storage means). At the same time, the installation information classified for each of the user computers 11A to 11C, 12A to 12C, 13A to 13C, 14A to 14C is stored in the data base (installation information second storage means). Also, the data management computer 18 outputs the installation information by classifying them for each of the networks 16A to 16D (installation information first output means) on the one hand and outputs the installation information by classifying them for each of the user computers 11A to 11C, 12A to 12C, 13A to 13C, 14A to 14C (installation information second output means) on the other hand.

(Uninstallation Information Management)

The data management computer 18 accesses the data relay servers 17B, 17B at predetermined intervals to acquire the uninstallatiton information, the first identification data and the second identification data transmitted from the device monitor servers 15A to 15D, and decrypts the uninstallation information, the first identification data and the second identification data acquired from the data relay servers 17A, 17B (uninstallation information decryption means). The data management computer 18, based on the first identification data, classifies the decrypted uninstallation information for each of the networks 16A to 16D while at the same time classifying the uninstallation information for each of the user computers 11A to 11C, 12A to 12C, 13A to 13C, 14A to 14C based on the second identification data. The data management computer 18 stores, in the data base, the uninstallation information classified for each of the networks 16A to 16D (uninstallation information first storage means). At the same time, the uninstallation information classified for each of the user computers 11A to 11C, 12A to 12C, 13A to 13C, 14A to 14C is stored in the data base (uninstallation information second storage means). Also, the data management computer 18 outputs the uninstallation information by classifying them for each of the networks 16A to 16D (uninstallation information first output means) on the one hand and outputs the uninstallation information by classifying them for each of the user computers 11A to 11C, 12A to 12C, 13A to 13C, 14A to 14C (uninstallation information second output means) on the other hand.

(Print History Information Management)

The data management computer 18 accesses the data relay servers 17B, 17B at predetermined intervals to acquire the print history information, the first identification data and the second identification data transmitted from the device monitor servers 15A to 15D, and decrypts the print history information, the first identification data and the second identification data acquired from the data relay servers 17A, 17B (print history information decryption means). The data management computer 18, based on the first identification data, classifies the decrypted print history information for each of the networks 16A to 16D while at the same time classifying the print history information for each of the user computers 11A to 11C, 12A to 12C, 13A to 13C, 14A to 14C based on the second identification data. The data management computer 18 stores, in the data base, the print history information classified for each of the networks 16A to 16D (print history information first storage means). At the same time, the print history information classified for each of the user computers 11A to 11C, 12A to 12C, 13A to 13C, 14A to 14C is stored in the data base (print history information second storage means). Also, the data management computer 18 outputs the print history information by classifying them for each of the networks 16A to 16D (print history information first output means) on the one hand and outputs the print history information by classifying them for each of the user computers 11A to 11C, 12A to 12C, 13A to 13C, 14A to 14C (print history information second output means) on the other hand.

(File Access History Information Management)

The data management computer 18 accesses the data relay servers 17B, 17B at predetermined intervals to acquire the file access history information, the first identification data and the second identification data transmitted from the device monitor servers 15A to 15D, and decrypts the file access history information, the first identification data and the second identification data acquired from the data relay servers 17A, 17B (file access information decryption means). The data management computer 18, based on the first identification data, classifies the decrypted file access information for each of the networks 16A to 16D while at the same time classifying the file access information for each of the user computers 11A to 11C, 12A to 12C, 13A to 13C, 14A to 14C based on the second identification data. The data management computer 18 stores, in the data base, the file access information classified for each of the networks 16A to 16D (file access information first storage means). At the same time, the file access information classified for each of the user computers 11A to 11C, 12A to 12C, 13A to 13C, 14A to 14C is stored in the data base (file access information second storage means). Also, the data management computer 18 outputs the file access information by classifying them for each of the networks 16A to 16D (file access information first output means) on the one hand and outputs the file access information by classifying them for each of the user computers 11A to 11C, 12A to 12C, 13A to 13C, 14A to 14C (file access information second output means) on the other hand.

(External Use History Information Management)

The data management computer 18 accesses the data relay servers 17B, 17B at predetermined intervals to acquire the external use history information, the first identification data and the second identification data transmitted from the device monitor servers 15A to 15D, and decrypts the external use history information, the first identification data and the second identification data acquired from the data relay servers 17A, 17B (external use history information decryption means). The data management computer 18, based on the first identification data, classifies the decrypted external use history information for each of the networks 16A to 16D while at the same time classifying the external use history information for each of the user computers 11A to 11C, 12A to 12C, 13A to 13C, 14A to 14C based on the second identification data. The data management computer 18 stores, in the data base, the external use history information classified for each of the networks 16A to 16D (external use history information first storage means). At the same time, the external use history information classified for each of the user computers 11A to 11C, 12A to 12C, 13A to 13C, 14A to 14C is stored in the data base (external use history information second storage means). Also, the data management computer 18 outputs the external use history information by classifying them for each of the networks 16A to 16D (external use history information first output means) on the one hand and outputs the external use history information by classifying them for each of the user computers 11A to 11C, 12A to 12C, 13A to 13C, 14A to 14C (external use history information second output means) on the other hand.

(Undesignated Time Use History Information Management)

The data management computer 18 accesses the data relay servers 17B, 17B at predetermined intervals to acquire the undesignated time use history information, the first identification data and the second identification data transmitted from the device monitor servers 15A to 15D, and decrypts the undesignated time use history information, the first identification data and the second identification data acquired from the data relay servers 17A, 17B (undesignated time use history information decryption means). The data management computer 18, based on the first identification data, classifies the decrypted undesignated time use history information for each of the networks 16A to 16D while at the same time classifying the undesignated time use history information for each of the user computers 11A to 11C, 12A to 12C, 13A to 13C, 14A to 14C based on the second identification data. The data management computer 18 stores, in the data base, the undesignated time use history information classified for each of the networks 16A to 16D (undesignated time use history information first storage means). At the same time, the undesignated time use history information classified for each of the user computers 11A to 11C, 12A to 12C, 13A to 13C, 14A to 14C is stored in the data base (undesignated time use history information second storage means). Also, the data management computer 18 outputs the undesignated time use history information by classifying them for each of the networks 16A to 16D (undesignated time use history information first output means) on the one hand and outputs the undesignated time use history information by classifying them for each of the user computers 11A to 11C, 12A to 12C, 13A to 13C, 14A to 14C (undesignated time use history information second output means) on the other hand.

(Bring-Out Action Information Management)

The data management computer 18 accesses the data relay servers 17B, 17B at predetermined intervals to acquire the bring-out action information, the first identification data and the second identification data transmitted from the device monitor servers 15A to 15D, and decrypts the bring-out action information, the first identification data and the second identification data acquired from the data relay servers 17A, 17B (bring-out action information decryption means). The data management computer 18, based on the first identification data, classifies the decrypted bring-out action information for each of the networks 16A to 16D while at the same time classifying the bring-out action information for each of the user computers 11A to 11C, 12A to 12C, 13A to 13C, 14A to 14C based on the second identification data. The data management computer 18 stores, in the data base, the bring-out action information classified for each of the networks 16A to 16D (bring-out action information first storage means). At the same time, the bring-out action information classified for each of the user computers 11A to 11C, 12A to 12C, 13A to 13C, 14A to 14C is stored in the data base (bring-out action information second storage means). Also, the data management computer 18 outputs the bring-out action information by classifying them for each of the networks 16A to 16D (bring-out action information first output means) on the one hand and outputs the bring-out action information by classifying them for each of the user computers 11A to 11C, 12A to 12C, 13A to 13C, 14A to 14C (bring-out action information second output means) on the other hand.

(Print Action Information Management)

The data management computer 18 accesses the data relay servers 17B, 17B at predetermined intervals to acquire the print action information, the first identification data and the second identification data transmitted from the device monitor servers 15A to 15D, and decrypts the print action information, the first identification data and the second identification data acquired from the data relay servers 17A, 17B (print action information decryption means). The data management computer 18, based on the first identification data, classifies the decrypted print action information for each of the networks 16A to 16D while at the same time classifying the print action information for each of the user computers 11A to 11C, 12A to 12C, 13A to 13C, 14A to 14C based on the second identification data. The data management computer 18 stores, in the data base, the print action information classified for each of the networks 16A to 16D (print action information first storage means). At the same time, the print action information classified for each of the user computers 11A to 11C, 12A to 12C, 13A to 13C, 14A to 14C is stored in the data base (print action information second storage means). Also, the data management computer 18 outputs the print action information by classifying them for each of the networks 16A to 16D (print action information first output means) on the one hand and outputs the print action information by classifying them for each of the user computers 11A to 11C, 12A to 12C, 13A to 13C, 14A to 14C (print action information second output means) on the other hand.

(E-Mail Transmission Information Management)

The data management computer 18 accesses the data relay servers 17B, 17B at predetermined intervals to acquire the E-mail transmission information, the first identification data and the second identification data transmitted from the device monitor servers 15A to 15D, and decrypts the E-mail transmission information, the first identification data and the second identification data acquired from the data relay servers 17A, 17B (E-mail transmission information decryption means). The data management computer 18, based on the first identification data, classifies the decrypted E-mail transmission information for each of the networks 16A to 16D while at the same time classifying the E-mail transmission information for each of the user computers 11A to 11C, 12A to 12C, 13A to 13C, 14A to 14C based on the second identification data. The data management computer 18 stores, in the data base, the E-mail transmission information classified for each of the networks 16A to 16D (E-mail transmission history information first storage means). At the same time, the E-mail transmission information classified for each of the user computers 11A to 11C, 12A to 12C, 13A to 13C, 14A to 14C is stored in the data base (E-mail transmission information second storage means). Also, the data management computer 18 outputs the E-mail transmission information by classifying them for each of the networks 16A to 16D (E-mail transmission history information first output means) on the one hand and outputs the E-mail transmission information by classifying them for each of the user computers 11A to 11C, 12A to 12C, 13A to 13C, 14A to 14C (E-mail transmission information second output means) on the other hand.

(Web Site Access Information Management)

The data management computer 18 accesses the data relay servers 17B, 17B at predetermined intervals to acquire the Web site access information, the first identification data and the second identification data transmitted from the device monitor servers 15A to 15D, and decrypts the Web site access information, the first identification data and the second identification data acquired from the data relay servers 17A, 17B (Web site access information decryption means). The data management computer 18, based on the first identification data, classifies the decrypted Web site access information for each of the networks 16A to 16D while at the same time classifying the Web site access information for each of the user computers 11A to 11C, 12A to 12C, 13A to 13C, 14A to 14C based on the second identification data. The data management computer 18 stores, in the data base, the Web site access information classified for each of the networks 16A to 16D (Web site access information first storage means). At the same time, the Web site access information classified for each of the user computers 11A to 11C, 12A to 12C, 13A to 13C, 14A to 14C is stored in the data base (Web site access information second storage means). Also, the data management computer 18 outputs the Web site access information by classifying them for each of the networks 16A to 16D (Web site access information first output means) on the one hand and outputs the Web site access information by classifying them for each of the user computers 11A to 11C, 12A to 12C, 13A to 13C, 14A to 14C (Web site access information second output means) on the other hand.

(External Network Access Information Management)

The data management computer 18 accesses the data relay servers 17B, 17B at predetermined intervals to acquire the external network access information, the first identification data and the second identification data transmitted from the device monitor servers 15A to 15D, and decrypt the external network access information, the first identification data and the second identification data acquired from the data relay servers 17A, 17B (external network access information decryption means). The data management computer 18, based on the first identification data, classifies the decrypted external network access information for each of the networks 16A to 16D while at the same time classifying the external network access information for each of the user computers 11A to 11C, 12A to 12C, 13A to 13C, 14A to 14C based on the second identification data. The data management computer 18 stores, in the data base, the external network access information classified for each of the networks 16A to 16D (external network access information first storage means). At the same time, the external network access information classified for each of the user computers 11A to 11C, 12A to 12C, 13A to 13C, 14A to 14C is stored in the data base (external network access information second storage means). Also, the data management computer 18 outputs the external network access information by classifying them for each of the networks 16A to 16D (external network access information first output means) on the one hand and outputs the external network access information by classifying them for each of the user computers 11A to 11C, 12A to 12C, 13A to 13C, 14A to 14C (external network access information second output means) on the other hand.

The encryption system whereby the device monitor servers 15A to 15D and the data management computer 18 encrypt the various information is not specifically limited, and the existing encryption systems such as the public key encryption system or the common key encryption system can be used. The public key encryption system that is used includes the RSA system, the EPOC encryption system, the Rabin encryption system, the Diffie-Hellman key distribution ElGamal elliptic curve encryption system or the elliptic curve Diffie-Hellman key distribution ElGamal elliptic curve encryption system. As the common key encryption system, on the other hand, any one of the DES encryption system, the FEAL encryption system, the IDEA encryption system, the MISTY encryption system, the MULTI encryption system and the RC2/4/5 encryption system can be used. Also, the MIX encryption system can be used as a combination of the public key encryption system (RSA encryption system) and the common key encryption system (DES encryption system).

In the case where the various information are not transmitted to the device monitor servers 15A to 15D at predetermined intervals but transmitted at irregular time intervals from the device monitor servers 15A to 15D to the relay servers 17A, 17B or in the case where the various information are not transmitted from the device monitor servers 15A to 15D to the relay servers 17A, 17B, then the data management computer 18 transmits the transmission failure information by E-mail to each of the device monitor servers 15A to 15D to notify the transmission failure state of the information (E-mail transmission means). The manager of the device monitor servers 15A to 15D can be informed of the fault of the servers 15A to 15D or the disorder of the network configuration, and thus can quickly take a countermeasure against the fault or the disorder. Also, since the stagnation of transmission of the various information can be prevented, the various information in the networks 16A to 16D can be positively acquired, thereby making it possible to positively grasp and monitor the manner in which the user computers 11A to 11C, 12A to 12C, 13A to 13C, 14A to 14C are used or operated.

(Authentication Procedure)

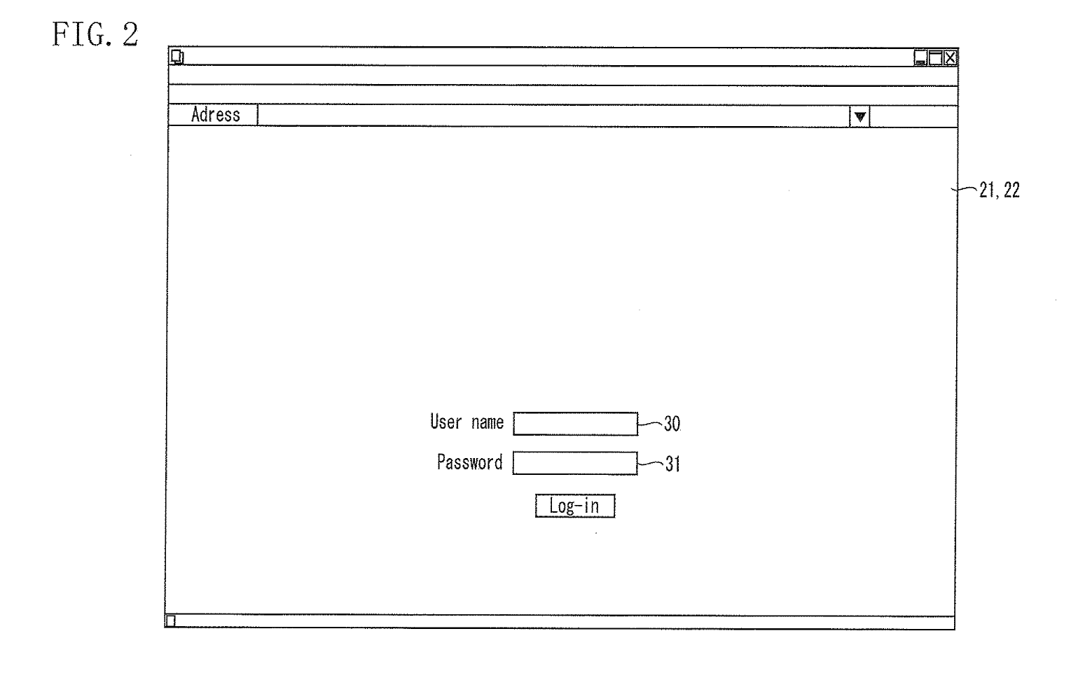

FIG. 2 is a diagram showing an example of an authentication procedure display screen displayed on a displays 21, 22 of the device monitor servers 15A to 15D and the data management computer 18. The data management computer 18 authenticates the device monitor servers 15A to 15D and the management computer 18 at the time of booting (authentication execution means). The object of authentication is to judge whether the person who has booted the management computer 18 is a legitimately authorized system manager. Another object of the authentication is to judge whether the device monitor servers 15A to 15D are to be logged in to the data management computer 18 or not. In other words, whether the device monitor servers 15A to 15D to be logged in to the data management computer 18 are servers in this system 10 or not is confirmed. The authentication method carried out by the data management computer 18 is the password authentication. In addition to the password authentication, the fingerprint, the voiceprint, the iris or the IC card can be used for authentication. Incidentally, the one-time password can also be employed for the password authentication.

Once the device monitor servers 15A to 15D or the data management computer 18 is booted, a user name input area 30 and a password input area 31 are displayed on the displays 21, 22 thereof as shown in FIG. 2. The system manager or the network manager inputs the user name and the password in the input areas. The data management computer 18 compares the input user name and password with those stored in a memory, and thus judges the legitimacy of the user name and the password. In the case where the user name and the password are right and the authentication result is a success, the use of the data management computer 18 is permitted. Also, the device monitor servers 15A to 15D are logged in to the data management computer 18. In the case where the user name or the password is erroneous and the authentication result is a failure, on the other hand, the use of the data management computer 18 is prohibited, and a use prohibit message is displayed on the display 22. Also, the device monitor servers 15A to 15D are prohibited from being logged in to the data management computer 18, and a “no log-in” message is displayed on the display 21. In the case where the authentication is carried out at the time of booting the data management computer 18 or log-in to the data management computer 18 with wrong authentication information, then the use of the management computer 18 is prohibited and so is the log-in to the management computer 18. Thus, the illegal use of the device monitor servers 15A to 15D and the data management computer 18 is prevented, thereby making it possible to prevent the illegal browsing, illegal alteration or illegal use of the various information stored in the data base or the hard disk.

(Network Configuration Information)

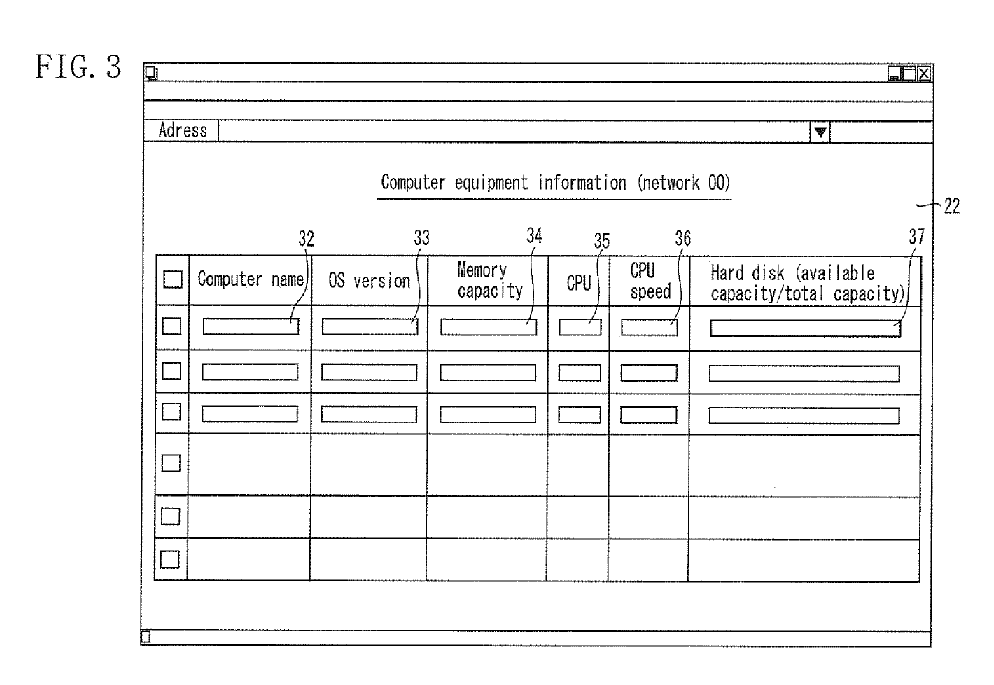

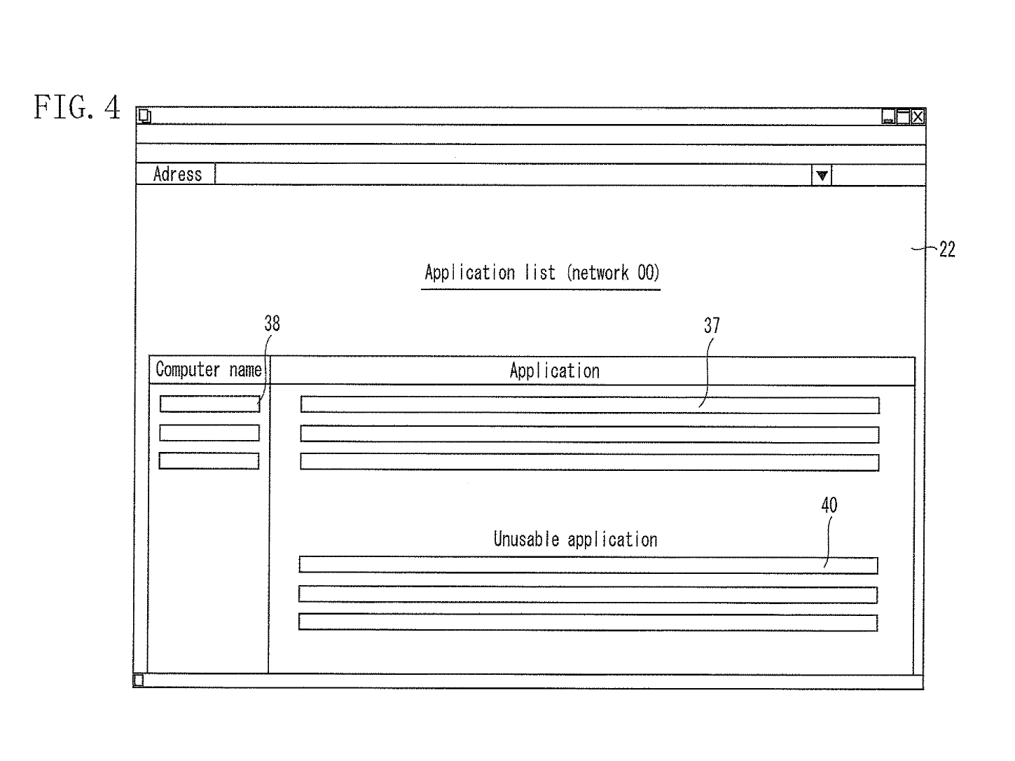

FIG. 3 is a diagram showing an example of the user computer equipment information, and FIG. 4 a diagram showing an example of an application list. In FIGS. 3 and 4, specific contents of each item are not shown. In the data management computer 18, the equipment information of the user computers 11A to 11C, 12A to 12C, 13A to 13C, 14A to 14C acquired tom the data relay servers 17A, 17B and the application information and the unusable application information installed in the user computers 11A to 11C, 12A to 12C, 13A to 13C, 14A to 14C are classified for each of the networks 16A to 16D and displayed on a display 22, while at the same time being output from a printer (network configuration information output means).

The system manager, after making the data management computer 18 usable by following the authentication procedure, selects the computer equipment information from the report items on a report display screen (not shown) displayed on the display 22 of the computer 18, and designates any of the networks 16A to 16D. After selecting the computer equipment information and designating any of the networks 16A to 16D, the data management computer 18 specifies the first and second identification data corresponding to the designated one of the networks 16A to 16D, so that the network configuration information corresponding to the first identification data and any of the user computers 11A to 11C, 12A to 12C, 13A to 13C, 14A to 14C corresponding to the second identification data are extracted from the data base. Next, in the data management computer 18, as shown in FIG. 3, the computer equipment information of each of the user computers 11A to 11C, 12A to 12C, 13A to 13C, 14A to 14C existing in the designated one of the networks 16A to 16D is displayed on the display (network configuration information output means). FIG. 3 shows that the computer name is indicated in a computer name display area 32, the OS version in an OS version display area 33, the memory capacity in a memory capacity display area 34, the CPU in a CPU display area 35, the CPU speed in a CPU speed display area 36 and the hard disk (available capacity/total capacity) in a hard disk display area 37 as the computer equipment information.

Also, an application list is selected from the report items displayed on the display 22, while at the same time designating any of the networks 16A to 16D. Then, the data management computer 18 specifies the first and second identification data corresponding to the designated one of the networks 16A to 16D, so that the network configuration information corresponding to the first identification data and the user computers 11A to 11C, 12A to 12C, 13A to 13C, 14A to 14C corresponding to the second identification data are extracted from the data base. Next, as shown in FIG. 4, the data management computer 18 displays, on the display 22, the application list installed in each of the user computers 11A to 11C, 12A to 12C, 13A to 13C, 14A to 14C on the one hand, and the unusable application held in the device monitor servers 15A to 15D on the other hand (network configuration information output means).

FIG. 4 shows an application list in which the computer name is displayed in a computer name display area 38, an application in an application display area 39, and an unusable application in an unusable application display area 40. The system manager can output each information shown in FIGS. 3 and 4 from the printer. The system manager, by using the computer equipment information, the application information and the unusable application information, can grasp the hardware configuration of the user computers 11A to 11C, 12A to 12C, 13A to 13C, 14A to 14C, and the application and the unusable application installed in the user computers 11A to 11C, 12A to 12C, 13A to 13C, 14A to 14C forming the networks 16A to 16D. Thus, the management of the user computers 11A to 11C, 12A to 12C, 13A to 13C, 14A to 14C and the management of each application can be carried out easily for each of the networks 16A to 16D.

(Use History Information)

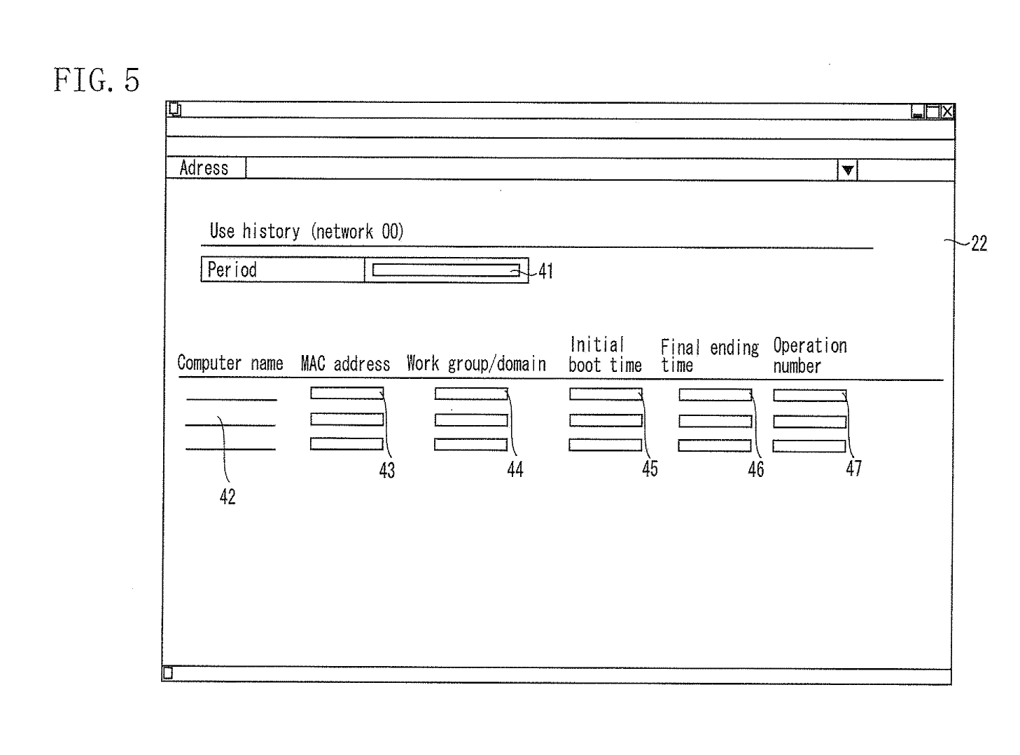

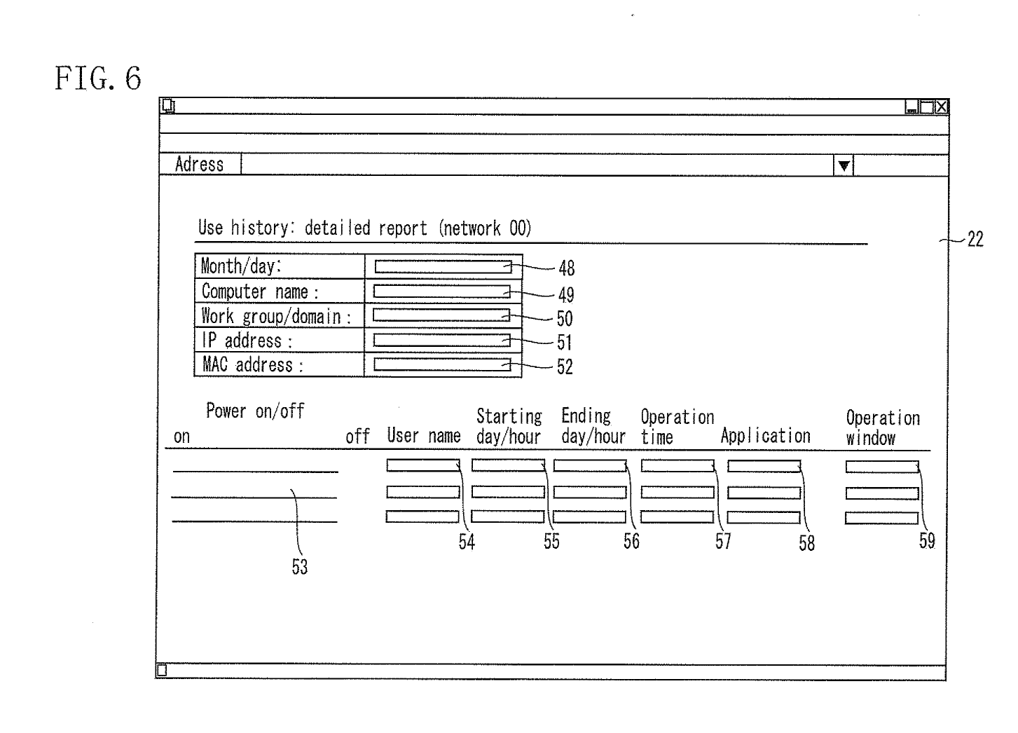

FIGS. 5 and 6 are diagrams showing an example of the use history information of an application, in which the use history of an application of the user computers 11A to 11C, 12A to 12C, 13A to 13C, 14A to 14C is shown. Incidentally, in FIGS. 5 and 6, specific contents of each item are not shown. In the data management computer 18, the use history information of the application in the user computers 11A to 11C, 12A to 12C, 13A to 13C, 14A to 14C acquired from the data relay servers 17A, 17B are classified for each of the networks 16A to 16D and displayed on the display 22, while at the same time being output from the printer (use history information first output means). Also, the application use history information is classified for each of the user computers 11A to 11C, 12A to 12C, 13A to 13C, 14A to 14C and displayed on the display 22, while at the same time being output from the printer (use history information second output means). The data management computer 18 can output by classifying the use history information in units of a predetermined period such as day, week or month.

The system manager, after making the data management computer 18 usable by following the authentication procedure, selects (clicks) the use history information from the report items on the report display screen (not shown) displayed on the display 22 of the computer 18 thereby to designate both the networks 16A to 16D and the period. Then, the data management computer 18 specifies the first and second identification data corresponding to the designated one of the networks 16A to 16D, and extracts the use history information corresponding to the first identification data and the use history information corresponding to the second identification data from the data base. Next, in the data management computer 18, as shown in FIG. 5, the application use history of the user computers 11A to 11C, 12A to 12C, 13A to 13C, 14A to 14C in the designated one of the networks 16A to 16D during the designated period is displayed on the display 22 (use history information first output means). As an example of the use history information, FIG. 5 shows the designated period in a period display area 41, the computer name (the name of the computer that has used the application) in a computer name display area 42, the MAC address in a MAC address display area 43, the work group/domain in a work group/domain display area 44, the initial booting time in an initial booting time display area 45, the final termination time in a final termination time display area 46 and the number of times the application is operated in an operation number display area 47.

The computer name displayed in the underlined part of the screen shown in FIG. 5 is selected (clicked). Then, the data management computer 18, as shown in FIG. 6, displays the detailed application use history of the selected one of the user computers 11A to 11C, 12A to 12C, 13A to 13C, 14A to 14C on the display 22 (use history information second output means). As an example of the detailed use history information, FIG. 6 shows the month/day in a month/day display area 48, the computer name in a computer name display area 49, the work group/domain in a work group/domain display area 50, the IP address in an IP address display area 51 and the MAC address in a MAC address display area 52. Further, the power on/off record is displayed in a power on/off record display area 53, the user name (the name of the user of any of the user computers 11A to 11C, 12A to 12C, 13A to 13C, 14A to 14C that has used an application) in a user name display area 54, the starting day/hour (the day/hour at which the use of an application is started) in a starting day/hour display area 55, the ending day/hour (the day/hour at which the use of an application is ended) in an ending day/hour display area 56, the operation time (the time during which an application is used) in an operation time display area 57, the application name (the name of the application used) in an application name display area 58, and the operation window name (the name of the operation window of the application used) in an operation window name display area 59. The system manager can output the application use history information of FIGS. 5 and 6 from the printer.

In this system 10, the data management computer 18 manages the use history information of an application in the user computers 11A to 11C, 12A to 12C, 13A to 13C, 14A to 14C for each of the networks 16A to 16D or for each of the user computers 11A to 11C, 12A to 12C, 13A to 13C, 14A to 14C. Thus, the system manager can grasp the manner in which the application is used in the user computers 11A to 11C, 12A to 12C, 13A to 13C, 14A to 14C of each of the networks 16A to 16D through the data management computer 18, and can monitor the use of the application in the user computers 11A to 11C, 12A to 12C, 13A to 13C, 14A to 14C for each of the networks 16A to 16D or each of the user computers 11A to 11C, 12A to 12C, 13A to 13C, 14A to 14C, while at the same time controlling the unlimited use of the application.

(Access History Information)

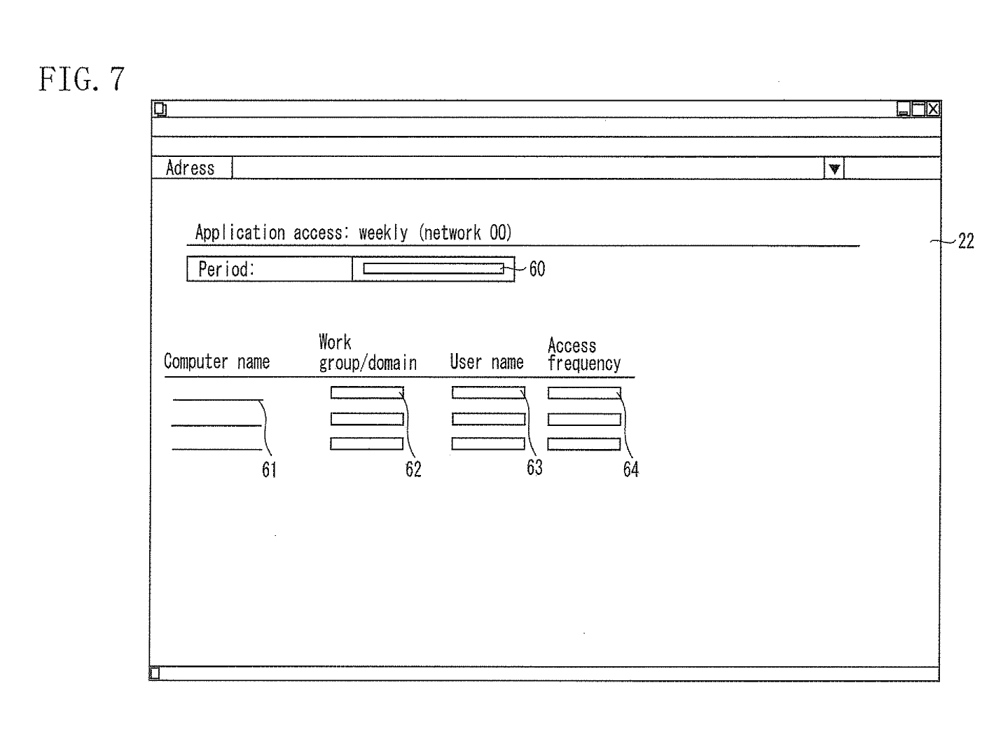

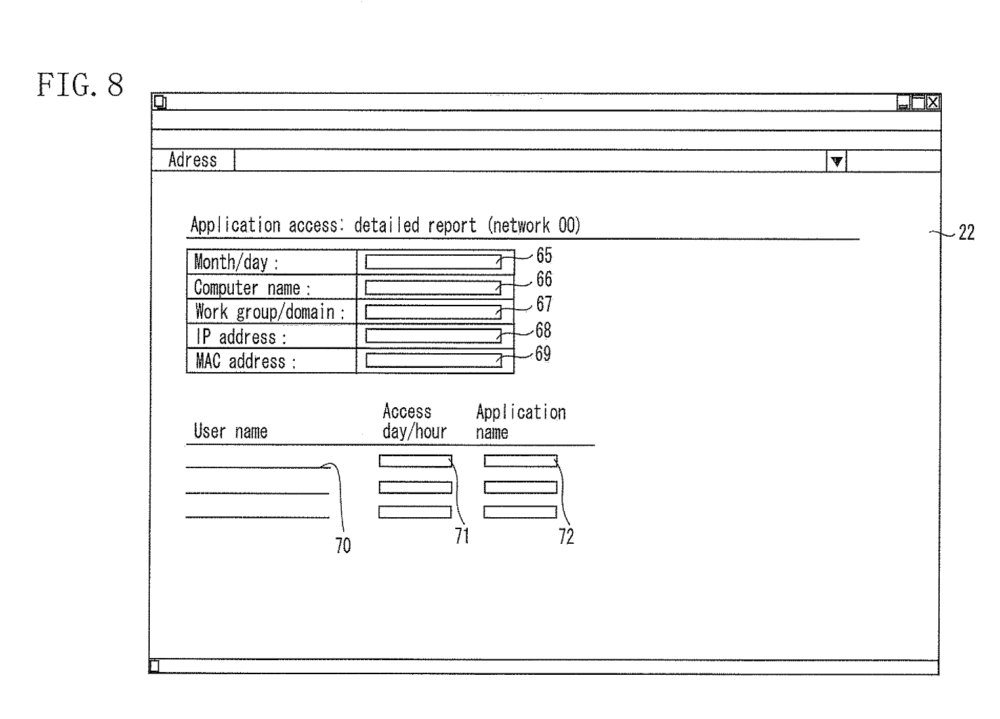

FIGS. 7 and 8 are diagrams showing an example of the access history information, in which the weekly access history of the user computers 11A to 11C, 12A to 12C, 13A to 13C, 14A to 14C is shown. Incidentally, in FIGS. 7 and 8, specific contents of each item are not shown. In the data management computer 18, the history information of access to an unusable application in the user computers 11A to 11C, 12A to 12C, 13A to 13C, 14A to 14C acquired from the data relay servers 17A, 17B is classified for each of the networks 16A to 16D and displayed on the display 22, while at the same time being output from the printer (access history information first output means). Also, the history information of access to the unusable application is classified for each of the user computers 11A to 11C, 12A to 12C, 13A to 13C, 14A to 14C and displayed on the display 22, while at the same time being output from the printer (access history information second output means). The data management computer 18 can output by classifying the access history information in units of a predetermined period such as day, week or month.

The system manager, after making the data management computer 18 usable by following the authentication procedure, selects (clicks) the access history information from the report items on the report display screen (not shown) displayed on the display 22 of the computer 18 thereby to designate any of the networks 16A to 16D and the period. Once the access history information is selected and any of the networks 16A to 16D and the period are designated, the data management computer 18 specifies the first and second identification data corresponding to the designated one of the networks 16A to 16D, and extracts the access history information corresponding to the first identification data and the access history information corresponding to the second identification data from the data base. Next, in the data management computer 18, as shown in FIG. 7, the application history of access to an unusable application of the user computers 11A to 11C, 12A to 12C, 13A to 13C, 14A to 14C in the designated one of the networks 16A to 16D during the designated period is displayed on the display 22 (access history information first output means). As an example of the access history information, FIG. 7 shows the designated period in a period display area 60, the computer name (the name of the computer that has accessed an unusable application) in a computer name display area 61, the work group/domain in a work group/domain display area 62, the user name (the name of the user of any of the user computers 11A to 11C, 12A to 12C, 13A to 13C, 14A to 14C that has accessed an unusable application) in a user name display area 63, and the access number (the number of times accessed to an application) in an access number display area 64.

The computer name displayed in the underlined part of the screen shown in FIG. 7 is selected (clicked). Then, the data management computer 18, as shown in FIG. 8, displays the detailed access history of the selected one of the computers 11A to 11C, 12A to 12C, 13A to 13C, 14A to 14C on the display 22 (access history information second output means). As an example of the detailed access history information, FIG. 8 shows the month/day-to-month/day period (one week) in a month/day display area 65, the computer name in a computer name display area 66, the work group/domain in a work group/domain display area 67, the IP address in an IP address display area 68 and the MAC address in a MAC address display area 69. Further, the user name is displayed in a user name display area 70, the access day/hour (day/hour of access to an unusable application) in an access day/hour display area 71, and the application name (name of the unusable application accessed) in an application name display area 72. The manager can output the application access history information of FIGS. 7 and 8 from the printer.

In this system 10, the data management computer 18 manages the history information of access to an unusable application in the user computers 11A to 11C, 12A to 12C, 13A to 13C, 14A to 14C for each of the networks 16A to 16D or for each of the user computers 11A to 11C, 12A to 12C, 13A to 13C, 14A to 14C. Thus, the system manager can grasp the manner in which an unusable application is accessed in the user computers 11A to 11C, 12A to 12C, 13A to 13C, 14A to 14C of each of the networks 16A to 16D through the data management computer 18, and can monitor the access to the unusable application in the user computers 11A to 11C, 12A to 12C, 13A to 13C, 14A to 14C for each of the networks 16A to 16D or for each of the user computers 11A to 11C, 12A to 12C, 13A to 13C, 14A to 14C, while at the same time controlling the action to access an unusable application.

(Application Addition, Change and Deletion)

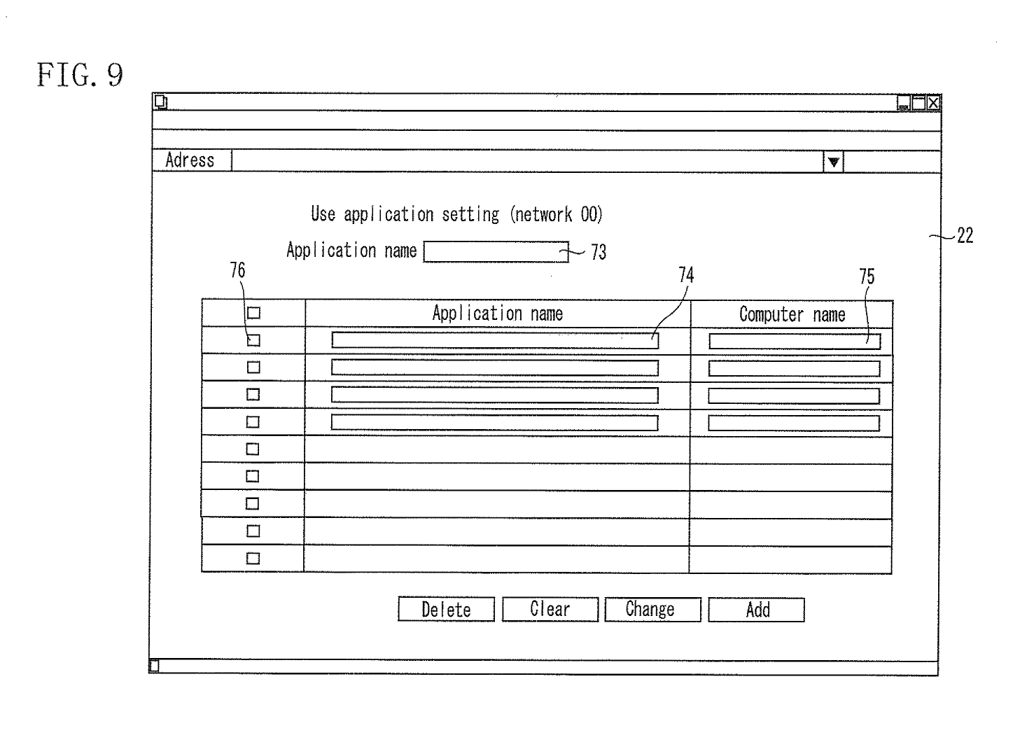

FIG. 9 is a diagram showing an example of the setting screen for addition, change and deletion of an application. In the data management computer 18, an application used in the user computers 11A to 11C, 12A to 12C, 13A to 13C, 14A to 14C forming each of the networks 16A to 16D can be added, changed or deleted for each of the networks 16A to 16D (usable application alteration means). An example of application addition is described below. The system manager, after making the data management computer 18 usable by following the authentication procedure, selects (clicks) the application setting from the report items on the report display screen (not shown) displayed on the display 22 of the computer 18, while at the same time designating any of the networks 16A to 16D. Once the application setting is selected and any of the networks 16A to 16D is designated, the application setting screen is displayed.

The system manager inputs the application name in an application name input area 73 and thereby specifies the application used in the user computers 11A to 11C, 12A to 12C, 13A to 13C, 14A to 14C. The application software corresponding to the application name is stored in the hard disk of the data management computer 18. After inputting the application name, the system manager selects (clicks) the add button on the screen. Then, as shown in FIG. 9, the application name is displayed in an application display area 74, and the user computer name forming any of the networks 16A to 16D designated is displayed in a computer name display area 75. In the case where the application to be added is used for all the user computers 11A to 11C, 12A to 12C, 13A to 13C, 14A to 14C, all the check boxes 76 are checked and the add button is selected (clicked). In the case where the application to be added is used only for a specific one of the user computers 11A to 11C, 12A to 12C, 13A to 13C, 14A to 14C, on the other hand, the check box 76 for the applicable one of the user computers 11A to 11C, 12A to 12C, 13A to 13C, 14A to 14C is checked, and the add button is selected (clicked).

After filling a check mark in any of the check boxes 76, the system manager selects (clicks) the add button. Then, the data management computer 18 encrypts the input application name, the application software and the add command. The first identification data for specifying any of the networks 16A to 16D and the second identification data for specifying any of the user computers 11A to 11C, 12A to 12C, 13A to 13C, 14A to 14C are attached to the encrypted application name, and the resultant data are output to the data relay servers 17A, 17B. The first identification data for specifying the encrypted application name, application software, add command and any of the networks 16A to 16D and the second identification data for specifying any of the user computers 11A to 11C, 12A to 12C, 13A to 13C, 14A to 14C are held in the data relay servers 17A, 17B. Incidentally, in the case where an application is added to all the user computers 11A to 11C, 12A to 12C, 13A to 13C, 14A to 14C, only the first identification data for specifying the networks 16A to 16D is attached to the encrypted application name, and the first identification data for specifying the encrypted application name, application software, add command and network is held in the data relay servers 17A, 17B.

The device monitor servers 15A to 15D which access the data relay servers 17A, 17B at predetermined intervals acquire the first identification data attached to the application name from the data relay servers 17A, 17B, and specify the networks 16A to 16D by the first identification data. In the device monitor servers 15A to 15D, upon judgment that any of the networks 16A to 16D specified by the first identification data is associated with itself, the application name with the first identification data attached thereto, the application software, the add command and the second identification data are acquired from the data relay servers 17A, 17B.

The device monitor servers 15A to 15D, after decrypting the acquired new application name, the application software and the add command, store them in a hard disk, and the second identification data of the user computers 11A to 11C, 12A to 12C, 13A to 13C, 14A to 14C to use the particular application is stored in the hard disk. In the case where an application is added to all the user computers 11A to 11C, 12A to 12C, 13A to 13C, 14A to 14C, the new application software is downloaded (installed) in all the user computers 11A to 11C, 12A to 12C, 13A to 13C, 14A to 14C from the device monitor devices 15A to 15D. In the case where the application is added only to the designated one of the user computers 11A to 11C, 12A to 12C, 13A to 13C, 14A to 14C, on the other hand, the new application software is downloaded (installed) from the device monitor servers 15A to 15D only to any one of the user computers 11A to 11C, 12A to 12C, 13A to 13C, 14A to 14C specified by the second identification data.

In this system 10, even in the case where all the user computers 11A to 11C, 12A to 12C, 13A to 13C, 14A to 14C or a specified one of the user computers 11A to 11C, 12A to 12C, 13A to 13C, 14A to 14C forming the networks 16A to 16D is required to use a new application, the particular application can be freely added through the data management computer 18, and therefore, the request to use the application in the networks 16A to 16D can be quickly met. The system manager can determine the usability of the newly usable application in the networks 16A to 16D or the user computers 11A to 11C, 12A to 12C, 13A to 13C, 14A to 14C, and therefore, the application usability can be managed for each of the networks 16A to 16D or for each of the user computers 11A to 11C, 12A to 12C, 13A to 13C, 14A to 14C, thereby making it possible to prevent the unlimited use of the application.

An example of application change is described below. The system manager, after making the data management computer 18 usable by following the authentication procedure, selects (clicks) the application setting from the report items on the report display screen displayed on the display 22 of the data management computer 18, while at the same time designating any of the networks 16A to 16D. Upon selection of the application setting and designation of the networks 16A to 16D, the application setting screen is displayed. Next, the change button on the application setting screen is selected (clicked). Once the change button is selected, the application name is displayed in an application name display area 74 on the application setting screen. Thus, the user computer name of the designated one of the networks 16A to 16D is displayed in a computer name display area 75 (see FIG. 9).

The system manager fills a check mark in the check box 76 of the application setting screen, and by thus designating the application to be changed, specifies the application to be changed from usable to unusable state. In the case where the application is changed for all the user computers 11A to 11C, 12A to 12C, 13A to 13C, 14A to 14C, a check mark is filled in all the check boxes 76. In the case where the application is changed only for a specified one of the user computers 11A to 11C, 12A to 12C, 13A to 13C, 14A to 14C, on the other hand, a check mark is filled in the check box 76 associated with the applicable one of the user computers 11A to 11C, 12A to 12C, 13A to 13C, 14A to 14C.

After putting a check mark in each check box 76, the system manager selects (clicks) the change button. Then, the data management computer 18 encrypts the application name and the change command specified by the check marks. The first identification data for specifying any of the networks 16A to 16D and the second identification data for specifying any of the user computers 11A to 11C, 12A to 12C, 13A to 13C, 14A to 14C are attached to the encrypted application name, and the resultant data are output to the data relay servers 17A, 17B. The first identification data for specifying the encrypted application name and change command and the second identification data for specifying any of the user computers 11A to 11C, 12A to 12C, 13A to 13C, 14A to 14C are held in the data relay servers 17A, 17B. Incidentally, in the case where an application is changed in all the user computers 11A to 11C, 12A to 12C, 13A to 13C, 14A to 14C, only the first identification data for specifying the networks 16A to 16D is attached to the encrypted application name, and the first identification data for specifying the encrypted application name, change command and any of the networks 16A to 16D is held in the data relay servers 17A, 17B.

The device monitor servers 15A to 15D accessing the data relay servers 17A, 17B at predetermined intervals acquire the first identification data attached to the application name from the data relay servers 17A, 17B, and specify the networks 16A to 16D by the first identification data. In the device monitor servers 15A to 15D, upon judgment that any of the networks 16A to 16D specified by the first identification data is associated with itself, the application name with the first identification data attached thereto, the change command and the second identification data are acquired from the data relay servers 17A, 17B.

The device monitor servers 15A to 15D, after decrypting the acquired application name and change command, store them in a hard disk, and the second identification data of the user computers 11A to 11C, 12A to 12C, 13A to 13C, 14A to 14C to change the particular application is stored in the hard disk. In the case where an application is changed in all the user computers 11A to 11C, 12A to 12C, 13A to 13C, 14A to 14C, a designated application is uninstalled from all the user computers 11A to 11C, 12A to 12C, 13A to 13C, 14A to 14C, and the uninstalled application is stored in the hard disk of the device monitor devices 15A to 15D as an unusable application. In the case where the application is changed only in the designated one of the user computers 11A to 11C, 12A to 12C, 13A to 13C, 14A to 14C, on the other hand, the designated application is uninstalled from any of the user computers 11A to 11C, 12A to 12C, 13A to 13C, 14A to 14C specified by the second identification data, and the uninstalled application is stored in the hard disks of the device monitor devices 15A to 15D as an unusable application.

In this system 10, even in the case where an application is required to change from usable to unusable state in all the user computers 11A to 11C, 12A to 12C, 13A to 13C, 14A to 14C or a specified one of the user computers 11A to 11C, 12A to 12C, 13A to 13C, 14A to 14C forming the networks 16A to 16D, the particular application can be freely changed through the data management computer 18, and therefore, the request not to use the application in the networks 16A to 16D can be easily and quickly met. The system manager can stop the use of the now unusable application in the networks 16A to 16D or the user computers 11A to 11C, 12A to 12C, 13A to 13C, 14A to 14C, and therefore, the action to stop the use of the application can be managed for each of the networks 16A to 16D or for each of the user computers 11A to 11C, 12A to 12C, 13A to 13C, 14A to 14C, thereby making it possible to restrict the unlimited use of the application.

An example of application deletion is described below. The system manager, after making the data management computer 18 usable by following the authentication procedure, selects (clicks) the application setting from the report items on the report display screen displayed on the display 22 of the data management computer 18, while at the same time designating the networks 16A to 16D. Upon selection of the application setting and designation of any of the networks 16A to 16D, the application setting screen is displayed. Next, the delete button on the application setting screen is selected (clicked). Once the delete button is selected, the application name is displayed in the application name display area 74 of the application setting screen. Thus, the user computer name of the designated one of the networks 16A to 16D is displayed in the computer name display area 75 (see FIG. 9).

The system manager puts a check mark in a check box 76 of the application setting screen, and by thus designating the application to be deleted, specifies the application to be deleted. In the case where the application is deleted from all the user computers 11A to 11C, 12A to 12C, 13A to 13C, 14A to 14C, a check mark is filled in all the check boxes 76. Also, in the case where the application is deleted from only a specified one of the user computers 11A to 11C, 12A to 12C, 13A to 13C, 14A to 14C, a check mark is put in the check box 76 associated with the one of the user computers 11A to 11C, 12A to 12C, 13A to 13C, 14A to 14C applicable for deletion. After putting a check mark in the check box 76, the system manager selects (clicks) the delete button. Then, the data management computer 18 encrypts the application name specified by the check mark and the delete command. The first identification data for specifying any of the networks 16A to 16D and the second identification data for specifying any of the user computers 11A to 11C, 12A to 12C, 13A to 13C, 14A to 14C are attached to the encrypted application name, and the resultant data are output to the data relay servers 17A, 17B. The first identification data for specifying the encrypted application name, the delete command and any of the networks 16A to 16D and the second identification data for specifying any of the user computers 11A to 11C, 12A to 12C, 13A to 13C, 14A to 14C are held in the data relay servers 17A, 17B. Incidentally, in the case where an application is deleted from all the user computers 11A to 11C, 12A to 12C, 13A to 13C, 14A to 14C, only the first identification data for specifying the networks 16A to 16D is attached to the encrypted application name, and the first identification data for specifying the encrypted application name, the delete command and any of the networks 16A to 16D is held in the data relay servers 17A, 17B.

The device monitor servers 15A to 15D which access the data relay servers 17A, 17B at predetermined intervals acquire the first identification data attached to the application name from the data relay servers 17A, 17B, and specify the networks 16A to 16D by the first identification data. In any of the device monitor servers 15A to 15D, upon judgment that any of the networks 16A to 16D specified by the first identification data is associated with itself, the application name with the first identification data attached thereto, the delete command and the second identification data are acquired from the data relay servers 17A, 17B.

The device monitor servers 15A to 15D, after decrypting the acquired application name and the delete command, store them in a hard disk, and the second identification data of the user computers 11A to 11C, 12A to 12C, 13A to 13C, 14A to 14C from which an application is to be deleted is stored in the hard disk. In the case where an application is deleted from all the user computers 11A to 11C, 12A to 12C, 13A to 13C, 14A to 14C, the designated application is uninstalled from all the user computers 11A to 11C, 12A to 12C, 13A to 13C, 14A to 14C. In the case where the application is deleted only from the designated one of the user computers 11A to 11C, 12A to 12C, 13A to 13C, 14A to 14C, on the other hand, the application is uninstalled only from the designated one of the user computers 11A to 11C, 12A to 12C, 13A to 13C, 14A to 14C specified by the second identification data.

In this system 10, even in the case where an application is required to be deleted from all the user computers 11A to 11C, 12A to 12C, 13A to 13C, 14A to 14C forming the networks 16A to 16D or a specified one of the user computers 11A to 11C, 12A to 12C, 13A to 13C, 14A to 14C, the particular application can be freely deleted through the data management computer 18, and therefore, the request to delete an application in the networks 16A to 16D can be easily and quickly met. The system manager can delete any application to be deleted from the networks 16A to 16D or the user computers 11A to 11C, 12A to 12C, 13A to 13C, 14A to 14C, and therefore, the application deletion can be managed for each of the networks 16A to 16D or for each of the user computers 11A to 11C, 12A to 12C, 13A to 13C, 14A to 14C.

(Addition, Change and Deletion of Unusable Application)

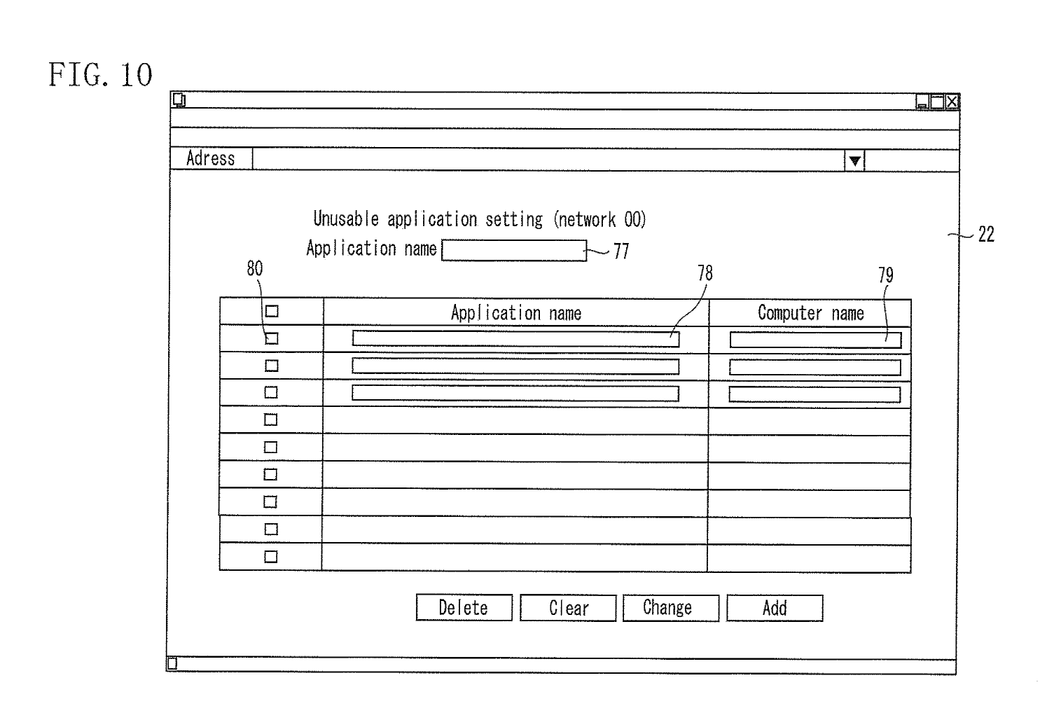

FIG. 10 is a diagram showing an example of the setting screen to add, change or delete an unusable application. The data management computer 18 can add, change or delete an unusable application (unusable application alteration means). An example of addition of an unusable application is described below. The system manager, after making the data management computer 18 usable by following the authentication procedure, selects (clicks) the unusable application setting from the report items on the report display screen (not shown) displayed on the display 22 of the computer 18, while at the same time designating any of the networks 16A to 16D. Once the unusable application setting is selected and any of the networks 16A to 16B designated, the unusable application setting screen is displayed.

The system manager inputs the name of an unusable application in an application name input area 77 and thus specifies the unusable application. The unusable application software corresponding to the unusable application name is stored in the hard disk of the data management computer 18. After inputting the name of the unusable application, the system manager selects (clicks) the add button on the screen. As shown in FIG. 10, the name of the unusable application is displayed in an application display area 78, and the user computer name forming the designated one of the networks 16A to 16D is displayed in a computer name display area 79. In the case where the unusable application is involved for all the user computers 11A to 11C, 12A to 12C, 13A to 13C, 14A to 14C, a check mark is filled in all the check boxes 80 and the add button is selected (clicked). In the case where the unusable application is involved only for a specified one of the user computers 11A to 11C, 12A to 12C, 13A to 13C, 14A to 14C, on the other hand, a check mark is put in the check box 80 of the applicable one of the user computers 11A to 11C, 12A to 12C, 13A to 13C, 14A to 14C and the add button is selected (clicked).

After putting a check mark in any of the check boxes 80, the system manager selects (clicks) the add button. Then, the data management computer 18 encrypts the input unusable application name, the unusable application software and the add command. The first identification data for specifying any of the networks 16A to 16D and the second identification data for specifying any of the user computers 11A to 11C, 12A to 12C, 13A to 13C, 14A to 14C are attached to the encrypted unusable application name, and the resultant data are output to the data relay servers 17A, 17B. The first identification data for specifying the encrypted unusable application name, unusable application software, add command and any of the networks 16A to 16D and the second identification data for specifying any of the user computers 11A to 11C, 12A to 12C, 13A to 13C, 14A to 14C are held in the data relay servers 17A, 17B. Incidentally, in the case where an unusable application is involved for all the user computers 11A to 11C, 12A to 12C, 13A to 13C, 14A to 14C, only the first identification data for specifying the networks 16A to 16D is attached to the encrypted unusable application name, and the first identification data for specifying the encrypted unusable application name, unusable application software, the add command and the networks 16A to 16D is held in the data relay servers 17A, 17B.

The device monitor servers 15A to 15D which access the data relay servers 17A, 17B at predetermined intervals acquire the first identification data attached to the unusable application name from the data relay servers 17A, 17B, and specify any of the networks 16A to 16D by the first identification data. In the device monitor servers 15A to 15D, upon judgment that any of the networks 16A to 16D specified by the first identification data is associated with itself, the unusable application name with the first identification data attached thereto, the unusable application software, the add command and the second identification data are acquired from the data relay servers 17A, 17B.

The device monitor servers 15A to 15D, after decrypting the acquired the unusable application name, the unusable application software and the add command, store them in a hard disk, and the second identification data of the user computers 11A to 11C, 12A to 12C, 13A to 13C, 14A to 14C for which the particular unusable application is to be added is stored in the hard disk. In the case where an unusable application is applicable to all the user computers 11A to 11C, 12A to 12C, 13A to 13C, 14A to 14C, the second identification data for specifying all the user computers 11A to 11C, 12A to 12C, 13A to 13C, 14A to 14C and the unusable application software are stored in the hard disk of the device monitor devices 15A to 15D. In the case where the unusable application is applied only to the designated one of the user computers 11A to 11C, 12A to 12C, 13A to 13C, 14A to 14C, on the other hand, the second identification data and the unusable application software for only the user computers 11A to 11C, 12A to 12C, 13A to 13C, 14A to 14C specified by the second identification data are stored in the hard disk of the device monitor devices 15A to 15D.

In this system 10, an application not to used for the time being is installed (added) in the device monitor devices 15A to 15D as an unusable application, and whenever required, the unusable application can be changed to a usable one. Thus, the use or disuse of an application can be freely selected as required.

An example of an unusable application change is described below. The system manager, after making the data management computer 18 operable by following the authentication procedure, selects (clicks) the unusable application setting from the report items on the report display screen displayed on the display 22 of the data management computer 18, while at the same time designating any of the networks 16A to 16D. The unusable application setting screen is displayed. Next, the change button on the unusable application setting screen is selected (clicked). Once the change button is selected, the unusable application name is displayed in an application name display area 78 on the unusable application setting screen. Thus, the user computer name of the designated one of the networks 16A to 16D is displayed in a computer name display area 79 (see FIG. 9).

The system manager fills a check mark in the check box 80 of the unusable application setting screen, and by thus designating the unusable application to be changed, specifies the unusable application to be changed to usable state. In the case where the unusable application is changed for all the user computers 11A to 11C, 12A to 12C, 13A to 13C, 14A to 14C, all the check boxes 80 are filled with a check mark. In the case where the unusable application is changed only for a specified one of the user computers 11A to 11C, 12A to 12C, 13A to 13C, 14A to 14C, on the other hand, the check box 80 associated with the applicable one of the user computers 11A to 11C, 12A to 12C, 13A to 13C, 14A to 14C is filled with a check mark.

After putting a check mark in the check boxes 80, the system manager selects (clicks) the change button. Then, the data management computer 18 encrypts the input unusable application name specified by the check mark and the add command. The first identification data for specifying any of the networks 16A to 16D and the second identification data for specifying any of the user computers 11A to 11C, 12A to 12C, 13A to 13C, 14A to 14C are attached to the encrypted unusable application name, and the resultant data are output to the data relay servers 17A, 17B. The first identification data for specifying the encrypted unusable application name, the change command and any of the networks 16A to 16D and the second identification data for specifying any of the user computers 11A to 11C, 12A to 12C, 13A to 13C, 14A to 14C are held in the data relay servers 17A, 17B. Incidentally, in the case where an unusable application is changed for all the user computers 11A to 11C, 12A to 12C, 13A to 13C, 14A to 14C, only the first identification data for specifying the networks 16A to 16D is attached to the encrypted unusable application name, and the first identification data for specifying the encrypted unusable application name, the change command and any of the networks 16A to 16D is held in the data relay servers 17A, 17B.

The device monitor servers 15A to 15D which access the data relay servers 17A, 17B at predetermined intervals acquire the first identification data attached to the unusable application name from the data relay servers 17A, 17B, and specify the networks 16A to 16D by the first identification data. In the device monitor servers 15A to 15D, upon judgment that any of the networks 16A to 16D specified by the first identification data is associated with itself, the unusable application name with the first identification data attached thereto, the change command and the second identification data are acquired from the data relay servers 17A, 17B.

The device monitor servers 15A to 15D, after decrypting the acquired unusable application name and the change command, store them in a hard disk, and the second identification data of the user computers 11A to 11C, 12A to 12C, 13A to 13C, 14A to 14C with the unusable application to be changed is stored in the hard disk. In the case where an unusable application is changed for all the user computers 11A to 11C, 12A to 12C, 13A to 13C, 14A to 14C, the designated unusable application is changed from unusable to usable state for all the user computers 11A to 11C, 12A to 12C, 13A to 13C, 14A to 14C. In the case where the unusable application is changed only for a designated one of the user computers 11A to 11C, 12A to 12C, 13A to 13C, 14A to 14C, on the other hand, the application designated only in any one of the user computers 11A to 11C, 12A to 12C, 13A to 13C, 14A to 14C specified by the second identification data is changed from unusable to usable state. The user computers 11A to 11C, 12A to 12C, 13A to 13C, 14A to 14C can download (install) the now usable application from the device monitor servers 15A to 15D.

In this system 10, even in the case where all the user computers 11A to 11C, 12A to 12C, 13A to 13C, 14A to 14C or a specified one of the user computers 11A to 11C, 12A to 12C, 13A to 13C, 14A to 14C forming the networks 16A to 16D is required to use an unusable application, the particular unusable application can be freely changed to a usable application through the data management computer 18, and therefore, the request to use an unusable application can be easily and quickly met. In this system 10, the change from an unusable application to a usable application can be managed for each of the networks 16A to 16D or for each of the user computers 11A to 11C, 12A to 12C, 13A to 13C, 14A to 14C.

An example of deletion of an unusable application is described below. The system manager, after making the data management computer 18 usable by following the authentication procedure, selects (clicks) the unusable application setting from the report items on the report display screen displayed on the display 22 of the data management computer 18, while at the same time designating any of the networks 16A to 16D. Upon selection of the unusable application setting and designation of the networks 16A to 16D, the unusable application setting screen is displayed. Next, the delete button on the unusable application setting screen is selected (clicked). Once the delete button is selected, the unusable application name is displayed in an application name display area 78 of the unusable application setting screen. Thus, the user computer name of the designated one of the networks 16A to 16D is displayed in a computer name display area 79 (see FIG. 9).

The system manager fills a check mark in the appropriate check box 80 and specifies the unusable application to be deleted. The unusable application software corresponding to the unusable application name is stored in the hard disk of the device monitor servers 15A to 15D. After filling a check mark in the check box 80, the system manager selects (clicks) the delete button on the screen. The data management computer 18 encrypts the unusable application name specified by the check mark and the delete command. The first identification data for specifying any of the networks 16A to 16D is attached to the encrypted unusable application name, and the resultant data are output to the data relay servers 17A, 17B. The first identification data for specifying the encrypted unusable application name and any of the networks 16A to 16D are held in the data relay servers 17A, 17B.

The device monitor servers 15A to 15D accessing the data relay servers 17A, 17B at predetermined intervals acquire the first identification data attached to the unusable application name from the data relay servers 17A, 17B, and specify the networks 16A to 16D by the first identification data. In the device monitor servers 15A to 15D, upon judgment that any of the networks 16A to 16D specified by the first identification data is associated with itself, the unusable application name with the first identification data attached thereto and the delete command are acquired from the data relay servers 17A, 17B. The device monitor servers 15A to 15D, after decrypting the acquired unusable application name and the delete command, store them in the hard disk. In the device monitor servers 15A to 15D, the unusable application stored in the hard disk is uninstalled from the particular hard disk. In this system 10, the deletion of an unusable application can be managed for each of the networks 16A to 16D or for each of the user computers 11A to 11C, 12A to 12C, 13A to 13C, 14A to 14C.

(Information Transmission Interval)

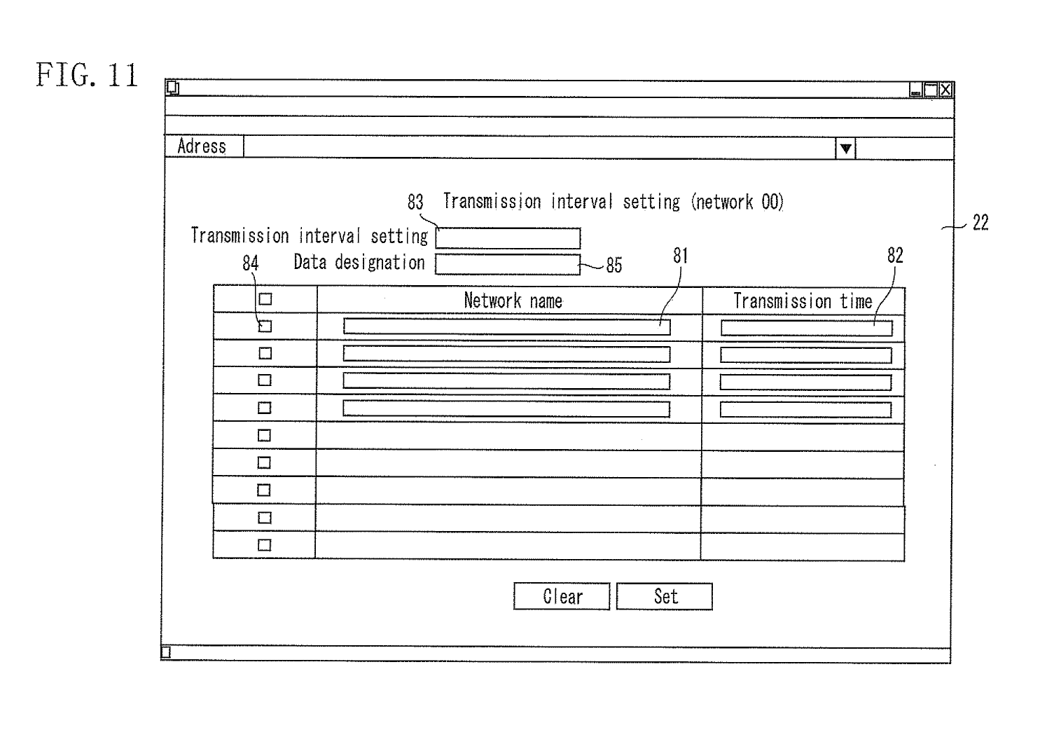

FIG. 11 is a diagram showing an example of the setting screen to set the transmission interval (output interval) of various information. The data management computer 18 can set and change, for each of the networks 16A to 16D, the interval at which the device monitor servers 15A to 15D transmit various information to the data relay servers 17A, 17B (transmission interval setting/changing means). Also, transmission interval (output interval) of the various information output from the user computers 11A to 11C, 12A to 12C, 13A to 13C, 14A to 14C to the device monitor servers 15A to 15D can be set and changed for each of the networks 16A to 16D (transmission interval setting/changing means). An example of setting and changing the transmission interval is described below. The system manager, after making the data management computer 18 usable by following the authentication procedure, selects (clicks) the transmission interval setting from the report items on the report display screen (not shown) displayed on the display 22 of the computer 18, while at the same time designating any of the networks 16A to 16D. Once the transmission interval setting is selected and any of the networks 16A to 16B designated, the transmission interval setting screen is displayed. On the transmission interval setting screen, the network name is displayed in a network name display area 81, and the transmission interval that has been set is displayed in a transmission interval display area 82.

The system manager inputs a new transmission interval in a transmission interval setting input area 83 thereby to specify the transmission interval. After inputting the transmission interval, assume that the particular transmission interval is used in all the networks 16A to 16D. All the check boxes 84 are filled with a check mark and the set button is selected (clicked). In the case where the particular transmission interval is used only for a specified one of the networks 16A to 16D, on the other hand, the check box 84 for the applicable one of the networks 16A to 16D is filled with a check mark. Also, in the case where the transmission interval is used only for specified one of the various information, the name of the particular information is input in a data designation input area 85. The information names include the network configuration, the use history information, the access information, the print history information, the file access information, the external access history information, the undesignated time use history information, the bring-out action information, the print action information, the E-mail transmission information, the Web site access information and the external network access information.

After putting a check mark in the check box 84, the system manager selects (clicks) the set button. Then, the data management computer 18 encrypts the input transmission interval and the set command. The first identification data for specifying any of the networks 16A to 16D is attached to the encrypted transmission interval, and the resultant data are output to the data relay servers 17A, 17B. Also, after putting a check mark in the check box 84 and the information name in a data designation input area 85, the system manager selects (clicks) the set button. Then, the data management computer 18 encrypts the input transmission interval, the set command and the information name. The first identification data for specifying any of the networks 16A to 16D is attached to the encrypted transmission interval, and the resultant data are output to the data relay servers 17A, 17B. The first identification data for specifying the encrypted transmission interval, the set command, the information name and the networks 16A to 16D is held in the data relay servers 17A, 17B.

The device monitor servers 15A to 15D accessing the data relay servers 17A, 17B at predetermined intervals acquire the first identification data attached to the transmission interval from the data relay servers 17A, 17B, and specify any of the networks 16A to 16D by the first identification data. In the device monitor servers 15A to 15D, upon judgment that any of the networks 16A to 16D specified by the first identification data is associated with itself, the transmission interval with the first identification data attached thereto, the set command and the information name are acquired from the data relay servers 17A, 17B. The device monitor servers 15A to 15D, after decrypting the acquired transmission interval, set command and information name, store them in the hard disk, while at the same time outputting the transmission interval and the information name to the user computers 11A to 11C, 12A to 12C, 13A to 13C, 14A to 14C. The device monitor servers 15A to 15D transmit the various information to the data relay servers 17A, 17B in accordance with the transmission interval acquired from the data relay servers 17A, 17B. The user computers 11A to 11C, 12A to 12C, 13A to 13C, 14A to 14C transmit the various information to the servers 15A to 15D at the transmission interval output from the device monitor servers 15A to 15D. Also, only the designated information is transmitted to the device monitor servers 15A to 15D at the particular transmission interval. In this system 10, the data management computer 18 can freely set and change the transmission interval of the various information in the device monitor servers 15A to 15D and the user computers 11A to 11C, 12A to 12C, 13A to 13C, 14A to 14C. Therefore, the proper transmission interval can be freely set for each of the networks 16A to 16D, while at the same time making it possible to set the proper transmission interval in accordance with the various information.

(Installation Information)

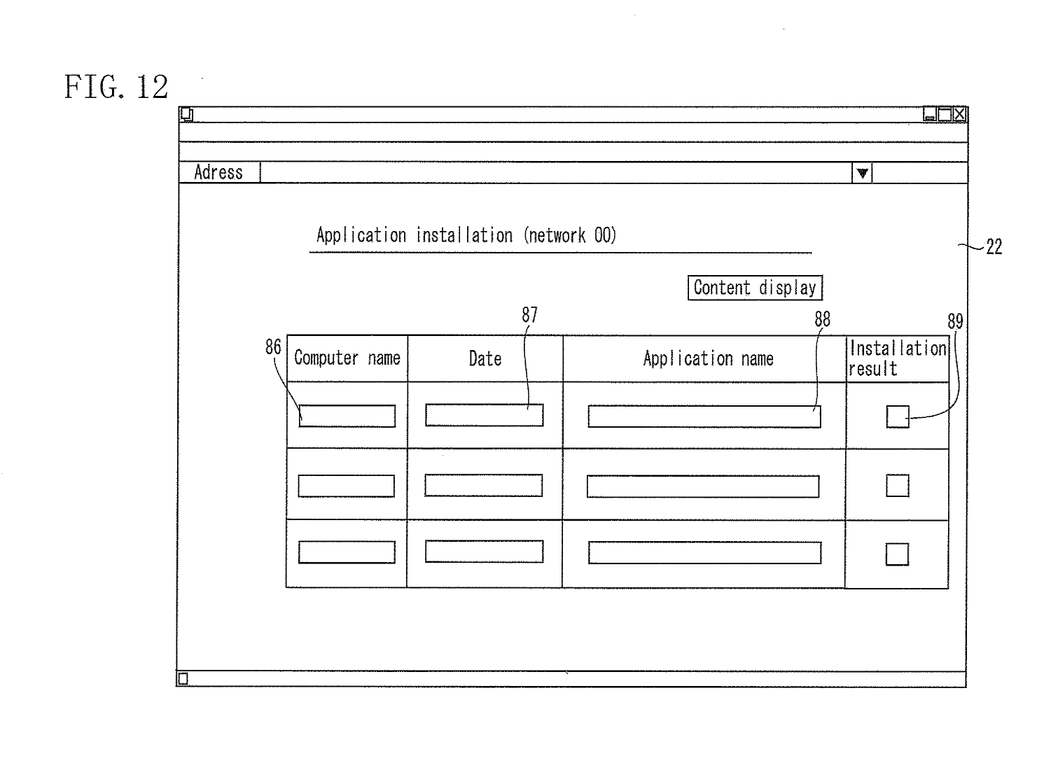

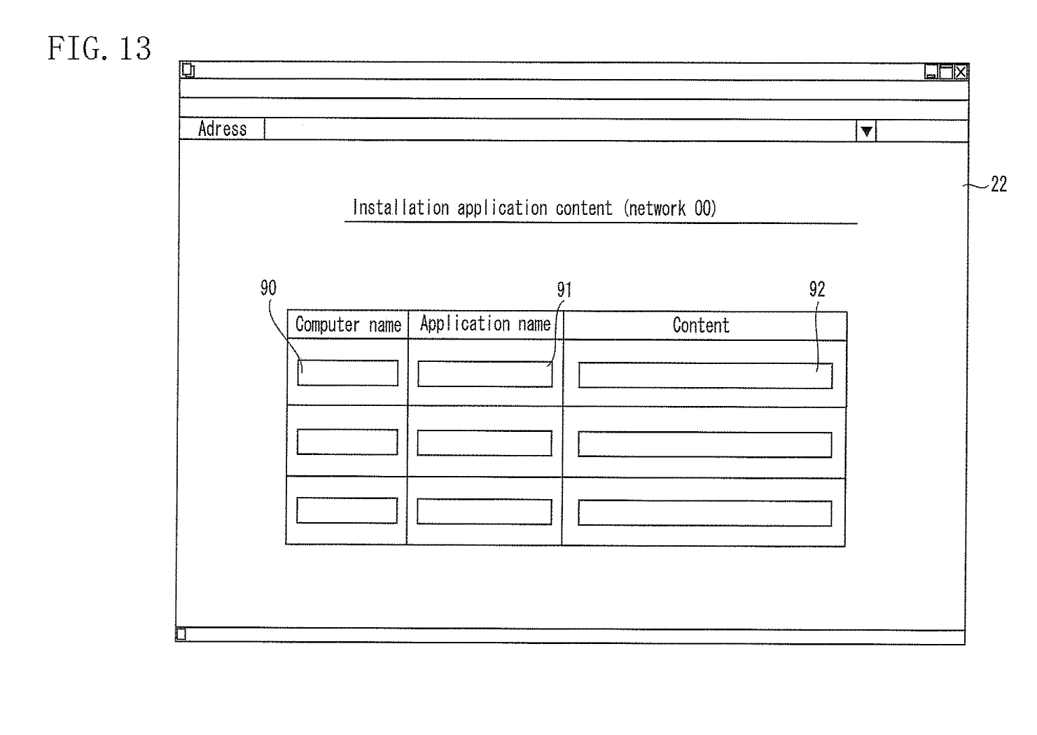

FIG. 12 is a diagram showing an example of the manner in which an application is installed, and FIG. 13 a diagram showing the specifics of an application installed. In FIGS. 12 and 13, specific contents of each item are not shown. In the data management computer 18, the installation information of an usable application in the user computers 11A to 11C, 12A to 12C, 13A to 13C, 14A to 14C acquired from the data relay servers 17A, 17B is displayed on the display 22 by being classified for each of the networks 16A to 16D, while at the same time outputting them from the printer (installation information first output means). Also, the installation information of the usable application is displayed on the display 22 by being classified for each of the user computers 11A to 11C, 12A to 12C, 13A to 13C, 14A to 14C, while at the same time being output from the printer (installation information second output means). The data management computer 18 can output by classifying the installation information according to a predetermined period such as day, week or month.

The system manager, after making the data management computer 18 usable by following the authentication procedure, selects (clicks) the installation information from the report items on the report display screen (not shown) displayed on the display 22 of the computer 18 thereby to designate any of the networks 16A to 16D. Once the installation information is selected and the networks 16A to 16D designated, the data management computer 18 specifies the first and second identification data corresponding to the designated ones of the networks 16A to 16D, and extracts the installation information corresponding to the first identification data and the installation information corresponding to the second identification information from the data base. Next, as shown in FIG. 12, the data management computer 18 displays, on the display 22, the information on the installation of a usable application in the user computers 11A to 11C, 12A to 12C, 13A to 13C, 14A to 14C in the designated one of the networks 16A to 16D (installation information first output means). FIG. 12 shows the installation information in which the computer name (the name of the computer installed with the application) in a computer name display area 86, the date (installation day/hour) in a date display area 87, the application name (the name of the application installed) in an application name display area 88 and the installation completion check (not shown) in an installation result check box 89. Incidentally, the check box 89 is left vacant for an uninstallable application.

On the screen shown in FIG. 12, the application name is reversed in video and the content display is selected (clicked). As shown in FIG. 13, the computer name is displayed in a computer name display area 90, the application name in an application name display area 91, and the content of the installed application in an application content display area 92. The system manager can output the installation information of FIGS. 12 and 13 from the printer. The contents of the installed application include an outline of the applications such as the text generation software, the spreadsheet program, the translation software, the data base construction software, the communication software and the security software. The applications, when installed in the data management computer 18, are input in the management computer 18 at the same time and stored in the hard disk of the management computer 18.

In the system 10, the data management computer 18 manages the installation information of a usable application in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp the manner in which the usable application is installed in the user computers 11A to 11C, 12A to 12C, 13A to 13C, 14A to 14C of each of the networks 16A to 16D through the data management computer 18 on the one hand, and can monitor the installation of the usable application in the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand.

(Uninstallation Information)

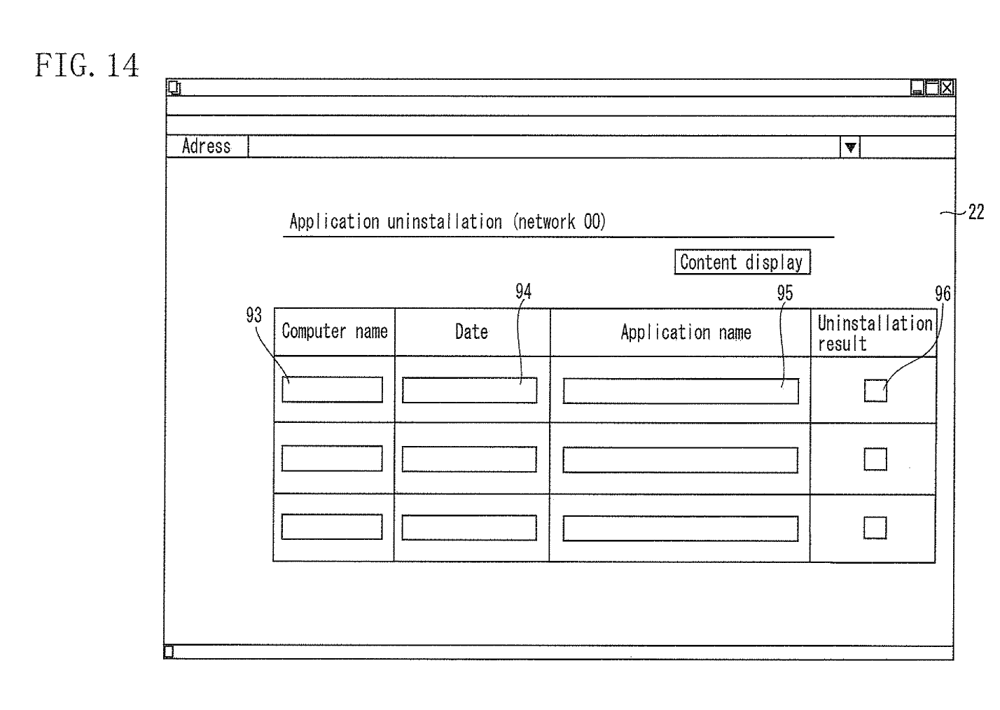

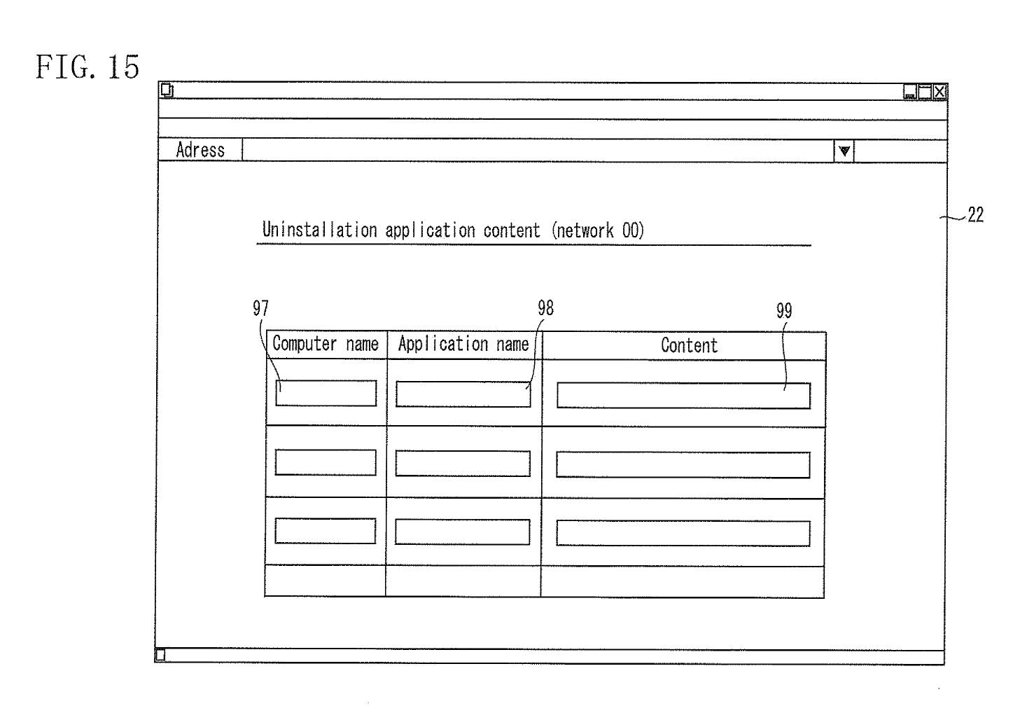

FIG. 14 is a diagram showing an example of the manner in which an application is uninstalled, and FIG. 15 a diagram showing the contents of an application uninstalled. In FIGS. 14 and 15, specific contents of each item are not shown. In the data management computer 18, the uninstallation information of a usable application from the user computers 11A to 11C, 12A to 12C, 13A to 13C, 14A to 14C acquired from the data relay servers 17A, 17B is displayed on the display 22 by being classified for each of the networks 16A to 16D, while at the same time outputting them from the printer (uninstallation information first output means). Also, the uninstallation information of the usable application is displayed on the display 22 by being classified for each of the user computers 11A to 11C, 12A to 12C, 13A to 13C, 14A to 14C, while at the same time being output from the printer (uninstallation information second output means). The data management computer 18 can output by classifying the uninstallation information according to a predetermined period such as day, week or month.

The system manager, after making the data management computer 18 usable by following the authentication procedure, selects (clicks) the uninstallation information from the report items on the report display screen (not shown) displayed on the display 22 of the computer 18 thereby to designate any of the networks 16A to 16D. Once the uninstallation information is selected and the networks 16A to 16D designated, the data management computer 18 specifies the first and second identification data corresponding to the designated ones of the networks 16A to 16D, and extracts the uninstallation information corresponding to the first identification data and the uninstallation information corresponding to the second identification data from the data base. Next, as shown in FIG. 14, the data management computer 18 displays, on the display 22, the information on the uninstallation of a usable application from the user computers 11A to 11C, 12A to 12C, 13A to 13C, 14A to 14C in the designated one of the networks 16A to 16D (uninstallation information first output means). FIG. 14 shows that, as uninstallation information, the computer name (the name of the computer from which the application is uninstalled) in a computer name display area 93, the date (uninstallation day/hour) in a date display area 94, the application name (the name of the application uninstalled) in an application name display area 95 and the uninstallation completion check mark (not shown) in an uninstallation result check box 96. Incidentally, the check box 96 is left vacant in the case where uninstallation is impossible.

On the screen shown in FIG. 14, the application name is reversed in video and the content display is selected (clicked). As shown in FIG. 15, the computer name is displayed in a computer name display area 97, the application name in an application name display area 98, and the content of the uninstalled application in an application content display area 99. The system manager can output the uninstallation information of FIGS. 14 and 15 from the printer. The contents of the uninstalled application include an outline of applications such as the text generation software, the spreadsheet program, the translation software, the data base construction software, the communication software and the security software. The applications, when installed in the data management computer 18, are input to the management computer 18 and stored in the hard disk of the management computer 18 at the same time and stored in the hard disk of the management computer 18.

In this system 10, the data management computer 18 manages the uninstallation information of a usable application in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the usable application is uninstalled from the user computers 11A to 11C, 12A to 12C, 13A to 13C, 14A to 14C in each of the networks 16A to 16D on the one hand, and can monitor the uninstallation of the unusable application in the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. This system 10 can restrict the unlimited uninstallation of applications in each of the networks 16A to 16D.

(Print History Information)

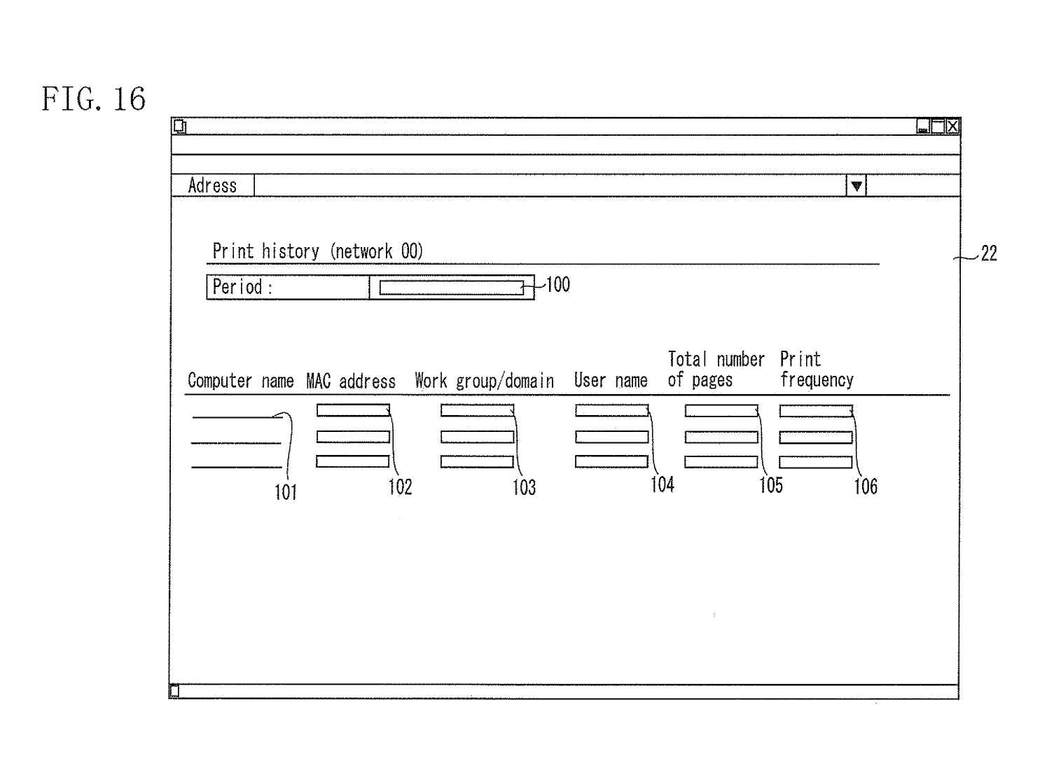

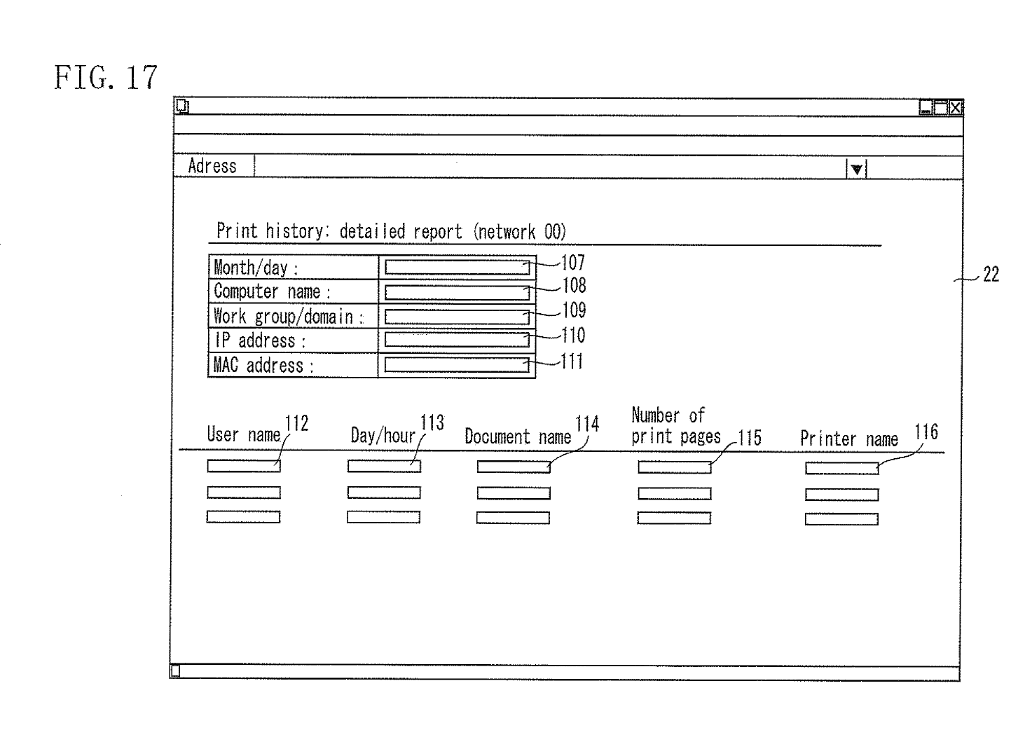

FIGS. 16 and 17 are diagrams showing an example of the print history information, i.e. the weekly print history of the user computers 11A to 11C, 12A to 12C, 13A to 13C, 14A to 14C. Incidentally, in FIGS. 16 and 17, specific contents of each item are not shown. In the data management computer 18, the print history information of the user computers 11A to 11C, 12A to 12C, 13A to 13C, 14A to 14C acquired from the data relay servers 17A, 17B is displayed on the display 22 by being classified for each of the networks 16A to 16D, while at the same time being output from the printer (print history information first output means). Also, the print history information is displayed on the display 22 by being classified for each of the user computers 11A to 11C, 12A to 12C, 13A to 13C, 14A to 14C, while at the same time being output from the printer (print history information second output means). The data management computer 18 can output by classifying the print history information according to a predetermined period such as day, week or month.

The system manager, after making the data management computer 18 usable by following the authentication procedure, selects (clicks) the print history information from the report items on the report display screen (not shown) displayed on the display 22 of the computer 18 thereby to designate any of the networks 16A to 16D. Once the print history information is selected and any of the networks 16A to 16D designated, the data management computer 18 specifies the first and second identification data corresponding to the designated one of the networks 16A to 16D, and extracts the print history information corresponding to the first identification data and the print history information corresponding to the second identification information from the data base. Next, as shown in FIG. 16, the data management computer 18 displays, on the display 22, the information on the print history of the user computers 11A to 11C, 12A to 12C, 13A to 13C, 14A to 14C for the designated one of the networks 16A to 16D (print history information first output means). In FIG. 16, as print history information, the period is displayed in a period display area 100, the computer name (the name of the computer in which the print operation is performed) in a computer name display area 101, the MAC address in a MAC address display area 102, the work group/domain in a work group/domain display area 103, the user name (the name of the user of the computer that has performed the print operation) in a user name display area 104, the total number of pages printed in a total print page number area 105, and the number of times printed in a print number display area 106.

On the screen shown in FIG. 16, the computer name displayed in the underlined part is selected (clicked). As shown in FIG. 17, the data management computer 18 displays, on the display 22, the detailed print history information of the selected one of the user computers 11A to 11C, 12A to 12C, 13A to 13C, 14A to 14C (print history information second output means). FIG. 17 shows the detailed print history information, in which the month/day is displayed in a month/day display area 107, the computer name in a computer name display area 108, the work group/domain in a work group/domain display area 109, the IP address in an IP address display area 110, and the MAC address in a MAC address display area 111. Further, the user name is displayed a user name display area 112, the print day/hour in a print day/hour display area 113, the document name in a document name display area 114, the total number of pages printed in a print page number area 115, and the name of the printer in a printer name display area 116. The system manager can output the print history information shown in FIGS. 16 and 17 from the printer.

In the system 10, the data management computer 18 manages the print history information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the print operation is performed in the user computers 11A to 11C, 12A to 12C, 13A to 13C, 14A to 14C of each of the networks 16A to 16D on the one hand, and can monitor the print operation in each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited print action in the user computers 11A to 11C, 12A to 12C, 13A to 13C, 14A to 14C can be restricted.

(File Access History Information)

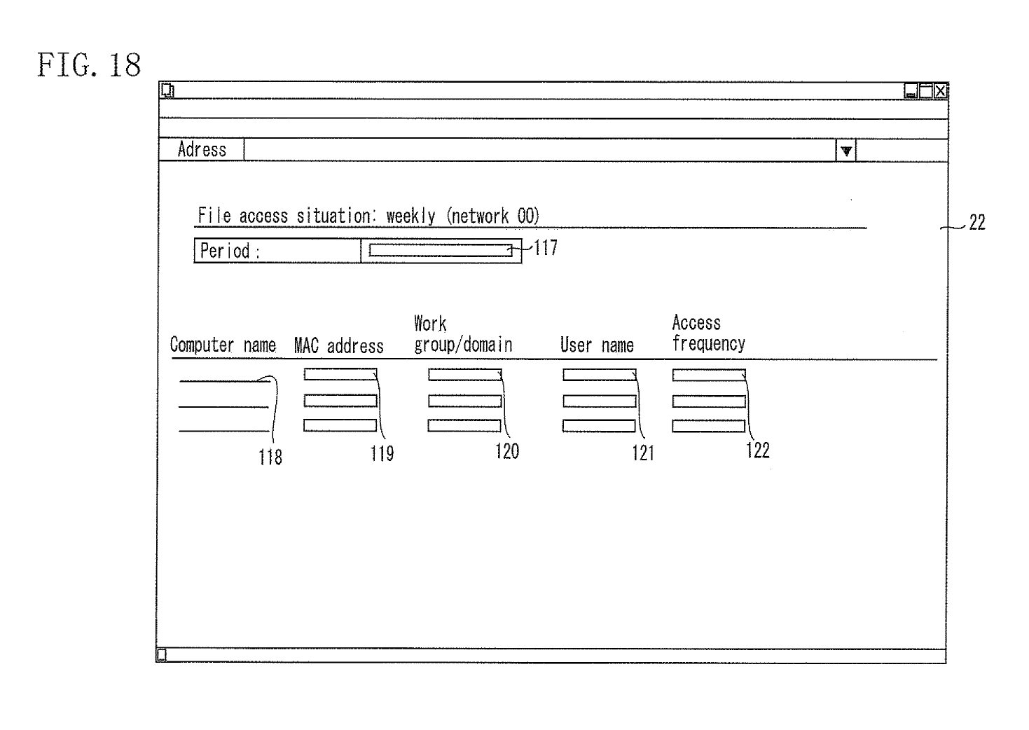

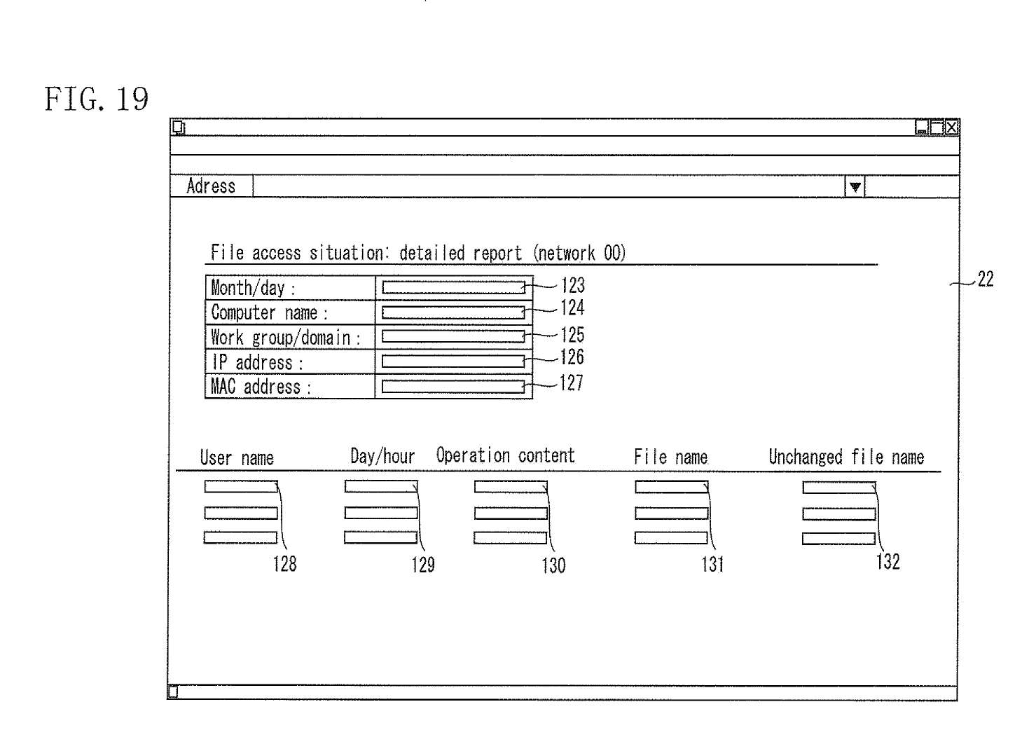

FIGS. 18 and 19 are diagrams showing an example of the file access history information, i.e. the weekly file access history of the user computers 11A to 11C, 12A to 12C, 13A to 13C, 14A to 14C. Incidentally, in FIGS. 18 and 19, specific contents of each item are not shown. In the data management computer 18, the file access history information of the user computers 11A to 11C, 12A to 12C, 13A to 13C, 14A to 14C acquired from the data relay servers 17A, 17B is displayed on the display 22 by being classified for each of the networks 16 to 16D, while at the same time being output from the printer (file access history information first output means). Also, the file access history information is displayed on the display 22 by being classified for each of the user computers 11A to 11C, 12A to 12C, 13A to 13C, 14A to 14C, while at the same time being output from the printer (file access history information second output means). The data management computer 18 can output by classifying the file access history information according to a predetermined period such as day, week or month.

The system manager, after making the data management computer 18 usable by following the authentication procedure, selects (clicks) the file access history information from the report items on the report display screen (not shown) displayed on the display 22 of the computer 18 thereby to designate any of the networks 16A to 16D. Once the file access history information is selected and any of the networks 16A to 16D designated, the data management computer 18 specifies the first and second identification data corresponding to the designated one of the networks 16A to 16D, and extracts the file access history information corresponding to the first identification data and the file access history information corresponding to the second identification data from the data base. Next, as shown in FIG. 18, the data management computer 18 displays, on the display 22, the information on the file access history of the user computers 11A to 11C, 12A to 12C, 13A to 13C, 14A to 14C in the designated one of the networks 16A to 16D (file access history information first output means). FIG. 18 shows that, as file access history information, the designated period is displayed in a period display area 117, the computer name (the name of the computer that has accessed the file) in a computer name display area 118, the MAC address in a MAC address display area 119, the work group/domain in a work group/domain display area 120, the user name (the name of the user who has accessed the file) in a user name display area 121, and the number of times accessed in an access number display area 122.

On the screen shown in FIG. 18, the computer name displayed in the underlined part is selected (clicked). As shown in FIG. 19, the data management computer 18 displays, on the display 22, the detailed file access history information of the selected one of the user computers 11A to 11C, 12A to 12C, 13A to 13C, 14A to 14C (file access history information second output means). FIG. 19 shows that, as detailed file access history information, the month/day is displayed in a month/day display area 123, the computer name in a computer name display area 124, the work group/domain in a work group/domain display area 125, the IP address in an IP address display area 126, and the MAC address in a MAC address display area 127. Further, the user name is displayed in a user name display area 128, the file access day/hour in a file access day/hour display area 129, the operation content (copy, cutoff, write, delete, folder creation, name change, etc.) in an operation content display area 130, the file name in a file name display area 131 and the file name before change in an unchanged file name display area 132. The system manager can output the file access history information shown in FIGS. 18 and 19 from the printer.

In the system 10, the data management computer 18 manages the file access history information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the file access operation is performed in the user computers 11A to 11C, 12A to 12C, 13A to 13C, 14A to 14C of each of the networks 16A to 16D on the one hand, and can monitor the file access operation in each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited file access action in the user computers 11A to 11C, 12A to 12C, 13A to 13C, 14A to 14C can be restricted.

(External Use History Information)

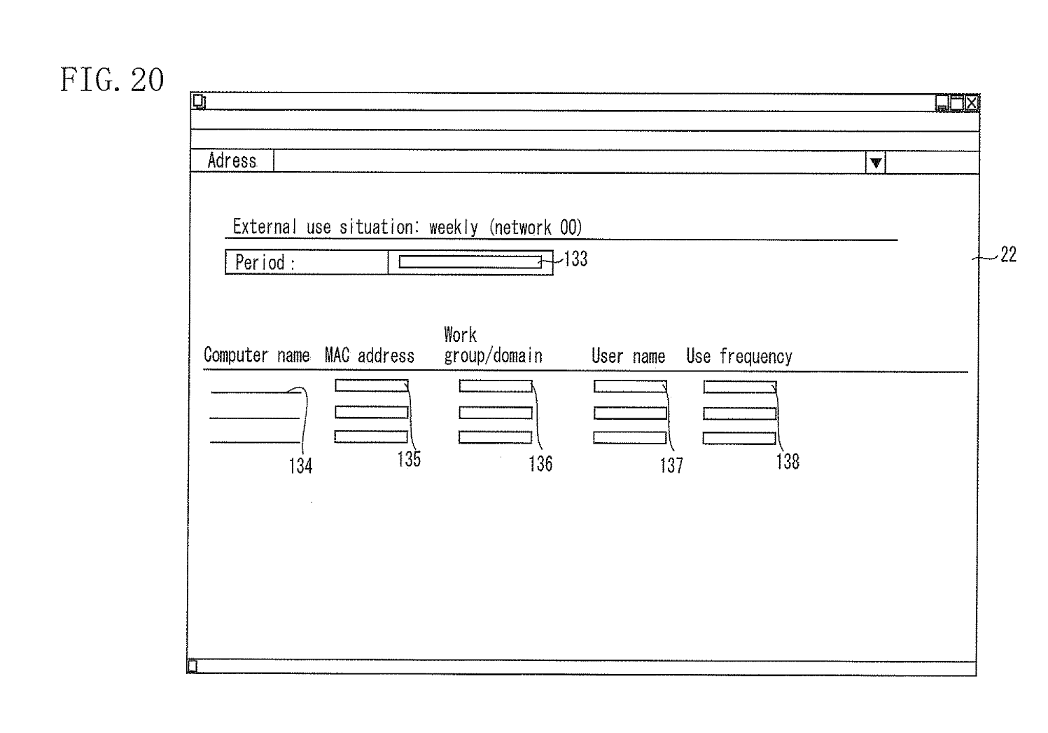

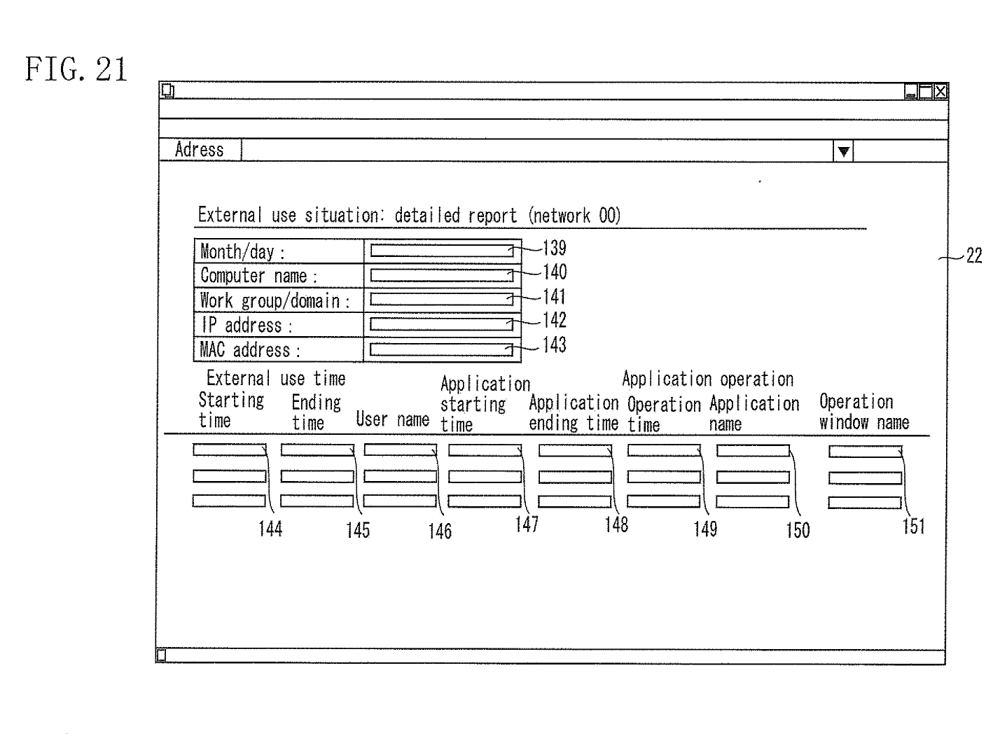

FIGS. 20 and 21 are diagrams showing an example of the external use history information, i.e. the weekly external use history of the user computers 11A to 11C, 12A to 12C, 13A to 13C, 14A to 14C. Incidentally, in FIGS. 20 and 21, specific contents of each item are not shown. In the data management computer 18, the external use history information of the user computers 11A to 11C, 12A to 12C, 13A to 13C, 14A to 14C acquired from the data relay servers 17A, 17B is displayed on the display 22 by being classified for each of the networks 16 to 16D, while at the same time being output from the printer (external use history information first output means). Also, the external use history information is displayed on the display 22 by being classified for each of the user computers 11A to 11C, 12A to 12C, 13A to 13C, 14A to 14C, while at the same time being output from the printer (external use history information second output means). The data management computer 18 can output by classifying the external use history information according to a predetermined period such as day, week or month.

The system manager, after making the data management computer 18 usable by following the authentication procedure, selects (clicks) the external use history information from the report items on the report display screen (not shown) displayed on the display 22 of the computer 18 thereby to designate any of the networks 16A to 16D. Once the external use history information is selected and any of the networks 16A to 16D designated, the data management computer 18 specifies the first and second identification data corresponding to the designated one of the networks 16A to 16D, and extracts the external use history information corresponding to the first identification data and the external use history information corresponding to the second identification data from the data base. Next, as shown in FIG. 20, the data management computer 18 displays, on the display 22, the information on the external use history of the user computers 11A to 11C, 12A to 12C, 13A to 13C, 14A to 14C for the designated one of the networks 16A to 16D (external use history information first output means). FIG. 20 shows that, as external use history information, the designated period is displayed in a period display area 133, the computer name (the name of the computer used externally) in a computer name display area 134, the MAC address in a MAC address display area 135, the work group/domain in a work group/domain display area 136, the user name (the name of the user who has externally used the computers 11A to 11C, 12A to 12C, 13A to 13C, 14A to 14C) in a user name display area 137, and the number of times externally used in an external use number display area 138.

On the screen shown in FIG. 20, the computer name displayed in the underlined part is selected (clicked). As shown in FIG. 21, the data management computer 18 displays, on the display 22, the detailed external use history information of selected one of the user computers 11A to 11C, 12A to 12C, 13A to 13C, 14A to 14C (external use history information second output means). FIG. 21 shows that, as detailed external use history information, the month/day is displayed in a month/day display area 139, the computer name in a computer name display area 140, the work group/domain in a work group/domain display area 141, the IP address in an IP address display area 142, and the MAC address in a MAC address display area 143. Further, the external use starting time is displayed in an external use starting time display area 144, the external use ending time in an external use ending time display area 145, the user name in a user name display area 146, the application use starting time in an application use starting time display area 147, the application use ending time in an application use ending time display area 148, the application operation time in an application operation time display area 149, the application name (the name of the application used externally) in an application name display area 150, and the operation window name (the name of the operation window of the application used externally) in an operation window name display area 151. The system manager can output the external use history information shown in FIGS. 20 and 21 from the printer.

In the system 10, the data management computer 18 manages the external use history information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the external use operation is performed in the user computers 11A to 11C, 12A to 12C, 13A to 13C, 14A to 14C for each of the networks 16A to 16D on the one hand, and can monitor the external use operation in each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited external use action in the user computers 11A to 11C, 12A to 12C, 13A to 13C, 14A to 14C can be restricted.

(Undesignated Time Use History Information)

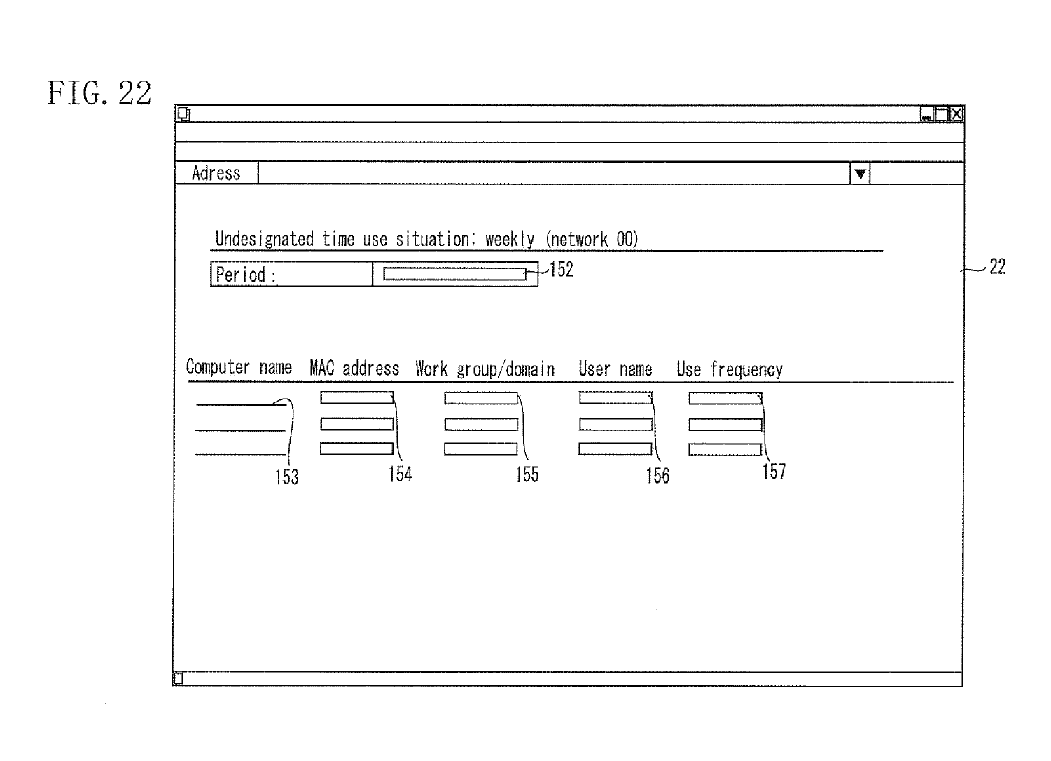

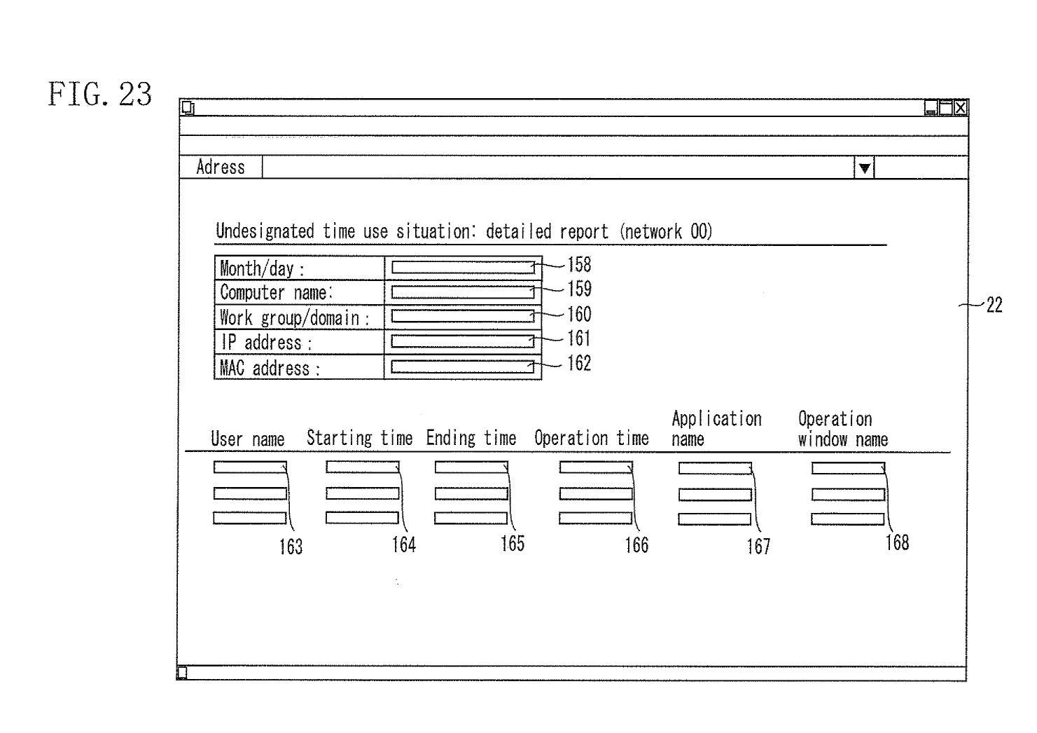

FIGS. 22 and 23 are diagrams showing an example of the undesignated time use history information, i.e. the weekly undesignated time use history of the user computers 11A to 11C, 12A to 12C, 13A to 13C, 14A to 14C. Incidentally, in FIGS. 22 and 23, specific contents of each item are not shown. In the data management computer 18, the undesignated time use history information of the user computers 11A to 11C, 12A to 12C, 13A to 13C, 14A to 14C acquired from the data relay servers 17A, 17B is displayed on the display 22 by being classified for each of the networks 16 to 16D, while at the same time being output from the printer (undesignated time use history information first output means). Also, the undesignated time use history information is displayed on the display 22 by being classified for each of the user computers 11A to 11C, 12A to 12C, 13A to 13C, 14A to 14C, while at the same time being output from the printer (undesignated time use history information second output means). The data management computer 18 can output by classifying the undesignated time use history information according to a predetermined period such as day, week or month.

The system manager, after making the data management computer 18 usable by following the authentication procedure, selects (clicks) the undesignated time use history information from the report items on the report display screen (not shown) displayed on the display 22 of the computer 18 thereby to designate any of the networks 16A to 16D. Once the undesignated time use history information is selected and any of the networks 16A to 16D designated, the data management computer 18 specifies the first and second identification data corresponding to the designated one of the networks 16A to 16D, and extracts the undesignated time use history information corresponding to the first identification data and the undesignated time use history information corresponding to the second identification data from the data base. Next, as shown in FIG. 22, the data management computer 18 displays, on the display 22, the information on the undesignated time use history of the user computers 11A to 11C, 12A to 12C, 13A to 13C, 14A to 14C in the designated one of the networks 16A to 16D (undesignated time use history information first output means). FIG. 22 shows that, as undesignated time use history information, the designated period is displayed in a period display area 152, the computer name in a computer name display area 153, the MAC address in a MAC address display area 154, the work group/domain in a work group/domain display area 155, the user name in a user name display area 156, and the number of times used at other than the designated time in an undesignated time use number display area 157.

On the screen shown in FIG. 22, the computer name displayed in the underlined part is selected (clicked). As shown in FIG. 23, the data management computer 18 displays, on the display 22, the detailed undesignated time use history information of selected one of the user computers 11A to 11C, 12A to 12C, 13A to 13C, 14A to 14C (undesignated time use history information second output means). FIG. 23 shows that, as detailed undesignated time use history information, the month/day is displayed in a month/day display area 158, the computer name (the name of the computer used at other than the designated time) in a computer name display area 159, the work group/domain in a work group/domain display area 160, the IP address in an IP address display area 161, and the MAC address in a MAC address display area 162. Further, the user name (the name of the user of the user computers 11A to 11C, 12A to 12C, 13A to 13C, 14A to 14C used at other than the designated time) in a user name display area 163, the undesignated time use starting time in an undesignated time use starting time display area 164, the undesignated time use ending time in an undesignated time use ending time display area 165, the operation time (the length of time used at other than the designated time) in an operation time display area 166, the application name (the name of the application used when the computer is used at other than the designated time) in an application name display area 167, and the operation window name (the name of the operation window of the application used when the computer is used at other than the designated time) in an operation window name display area 168. The system manager can output the undesignated time use history information shown in FIGS. 22 and 23 from the printer.

In the system 10, the data management computer 18 manages the undesignated time use history information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the undesignated time use operation is performed in the user computers 11A to 11C, 12A to 12C, 13A to 13C, 14A to 14C of each of the networks 16A to 16D on the one hand, and can monitor the use at other than the designated time in the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited use at other than the designated time in the user computers 11A to 11C, 12A to 12C, 13A to 13C, 14A to 14C can be restricted.

(Bring-Out Action Information)

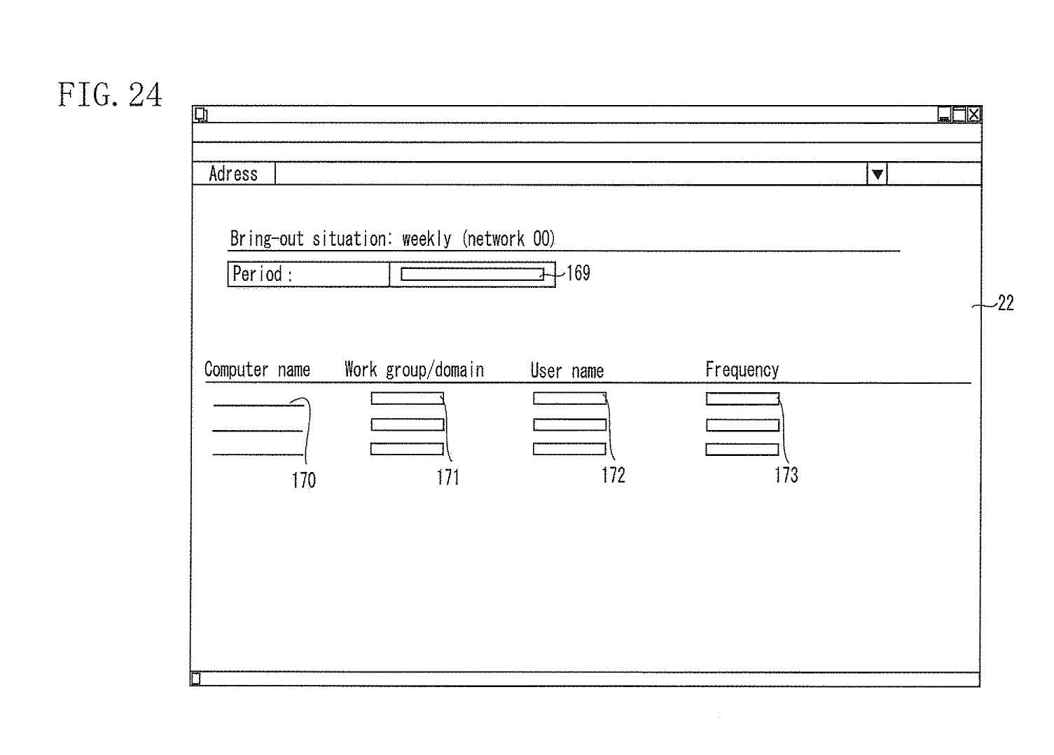

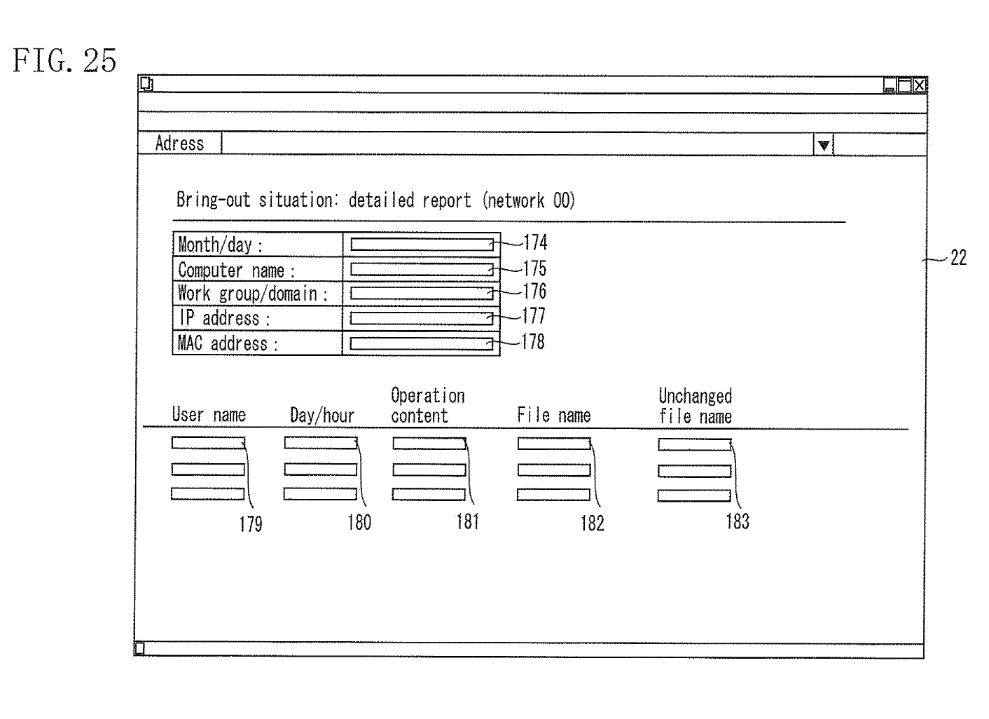

FIGS. 24 and 25 are diagrams showing an example of the bring-out action information, i.e. the weekly bring-out action of the user computers 11A to 11C, 12A to 12C, 13A to 13C, 14A to 14C. Incidentally, in FIGS. 24 and 25, specific contents of each item are not shown. In the data management computer 18, the bring-out action information of the user computers 11A to 11C, 12A to 12C, 13A to 13C, 14A to 14C acquired from the data relay servers 17A, 17B is displayed on the display 22 by being classified for each of the networks 16A to 16D, while at the same time being output from the printer (bring-out action information first output means). Also, the bring-out action information is displayed on the display 22 by being classified for each of the user computers 11A to 11C, 12A to 12C, 13A to 13C, 14A to 14C, while at the same time being output from the printer (bring-out action information second output means). The data management computer 18 can output by classifying the bring-out action information according to a predetermined period such as day, week or month.

The system manager, after making the data management computer 18 usable by following the authentication procedure, selects (clicks) the bring-out action information from the report items on the report display screen (not shown) displayed on the display 22 of the computer 18 thereby to designate any of the networks 16A to 16D. Once the bring-out action information is selected and any of the networks 16A to 16D designated, the data management computer 18 specifies the first and second identification data corresponding to the designated one of the networks 16A to 16D, and extracts the bring-out action information corresponding to the first identification data and the bring-out action information corresponding to the second identification data from the data base. Next, as shown in FIG. 24, the data management computer 18 displays, on the display 22, the information on the bring-out action of the user computers 11A to 11C, 12A to 12C, 13A to 13C, 14A to 14C of the designated one of the networks 16A to 16D (bring-out action information first output means). FIG. 24 shows that, as bring-out action information, the designated period is displayed in a period display area 169, the computer name (the name of the computer in the bring-out action is performed) in a computer name display area 170, the work group/domain in a work group/domain display area 171, the user name (the name of the user of the user computers 11A to 11C, 12A to 12C, 13A to 13C, 14A to 14C in which the bring-out action is performed) in a user name display area 172, and the number of times brought out in a bring-out action number display area 173.

On the screen shown in FIG. 24, the computer name displayed in the underlined part is selected (clicked). As shown in FIG. 25, the data management computer 18 displays, on the display 22, the detailed bring-out action information of selected one of the user computers 11A to 11C, 12A to 12C, 13A to 13C, 14A to 14C (bring-out action information second output means). FIG. 25 shows that, as detailed bring-out action information, the month/day is displayed in a month/day display area 174, the computer name in a computer name display area 175, the work group/domain in a work group/domain display area 176, the IP address in an IP address display area 177, and the MAC address in a MAC address display area 178. Further, the user name is displayed in a user name display area 179, the day/hour of the bring-out action in a bring-out action day/hour display area 180, the content of the bring-out operation (copy, cutoff, file search, etc.) in a bring-out operation content display area 181, the file name in a file name display area 182, the unchanged file name (the name of the data for which the bring-out action is attempted) in an unchanged file name display area 183. The system manager can output the bring-out action information shown in FIGS. 24 and 25 from the printer.

In the system 10, the data management computer 18 manages the bring-out action information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the bring-out action is performed in the user computers 11A to 11C, 12A to 12C, 13A to 13C, 14A to 14C for each of the networks 16A to 16D on the one hand, and can monitor the bring-out action in each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited bring-out action in the user computers 11A to 11C, 12A to 12C, 13A to 13C, 14A to 14C can be restricted.

(Print Action Information)

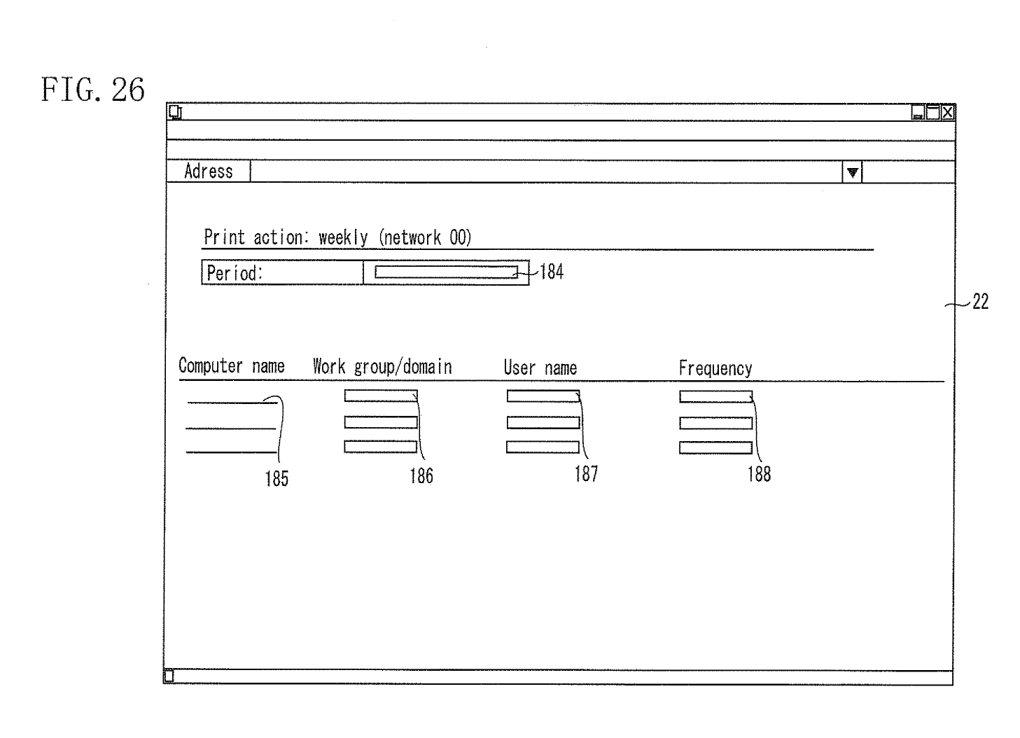

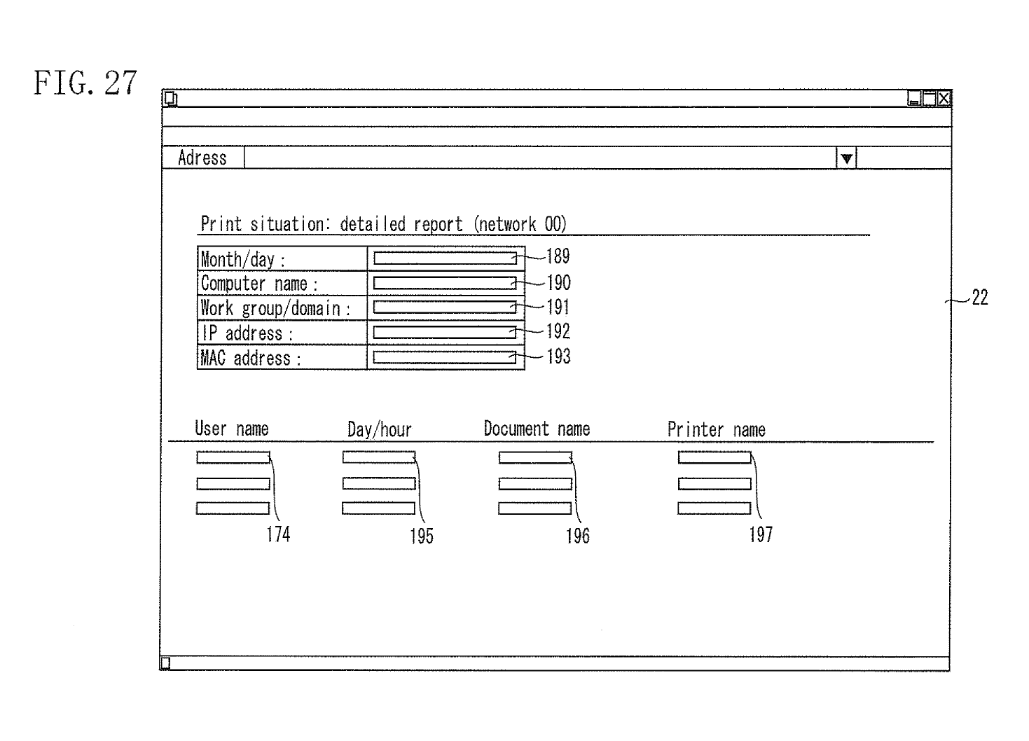

FIGS. 26 and 27 are diagrams showing an example of the print action information, i.e. the weekly print action of the user computers 11A to 11C, 12A to 12C, 13A to 13C, 14A to 14C. Incidentally, in FIGS. 26 and 27, specific contents of each item are not shown. In the data management computer 18, the information the action to print the prohibited data in the user computers 11A to 11C, 12A to 12C, 13A to 13C, 14A to 14C acquired from the data relay servers 17A, 17B is displayed on the display 22 by being classified for each of the networks 16 to 16D, while at the same time being output from the printer (print action information first output means). Also, the information on the print action for the prohibited data is displayed on the display 22 by being classified for each of the user computers 11A to 11C, 12A to 12C, 13A to 13C, 14A to 14C, while at the same time being output from the printer (print action information second output means). The data management computer 18 can output by classifying the print action information according to a predetermined period such as day, week or month.

The system manager, after making the data management computer 18 usable by following the authentication procedure, selects (clicks) the print action information from the report items on the report display screen (not shown) displayed on the display 22 of the computer 18 thereby to designate any of the networks 16A to 16D. Once the print action information is selected and any of the networks 16A to 16D designated, the data management computer 18 specifies the first and second identification data corresponding to the designated one of the networks 16A to 16D, and extracts the print action information corresponding to the first identification data and the print action information corresponding to the second identification data from the data base. Next, as shown in FIG. 26, the data management computer 18 displays, on the display 22, the information on the print action of the user computers 11A to 11C, 12A to 12C, 13A to 13C, 14A to 14C for the designated one of the networks 16A to 16D (print action information first output means). FIG. 26 shows that, as print action information, the designated period is displayed in a period display area 184, the computer name (the name of the computer in which the print action is performed) in a computer name display area 185, the work group/domain in a work group/domain display area 186, the user name (the name of the user of the computer in which the print action is conducted) in a user name display area 187, and the number of times the print action is performed in a print action number display area 188.

On the screen shown in FIG. 26, the computer name displayed in the underlined part is selected (clicked). As shown in FIG. 27, the data management computer 18 displays, on the display 22, the detailed print action information of selected one of the user computers 11A to 11C, 12A to 12C, 13A to 13C, 14A to 14C (print action information second output means). FIG. 27 shows that, as detailed print action information, the period is displayed in a period display area 189, the computer name in a computer name display area 190, the work group/domain in a work group/domain display area 191, the IP address in an IP address display area 192, and the MAC address in a MAC address display area 193. Further, the user name is displayed in a user name display area 194, the day/hour of the print action in a print action day/hour display area 195, the document name (the name of the document of which printing is attempted) in a document name display area 196, and the name of the printer (the name of the printer on which the print action is conducted) in a printer name display area 197. The system manager can output the print action information shown in FIGS. 26 and 27 from the printer.

In this system 10, the data management computer 18 manages the print action information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the print action is performed in the user computers 11A to 11C, 12A to 12C, 13A to 13C, 14A to 14C for each of the networks 16A to 16D on the one hand, and can monitor the print action in each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited print action on the prohibited data in the user computers 11A to 11C, 12A to 12C, 13A to 13C, 14A to 14C can be restricted.

(E-Mail Transmission Information)

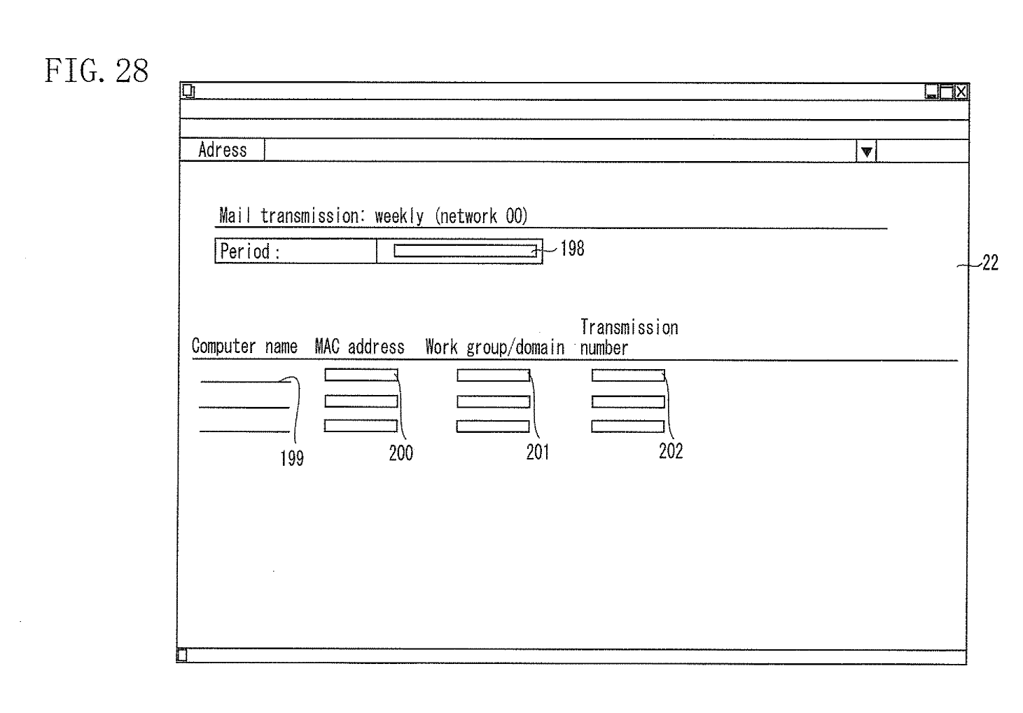

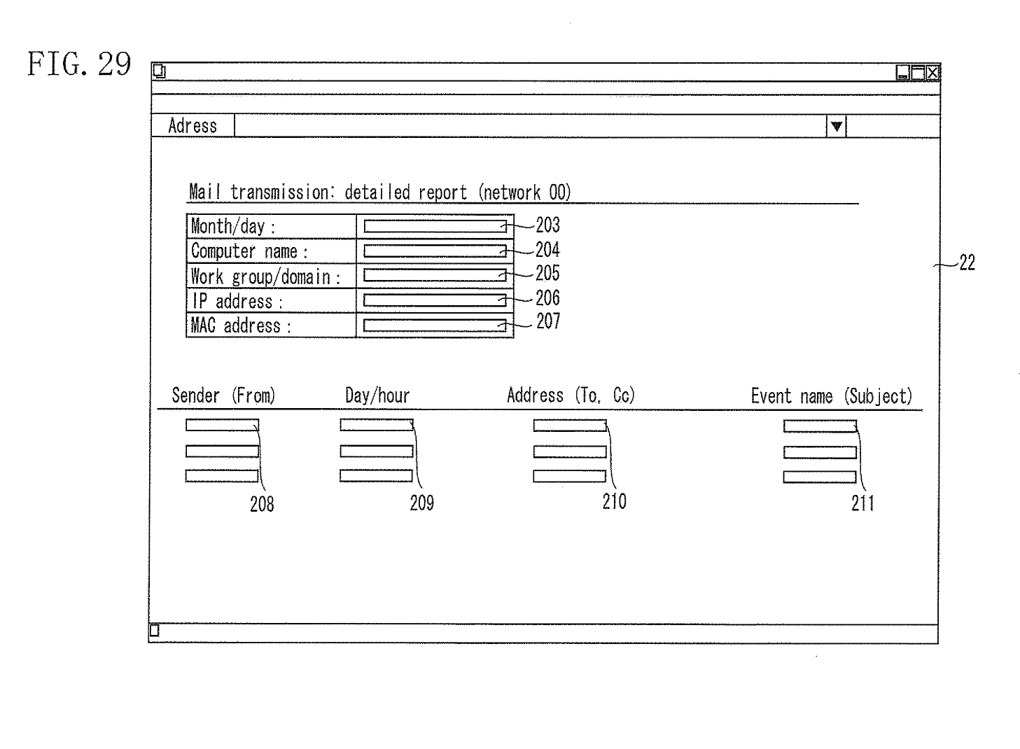

FIGS. 28 and 29 are diagrams showing an example of the E-mail transmission information, i.e. the weekly E-mail transmission of the user computers 11A to 11C, 12A to 12C, 13A to 13C, 14A to 14C. Incidentally, in FIGS. 28 and 29, specific contents of each item are not shown. In the data management computer 18, the E-mail transmission information of the user computers 11A to 11C, 12A to 12C, 13A to 13C, 14A to 14C acquired from the data relay servers 17A, 17B is displayed on the display 22 by being classified for each of the networks 16 to 16D, while at the same time being output from the printer (E-mail transmission information first output means). Also, the E-mail transmission information is displayed on the display 22 by being classified for each of the user computers 11A to 11C, 12A to 12C, 13A to 13C, 14A to 14C, while at the same time being output from the printer (E-mail transmission information second output means). The data management computer 18 can output by classifying the E-mail transmission information according to a predetermined period such as day, week or month.

The system manager, after making the data management computer 18 usable by following the authentication procedure, selects (clicks) the E-mail transmission information from the report items on the report display screen (not shown) displayed on the display 22 of the computer 18 thereby to designate any of the networks 16A to 16D. Once the E-mail transmission information is selected and any of the networks 16A to 16D designated, the data management computer 18 specifies the first and second identification data corresponding to the designated one of the networks 16A to 16D, and extracts the E-mail transmission information corresponding to the first identification data and the E-mail transmission information corresponding to the second identification data from the data base. Next, as shown in FIG. 28, the data management computer 18 displays, on the display 22, the information on the E-mail transmission of the user computers 11A to 11C, 12A to 12C, 13A to 13C, 14A to 14C for the designated one of the networks 16A to 16D (E-mail transmission information first output means). FIG. 28 shows that, as E-mail transmission information, the designated period is displayed in a period display area 198, the computer name in a computer name display area 199, the MAC address in a MAC address display area 200, the work group/domain in a work group/domain display area 201, and the number of times the E-mail is transmitted in an E-mail transmission number display area 202.

On the screen shown in FIG. 28, the computer name displayed in the underlined part is selected (clicked). As shown in FIG. 29, the data management computer 18 displays, on the display 22, the detailed E-mail transmission information of selected one of the user computers 11A to 11C, 12A to 12C, 13A to 13C, 14A to 14C (E-mail transmission information second output means). FIG. 29 shows that, as detailed E-mail transmission information, the month/day (the month/day when the E-mail is transmitted) is displayed in a month/day display area 203, the computer name (the name of the computer that has transmitted the E-mail) in a computer name display area 204, the work group/domain in a work group/domain display area 205, the IP address in an IP address display area 206, and the MAC address in a MAC address display area 207. Further, the sender name (the name of the user of the computers 11A to 11C, 12A to 12C, 13A to 13C, 14A to 14C who has sent the E-mail) in a sender name display area 208, the E-mail transmission day/hour in an E-mail transmission day/hour display area 209, the addressee (E-mail transmittee addressee) in the address display area 210, and the event name (the event name of the transmitted E-mail) in an event name display area 211. The system manager can output the E-mail transmission information shown in FIGS. 28 and 29 from the printer.

In this system 10, the data management computer 18 manages the E-mail transmission information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the E-mail is transmitted in the user computers 11A to 11C, 12A to 12C, 13A to 13C, 14A to 14C of each of the networks 16A to 16D on the one hand, and can monitor the E-mail transmission action in each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited E-mail transmission action in the user computers 11A to 11C, 12A to 12C, 13A to 13C, 14A to 14C can be restricted.

(Web Site Access Information)

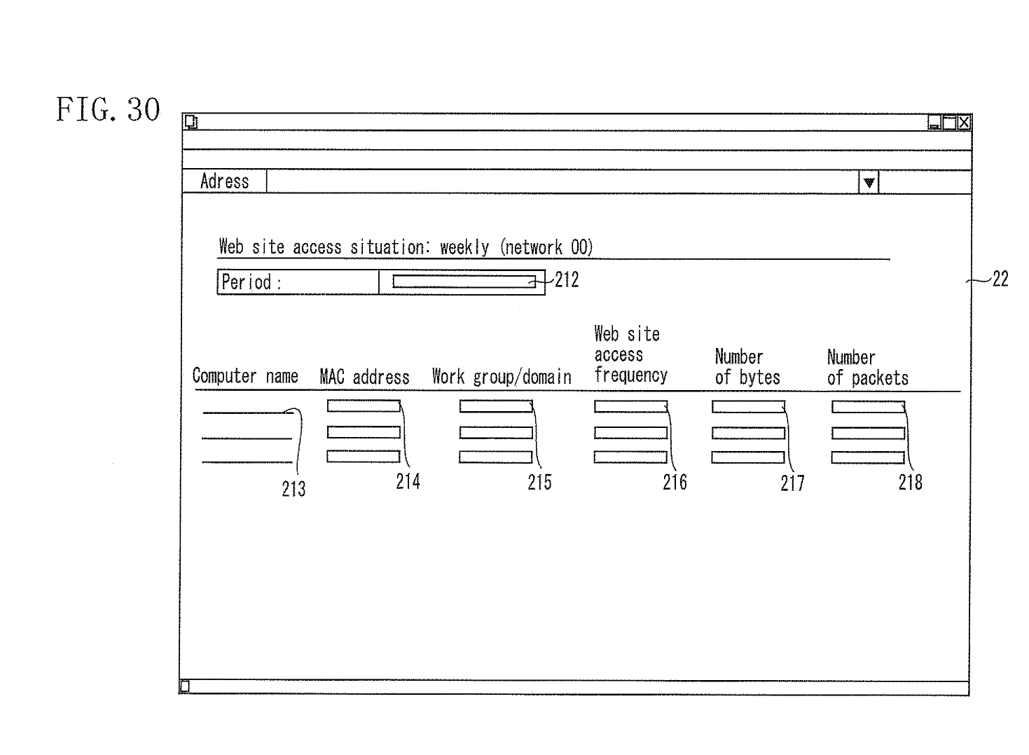

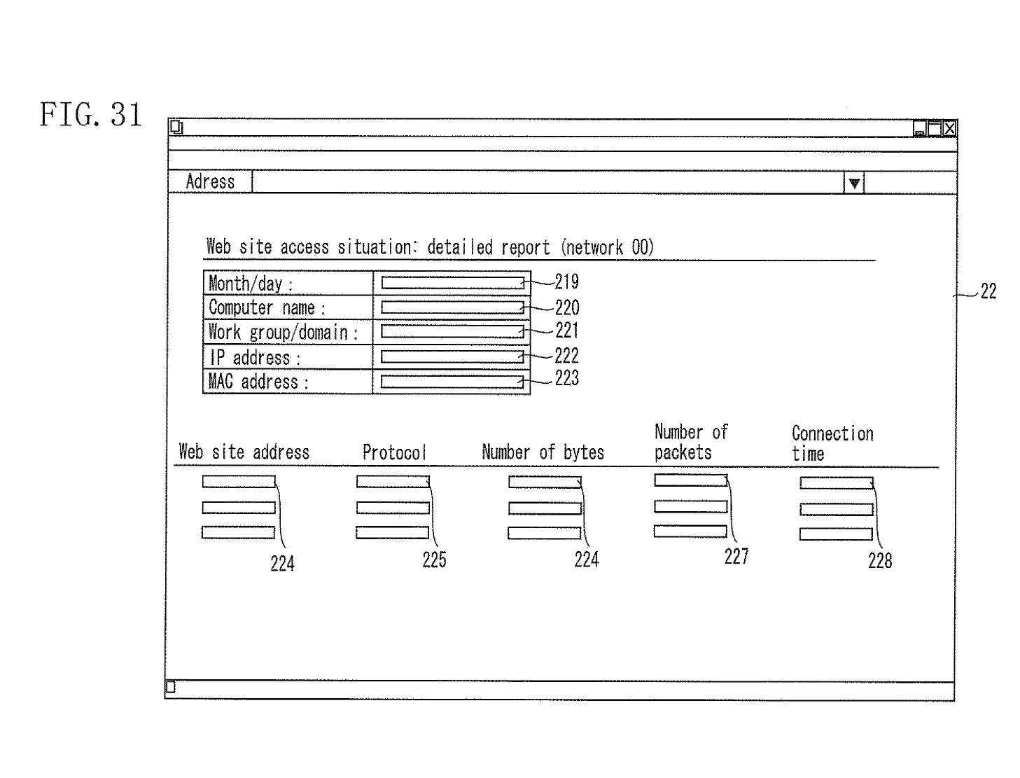

FIGS. 30 and 31 are diagrams showing an example of the Web site access information, i.e. the weekly Web site access of the user computers 11A to 11C, 12A to 12C, 13A to 13C, 14A to 14C. Incidentally, in FIGS. 30 and 31, specific contents of each item are not shown. In the data management computer 18, the Web site access information of the user computers 11A to 11C, 12A to 12C, 13A to 13C, 14A to 14C acquired from the data relay servers 17A, 17B is displayed on the display 22 by being classified for each of the networks 16 to 16D, while at the same time being output from the printer (Web site access information first output means). Also, the Web site access information is displayed on the display 22 by being classified for each of the user computers 11A to 11C, 12A to 12C, 13A to 13C, 14A to 14C, while at the same time being output from the printer (Web site access information second output means). The data management computer 18 can output by classifying the Web site access information according to a predetermined period such as day, week or month.

The system manager, after making the data management computer 18 usable by following the authentication procedure, selects (clicks) the Web site access information from the report items on the report display screen (not shown) displayed on the display 22 of the computer 18 thereby to designate any of the networks 16A to 16D. Once the Web site access information is selected and any of the networks 16A to 16D designated, the data management computer 18 specifies the first and second identification data corresponding to the designated one of the networks 16A to 16D, and extracts the Web site access information corresponding to the first identification data and the Web site access information corresponding to the second identification data from the data base. Next, as shown in FIG. 30, the data management computer 18 displays, on the display 22, the information on the Web site access of the user computers 11A to 11C, 12A to 12C, 13A to 13C, 14A to 14C in the designated one of the networks 16A to 16D (Web site access information first output means). FIG. 30 shows, as Web site access information, the designated period displayed in a period display area 212, the computer name (the name of the computer that has accessed the Web site) in a computer name display area 213, the MAC address in a MAC address display area 214, the work group/domain in a work group/domain display area 215, the number of times accessed in a Web site access number display area 216, the number of bytes in a byte number display area 217 and the number of packets in a packet number display area 218.

On the screen shown in FIG. 30, the computer name displayed in the underlined part is selected (clicked). As shown in FIG. 31, the data management computer 18 displays the detailed Web site access information of selected one of the user computers 11A to 11C, 12A to 12C, 13A to 13C, 14A to 14C on the display 22 (Web site access information second output means). FIG. 31 shows, as detailed Web site access information, the month/day (the day/hour when the Web site is accessed) displayed in a month/day display area 219, the computer name in a computer name display area 220, the work group/domain in a work group/domain display area 221, the IP address in an IP address display area 222, and the MAC address in a MAC address display area 223. Further, the Web site address is displayed in a Web site address display area 224, the protocol in a protocol display area 225, the number of bytes in a byte number display area 226, the number of packets in a packet number display area 227, and the connection time (the time connected to the Web site) in a connection time display area 228. The system manager can output the Web site access information shown in FIGS. 30 and 31 from the printer.

In this system 10, the data management computer 18 manages the Web site access information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the manner in which the Web site is accessed by any of the user computers 11A to 11C, 12A to 12C, 13A to 13C, 14A to 14C of each of the networks 16A to 16D on the one hand, and can monitor the Web site access action of each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited Web site access action of the user computers 11A to 11C, 12A to 12C, 13A to 13C, 14A to 14C can be restricted.

(External Network Access Information)

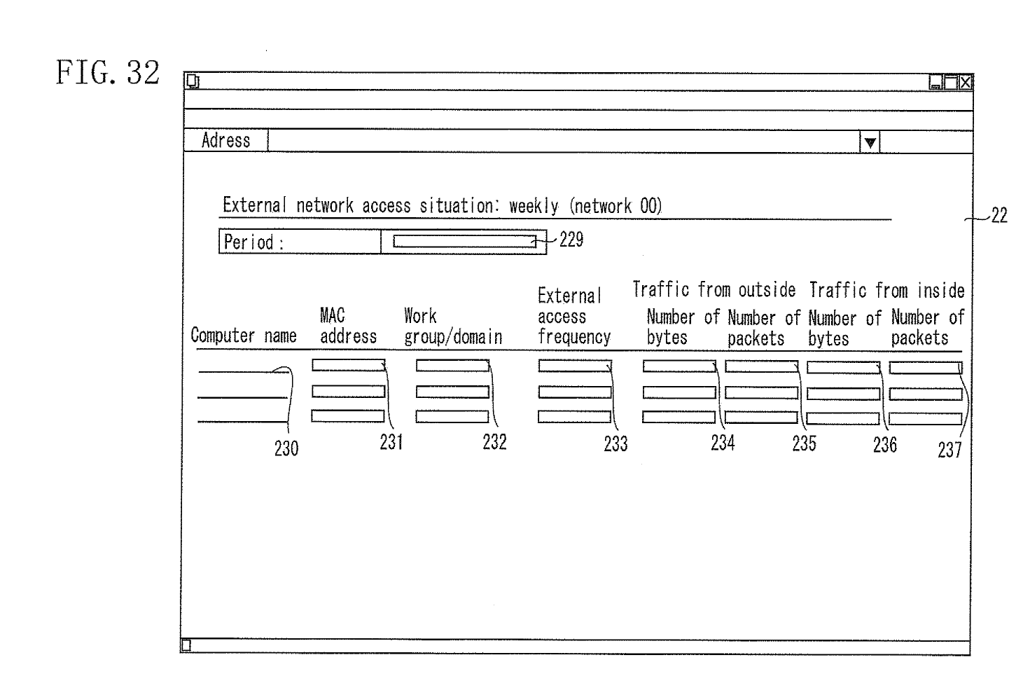

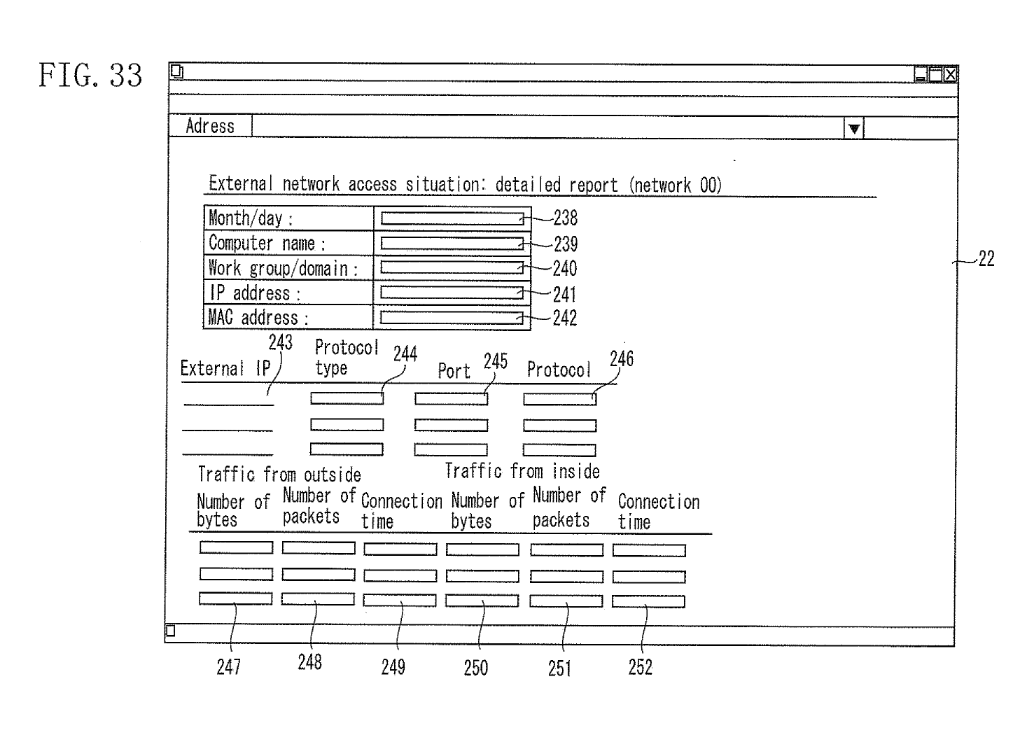

FIGS. 32 and 33 are diagrams showing an example of the external network access information, i.e. the weekly external network access of the user computers 11A to 11C, 12A to 12C, 13A to 13C, 14A to 14C. Incidentally, in FIGS. 32 and 33, specific contents of each item are not shown. In the data management computer 18, the external network access information of the user computers 11A to 11C, 12A to 12C, 13A to 13C, 14A to 14C acquired from the data relay servers 17A, 17B is displayed on the display 22 by being classified for each of the networks 16 to 16D, while at the same time being output from the printer (external network access information first output means). Also, the external network access information is displayed on the display 22 by being classified for each of the user computers 11A to 11C, 12A to 12C, 13A to 13C, 14A to 14C, while at the same time being output from the printer (external network access information second output means). The data management computer 18 can output by classifying the external network access information according to a predetermined period such as day, week or month.

The system manager, after making the data management computer 18 usable by following the authentication procedure, selects (clicks) the external network access information from the report items on the report display screen (not shown) displayed on the display 22 of the computer 18 thereby to designate any of the networks 16A to 16D. Once the external network access information is selected and any of the networks 16A to 16D designated, the data management computer 18 specifies the first and second identification data corresponding to the designated one of the networks 16A to 16D, and extracts the external network access information corresponding to the first identification data and the external network access information corresponding to the second identification data from the data base. Next, as shown in FIG. 32, the data management computer 18 displays, on the display 22, the information on the external network access of the user computers 11A to 11C, 12A to 12C, 13A to 13C, 14A to 14C for the designated one of the networks 16A to 16D (external network access information first output means). FIG. 32 shows, as external network access information, the designated period displayed in a period display area 229, the computer name (the name of the computer that has accessed the external network) in a computer name display area 230, the MAC address in a MAC address display area 231, the work group/domain in a work group/domain display area 232 and the number of times the external network is accessed in an external network access number display area 233. Also, with regard to the traffic from outside, the number of bytes is displayed in a byte number display area 234 and the number of packets in a packet number display area 235, and with regard to the traffic from inside, the number of bytes is displayed in a byte number display area 236 and the number of packets in a packet number display area 237.

On the screen shown in FIG. 32, the computer name displayed in the underlined part is selected (clicked). As shown in FIG. 33, the data management computer 18 displays, on the display 22, the detailed external network access information of selected one of the user computers 11A to 11C, 12A to 12C, 13A to 13C, 14A to 14C (external network access information second output means). FIG. 33 shows, as detailed external network access information, the month/day (the day/hour when the external network is accessed) in a month/day display area 238, the computer name in a computer name display area 239, the work group/domain in a work group/domain display area 240, the IP address in an IP address display area 241, and the MAC address in a MAC address display area 242. Further, the external IP (external network address) is displayed in an external IP display area 243, the protocol type in a protocol type display area 244, the port in a port display area 245, and the protocol in a protocol display area 246. Also, with regard to the traffic from outside, the number of bytes is displayed in a byte number display area 247, the number of packets in a packet number display area 248 and the connection time in a connection time display area 249, and with regard to the traffic from inside, the number of bytes is displayed in a byte number display area 250, the number of packets in a packet number display area 251 and the connection time in a connection time display area 252. The system manager can output the external network access information shown in FIGS. 32 and 33 from the printer.

In this system 10, the data management computer 18 manages the external network access information in the user computers 11A to 11C, 12A to 12C, 13A to 13C, 14A to 14C for each of the networks 16A to 16D or each of the user computers 11A to 11C, 12A to 12C, 13A to 13C, 14A to 14C. Therefore, the system manager can positively grasp, through the data management computer 18, the external network access in the user computers 11A to 11C, 12A to 12C, 13A to 13C, 14A to 14C of each of the networks 16A to 16D on the one hand, and can monitor the external network access in each of the user computers 11A to 11C, 12A to 12C, 13A to 13C, 14A to 14C for each of the networks 16A to 16D or for each of the user computers 11A to 11C, 12A to 12C, 13A to 13C, 14A to 14C on the other hand. At the same time, the unlimited external network access action in the user computers 11A to 11C, 12A to 12C, 13A to 13C, 14A to 14C can be restricted.

1. A device data management system comprising a plurality of networks each formed of a plurality of network component devices and a device monitor for temporally monitoring the network component devices, and a data management unit for acquiring a plurality of various information on the network component devices from a plurality of the device monitors forming the networks,
wherein the device monitor includes a use history information collection means for temporally collecting from the network component devices the use history information of each application used in the network component devices, and a use history information transmission means for transmitting the collected use history information to the data management unit, and
the data management unit includes a use history information first storage means for storing, by classifying according to each network, the use history information transmitted from each of the device monitors and a use history information first output means for outputting by classifying the use history information according to each network.

2. The device data management system according to claim 1,
wherein the data management unit includes a use history information second storage means for storing, by classifying according to each network component device, the use history information transmitted from each of the device monitors, and a use history information second output means for outputting by classifying the use history information according to each network component device.

3. The device data management system according to claim 1,
wherein the device monitor includes an access history information collection means for temporally collecting from the network component devices the access history information on the access to an unusable application in the network component devices, and an access history transmission means for transmitting the collected access history information to the data management unit, and
the data management unit includes an access history information first storage means for storing, by classifying according to each network, the access history information transmitted from each device monitor, and an access history information first output means for outputting by classifying the access history information according to each network.

4. The device data management system according to claim 3,
wherein the data management unit includes an access history information second storage means for storing, by classifying according to each network component device, the access history information transmitted from each device monitor, and an access history information second output means for outputting by classifying the access history information according to each network component device.

5. The device data management system according to claim 3,
wherein the data management unit includes an application alteration means for adding, changing or deleting the application used in the network component devices, and an unusable application alteration means for adding, changing or deleting the application unusable in the network component devices.

6. The device data management system according to claim 1,
wherein the device monitor includes an installation information collection means for temporally collecting, from the network component devices, the information on installation, if any, of an application in the network component devices, and an installation information transmission means for transmitting the collected installation information to the data management unit, and
the data management unit includes an installation information first storage means for storing, by classifying according to each network, the installation information transmitted from each device monitor, and an installation information first output means for outputting by classifying the installation information according to each network.

7. The device data management system according to claim 6,
wherein the data management unit includes an installation information second storage means for storing, by classifying according to each network component device, the installation information transmitted from each device monitor, and an installation information second output means for outputting by classifying the installation information according to each network component device.

8. The device data management system according to claim 1,
wherein the device monitor includes an uninstallation information collection means for temporally collecting from any of the network component devices the information on the uninstallation, if any, of an application from the network component device, and an uninstallation information transmission means for transmitting the collected uninstallation information to the data management unit, and
the data management unit includes an uninstallation information first storage means for storing, by classifying according to each network, the uninstallation information transmitted from each device monitor, and an uninstallation information first output means for outputting by classifying the uninstallation information according to each network.

9. The device data management system according to claim 8,
wherein the data management unit includes an uninstallation information second storage means for storing, by classifying according to each network component device, the uninstallation information transmitted from each device monitor, and an uninstallation information second output means for outputting by classifying the uninstallation information according to each network component device.

10. The device data management system according to claim 1,
wherein the device monitor includes an external use history information collection means for temporally collecting, from each of the network component devices, the external use history information in the case where the network component device is used in an external environment other than the network formed by the network component device, and an external use history information transmission means for transmitting the collected external use history information to the data management unit, and
the data management unit includes an external use history information first storage means for storing, by classifying according to each network, the external use history information transmitted from each device monitor, and an external use history information first output means for outputting by classifying the external use history information according to each network.

11. The device data management system according to claim 10,
wherein the data management unit includes an external use history information second storage means for storing, by classifying according to each network component device, the external use history information transmitted from each device monitor, and an external use history information second output means for outputting by classifying the external use history information according to each network component device.

12. The device data management system according to claim 1,
wherein the device monitor includes an undesignated time use history information collection means for temporally collecting, from each of the network component devices, the undesignated time use history information on the network component device used at other than a designated time, and an undesignated time use history information transmission means for transmitting the collected undesignated time use history information to the data management unit, and
the data management unit includes an undesignated time use history information first storage means for storing, by classifying according to each network, the undesignated time use history information transmitted from each device monitor, and an undesignated time use history information first output means for outputting by classifying the undesignated time use history information according to each network.

13. The device data management system according to claim 12,
wherein the data management unit includes an undesignated time use history information second storage means for storing, by classifying according to each network component device, the undesignated time use history information transmitted from each device monitor, and an undesignated time use history information second output means for outputting by classifying the undesignated time use history information according to each network component device.

14. The device data management system according to claim 1,
wherein the device monitor includes a bring-out action information collection means for temporally collecting, from each network component device, the bring-out action information in the case where an attempt is made to bring out a bring-out prohibited data from the network component device, and a bring-out action information transmission means for transmitting the collected bring-out action information to the data management unit, and
the data management unit includes a bring-out action information first storage means for storing, by classifying according to each network, the bring-out action information transmitted from each device monitor, and a bring-out action information first output means for outputting by classifying the bring-out action information according to each network.

15. The device data management system according to claim 14,
wherein the data management unit includes a bring-out action information second storage means for storing, by classifying according to each network component device, the bring-out action information transmitted from each device monitor, and a bring-out action information second output means for outputting by classifying the bring-out action information according to each network component device.

16. The device data management system according to claim 1,
wherein the device monitor includes a print action information collection means for temporally collecting, from each of the network component devices, the print action information in the case where an attempt is made to print a print prohibited data from the network component device, and a print action information transmission means for transmitting the collected print action information to the data management unit, and
the data management unit includes a print action information first storage means for storing, by classifying according to each network, the print action information transmitted from each device monitor, and a print action information first output means for outputting by classifying the print action information according to each network.

17. The device data management system according to claim 16,
wherein the data management unit includes a print action information second storage means for storing, by classifying according to each network component device, the print action information transmitted from each device monitor, and a print action information second output means for outputting by classifying the print action information according to each network component device.

18. The device data management system according to claim 1,
wherein the device monitor includes an E-mail transmission information collection means for temporally collecting, from each network component device, the E-mail transmission information in the case where an E-mail is transmitted from the network component device, and an E-mail transmission information transmission means for transmitting the collected E-mail transmission information to the data management unit, and
the data management unit includes an E-mail transmission information first storage means for storing, by classifying according to each network, the E-mail transmission information transmitted from each device monitor, and an E-mail transmission information first output means for outputting by classifying the E-mail transmission information according to each network.

19. The device data management system according to claim 18,
wherein the data management unit includes an E-mail transmission information second storage means for storing, by classifying according to each network component device, the E-mail transmission information transmitted from each device monitor, and an E-mail transmission information second output means for outputting by classifying the E-mail transmission information according to each network component device.

20. The device data management system according to claim 1,
wherein the device monitor includes a Web site access information collection means for temporally collecting, from each network component device, the Web site access information in the case where a predetermined Web site is accessed by the network component device, and a Web site access information transmission means for transmitting the collected Web site access information to the data management unit, and
the data management unit includes a Web site access information first storage means for storing, by classifying according to each network, the Web site access information transmitted from each device monitor, and a Web site access information first output means for outputting by classifying the Web site access information according to each network.

21. The device data management system according to claim 20,
wherein the data management unit includes a Web site access information second storage means for storing, by classifying according to each network component device, the Web site access information transmitted from each device monitor, and a Web site access information second output means for outputting by classifying the Web site access information according to each network component device.

22. The device data management system according to claim 1,
wherein the device monitor includes an external network access information collection means for temporally collecting, from each network component device, the external network access information in the case where the network component device accesses an external network other than the network formed by the network component device, and an external network access information transmission means for transmitting the collected external network access information to the data management unit, and
the data management unit includes an external network access information first storage means for storing, by classifying according to each network, the external network access information transmitted from each device monitor, and an external network access information first output means for outputting by classifying the external network access information according to each network.

23. The device data management system according to claim 22,
wherein the data management unit includes an external network access information second storage means for storing, by classifying according to each network component device, the external network access information transmitted from each device monitor, and an external network access information second output means for outputting by classifying the external network access information according to each network component device.
